(19) United States
(12) Patent Application Publication
(10) Pub. No.: US 2015/0119367 A1
(43) Pub. Date: Apr. 30, 2015

(54) Phosphate Esters of Bimatoprost and the Prostamides

(71) Applicant: Allergan, Inc., Irvine, CA (US)

(72) Inventors: David F. Woodward, Lake Forest, CA (US); Jenny W. Wang, Irvine, CA (US); Neil J. Poloso, Lake Forest, CA (US); Todd S. Gac, Santa Ana, CA (US); Robert M. Burk, Laguna Beach, CA (US); Michael E. Garst, Newport Beach, CA (US)

(73) Assignee: Allergan, Inc., Irvine, CA (US)

(21) Appl. No.: 14/065,698

(22) Filed: Oct. 29, 2013

(51) Int. Cl. C07F 9/09

(52) U.S. Cl. CPC C07F 9/093
USPC 514/102; 558/161

(57) ABSTRACT

Provided herein, inter alia, are prodrugs of bimatoprost, methods of using the same and compositions including the same.

### CROSS REFERENCE TO RELATED APPLICATIONS

The present application claims the benefit of U.S. Provisional Application Ser. No. 61/719,266, filed Oct. 29, 2012, which is incorporated herein by reference in its entirety.

### FIELD OF THE INVENTION

The present invention is directed to, inter alia, prodrugs of bimatoprost, formulations containing prodrugs of bimatoprost, and uses of bimatoprost prodrugs.

### BACKGROUND OF THE INVENTION

Bimatoprost isomer [(Z)-7-((1R,2R,3R,5S)-3,5-dihydroxy-2-((S,E)-3-hydroxy-5-phenylpent-1-enyl)cyclopentyl)-N-ethylhept-5-enamide] (sold under the name Lumigan® by Allergen, Inc., Irvine, Calif.), was initially developed for the treatment of a variety of diseases or disorders, including ocular hypertension and glaucoma. See U.S. Pat. Nos. 5,607,978, 5,688,819, 6,403,649, 8,017,655.

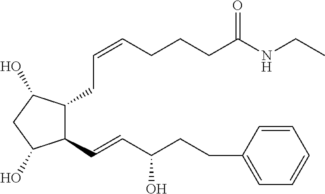 [SMILES: CCNC(=O)CCC/C=C\C[C@@H]1[C@@H](/C=C/[C@@H](O)CCc2ccccc2)[C@H](O)C[C@@H]1O]

### Bimatoprost Isomer

It has been observed that administration of bimatoprost results in hypertrichosis (i.e., increased hair growth) in treated regions. Indeed, results of administration of bimatoprost include altered differentiation, number, length, thickness, curvature and pigmentation. It has also been observed that administration of bimatoprost may result in growth of skeletal muscle, reduction of adipose deposits, and/or reduction in ocular hypertension, among other effects.

Accordingly, there is a need to provide derivatives of bimatoprost, including prodrugs, which provide efficacy in the treatment of a variety of diseases or disorders, such as lowering intraocular pressure, growing skeletal muscle, treating glaucoma, treating ocular hypertension, reducing or preventing hair loss, increasing hair growth, treating inflammatory diseases and disorders of the skin, and for the reduction of local adipose deposits. Provided herein are solutions to these and other needs in the art.

The entire contents of each patent or publication cited herein are incorporated by reference in its entirety for all purposes.

### BRIEF SUMMARY OF THE INVENTION

In a first aspect, there is provided a compound with the structure of Formula (I),

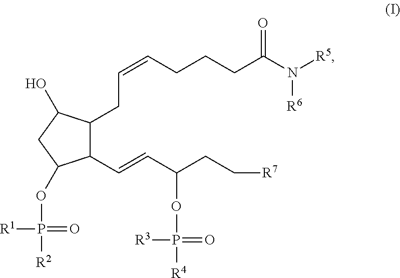

or a derivative, an isomer, or an enantiomer thereof. R¹ is —OR^{8A}, —NR^{9A}R^{10A}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R² is —OR^{8B}, —NR^{9B}R^{10B}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R³ is —OR^{8C}, —NR^{9C}R^{10C}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R⁴ is —OR^{8D}, —NR^{9D}R^{10D}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R⁷ is substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R⁵, R⁶, R^{8A}, R^{8B}, R^{8C}, R^{8D}, R^{9A}, R^{9B}, R^{9C}, R^{9D}, R^{10A}, R^{10B}, R^{10C} and R^{10D} are independently hydrogen, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl.

In another aspect, there is provided a pharmaceutical composition including a pharmaceutically acceptable excipient and a compound as described herein (including embodiments).

In another aspect, there is provided a method of inducing hair growth in a human including administering to a subject in need thereof a therapeutically effective amount of a compound as described herein (including embodiments).

In another aspect, there is provided a method of reducing hair loss in a human including administering to a subject in need thereof a therapeutically effective amount of a compound as described herein (including embodiments).

In another aspect, there is provided a method of treating an inflammatory condition in a human including administering to a subject in need thereof a therapeutically effective amount of a compound as described herein (including embodiments).

In another aspect, there is provided a method of reducing inflammation in a human including administering to a subject in need thereof a therapeutically effective amount of a compound as described herein (including embodiments).

In another aspect, there is provided a method of treating cachexia in a human including administering to a subject in need thereof, a therapeutically effective amount of a compound as described herein (including embodiments).

In another aspect, there is provided a method of increasing muscle mass in a human including administering to a subject in need thereof, a therapeutically effective amount of a compound as described herein (including embodiments).

In another aspect, there is provided a method of decreasing fat in a human including administering to a subject in need thereof, a therapeutically effective amount of a compound as described herein (including embodiments).

In another aspect, there is provided a method of decreasing adipose tissue in a human including administering to a subject in need thereof, a therapeutically effective amount of a compound as described herein (including embodiments).

In another aspect, there is provided a method of decreasing the weight of a human including administering to a subject in need thereof, a therapeutically effective amount of a compound as described herein (including embodiments).

In another aspect, there is provided a method of treating glaucoma in a human including administering to a subject in need thereof, a therapeutically effective amount of a compound as described herein (including embodiments).

In another aspect, there is provided a method of preventing glaucoma in a human including administering to a subject at increased risk of glaucoma, a prophylactically effective amount of a compound as described herein (including embodiments).

In another aspect, there is provided a method of reducing intraocular pressure in a human including administering to a subject in need thereof, a therapeutically effective amount of a compound as described herein (including embodiments).

In another aspect, there is provided a method of treating intraocular hypertension in a human including administering to a subject in need thereof, a therapeutically effective amount of a compound as described herein (including embodiments).

Embodiments of the invention include the following:

### Embodiment 1

A compound having the formula:

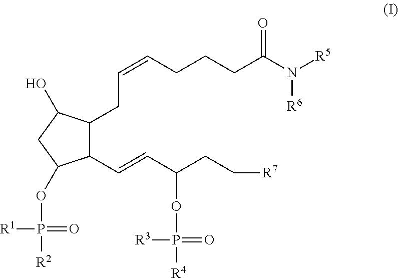

or derivative, isomer, or enantiomer thereof;
wherein R¹ is —OR^{8A}, —NR^{9A}R^{10A}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl; R² is —OR^{8B}, —NR^{9B}R^{10B}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl; R³ is —OR^{8C}, —NR^{9C}R^{10C}, substituted or unsubstituted alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl; R⁴ is —OR^{8D}, —NR^{9D}R^{10D}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl; R⁷ is substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl; R⁵, R⁶, R^{8A}, R^{8B}, R^{8C}, R^{8D}, R^{9A}, R^{9B}, R^{9C}, R^{9D}, R^{10A}, R^{10B}, R^{10C} and R^{10D} are independently hydrogen, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl.

### Embodiment 2

The compound of embodiment 1, wherein R¹ is —OR^{8A}, —NR^{9A}R^{10A}, substituted or unsubstituted cycloalkyl, substituted or unsubstituted heterocycloalkyl, substituted or unsubstituted aryl or substituted or unsubstituted heteroaryl; R² is —OR^{8B}, —NR^{9B}R^{10B}, substituted or unsubstituted cycloalkyl, substituted or unsubstituted heterocycloalkyl, substituted or unsubstituted aryl or substituted or unsubstituted heteroaryl; R³ is —OR^{8C}, —NR^{9C}R^{10C} substituted or unsubstituted cycloalkyl, substituted or unsubstituted heterocycloalkyl, substituted or unsubstituted aryl or substituted or unsubstituted heteroaryl; R⁴ is —OR^{8D}, —NR^{9D}R^{10D}, substituted or unsubstituted cycloalkyl, substituted or unsubstituted heterocycloalkyl, substituted or unsubstituted aryl or substituted or unsubstituted heteroaryl.

### Embodiment 3

The compound of embodiment 1, wherein R¹ is —OR^{8A}, —NR^{9A}R^{10A}, or a monosaccharide moiety; R² is —OR^{8B}, —NR^{9B}R^{10B}, or a monosaccharide moiety; R³ is —OR^{8C}, —NR^{9C}R^{10D}, or a monosaccharide moiety; R⁴ is —OR^{8D}, —NR^{9D}R^{10D}, or a monosaccharide moiety.

### Embodiment 4

The compound of any one of embodiments 1 to 3, wherein R^{8A}, R^{8B}, R^{8C} and R^{8D} are independently hydrogen, or hydroxyl-substituted or unsubstituted C₁-C₁₀ alkyl.

### Embodiment 5

The compound of any one of embodiments 1 to 4, wherein R⁵ and R⁶ are independently hydrogen or hydroxyl-substituted or unsubstituted C₁-C₁₀ alkyl.

### Embodiment 6

The compound of any one of embodiments 1 to 5, wherein R⁵ and R⁶ are hydrogen.

### Embodiment 7

The compound of any one of embodiments 1 to 6, wherein R^{9A}, R^{9B}, R^{9C}, R^{9D}, R^{10A}, R^{10B}, R^{10C} and R^{10D} are independently hydrogen or hydroxyl-substituted or unsubstituted C₁-C₁₀ alkyl.

### Embodiment 8

The compound of any one of embodiments 1 to 7, wherein R⁷ is substituted or unsubstituted C₁-C₁₀ alkyl, substituted or unsubstituted cycloalkyl, substituted or unsubstituted heterocycloalkyl, substituted or unsubstituted aryl or substituted or unsubstituted heteroaryl.

### Embodiment 9

The compound of any one of embodiments 1 to 7, wherein R⁷ is substituted or unsubstituted cycloalkyl, substituted or unsubstituted heterocycloalkyl, substituted or unsubstituted aryl or substituted or unsubstituted heteroaryl.

### Embodiment 10

The compound of any one of embodiments 1 to 7, wherein R⁷ is substituted or unsubstituted aryl.

### Embodiment 11

The compound of any one of embodiments 1 to 7, having the formula:

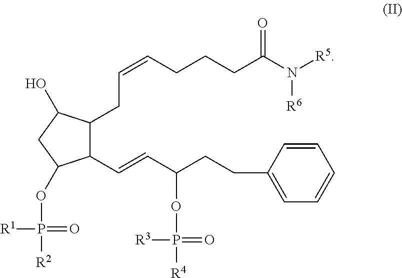

### Embodiment 12

The compound of embodiment 1, wherein at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₁-C₆ alkyl.

### Embodiment 13

The compound of embodiment 12, wherein at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₁-C₃ alkyl.

### Embodiment 14

The compound of embodiment 13, wherein at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₁ alkyl.

### Embodiment 15

The compound of embodiment 1, wherein at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted methyl.

### Embodiment 16

The compound of embodiment 1, wherein at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₃-C₈ cycloalkyl.

### Embodiment 17

The compound of embodiment 1, wherein at least one of R^{8A}, R^{8B}, R^{8C}, R^{8D}, R^{9A}, R^{9B}, R^{9C}, R^{9D}, R^{10A}, R^{10B}, R^{10C} and R^{10D} independently unsubstituted C₃-C₈ cycloalkyl.

### Embodiment 18

The compound of embodiment 1, wherein at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted aryl.

### Embodiment 19

The compound of embodiment 18, wherein at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted aryl.

### Embodiment 20

The compound of embodiment 1, wherein at least one of R^{8A}, R^{8B}, R^{8C}, R^{8D}, R^{9A}, R^{9B}, R^{9C}, R^{9D}, R^{10A}, R^{10B}, R^{10C} and R^{10D} independently unsubstituted phenyl.

### Embodiment 21

The compound of any one of embodiments 1 to 20, wherein R⁵ is substituted or unsubstituted C₁-C₁₀ alkyl, or substituted or unsubstituted C₃-C₈ cycloalkyl.

### Embodiment 22

The compound of any one of embodiments 1 to 21, wherein R⁵ is substituted or unsubstituted C₁-C₆ alkyl.

### Embodiment 23

The compound of any one of embodiments 1 to 22, wherein R⁵ is substituted or unsubstituted C₁-C₃ alkyl.

### Embodiment 24

The compound of any one of embodiments 1 to 23, wherein R⁵ is substituted or unsubstituted C₂ alkyl.

### Embodiment 25

The compound of any one of embodiments 1 to 24, wherein R⁵ is unsubstituted ethyl.

### Embodiment 26

The compound of any one of embodiments 1 to 21, wherein R⁵ is substituted or unsubstituted C₃-C₈ cycloalkyl.

### Embodiment 27

The compound of any one of embodiments 1 to 26, wherein R⁶ is hydrogen.

### Embodiment 28

The compound of embodiment 1 having the formula:

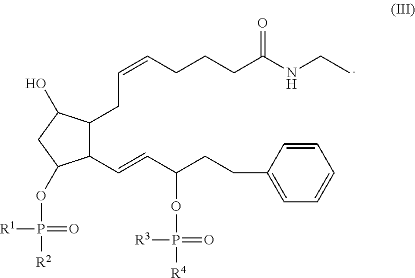

### Embodiment 29

A pharmaceutical composition comprising a pharmaceutically acceptable excipient and a compound of any one of embodiments 1 to 28.

### Embodiment 30

The pharmaceutical composition of embodiment 29, wherein said pharmaceutical composition is a solution, emulsion, gel or foam.

### Embodiment 31

The pharmaceutical composition of embodiment 29, wherein said pharmaceutical composition is a topical pharmaceutical composition.

### Embodiment 32

The pharmaceutical composition of embodiment 29, wherein said pharmaceutical composition is a topical epidermal pharmaceutical composition.

### Embodiment 33

A method for inducing piliation or hair growth in a human comprising administering to a subject in need thereof a therapeutically effective amount of a compound of any one of embodiments 1 to 28 and thereby inducing hair growth.

### Embodiment 34

The method of embodiment 33, wherein said subject suffers from alopecia.

### Embodiment 35

The method of embodiment 33, wherein said subject is in need of piliation of the cilia, the supercilia, scalp pili, or body pili.

### Embodiment 36

The method of embodiment 33, wherein said administering is topical administering.

### Embodiment 37

The method of embodiment 36, wherein said administering is topical epidermal administering.

### Embodiment 38

The method of any one of embodiments 33 to 37, wherein said compound is in the form of a solution, emulsion, gel or foam.

### Embodiment 39

The method of any one of embodiments 33 to 38, wherein said administering is topical palpebra administering, topical supercilium administering, topical scalp administering, or topical body administering.

### Embodiment 40

The method of any one of embodiments 33 to 39, wherein said administering is topical scalp administering, and said compound is in the form of a foam or gel.

### Embodiment 41

The method of any one of embodiments 33 to 40, wherein said administering is topical palpebra administering, and said compound is administered by an application brush disposed within a unit dose vial.

### Embodiment 42

A method for lowering intraocular pressure comprising administering to a subject in need thereof a therapeutically effective amount of a compound of any one of embodiments 1 to 28 and thereby lowering intraocular pressure.

### Embodiment 43

The method of embodiment 42, wherein said subject suffers from elevated intraocular pressure or glaucoma.

### Embodiment 44

The method of embodiment 43, wherein said subject suffers from glaucoma.

### Embodiment 45

A method for treating an inflammatory skin disease or disorder comprising administering to a subject in need thereof a therapeutically effective amount of a compound of any one of embodiments 1 to 28 and thereby treating an inflammatory skin disease or disorder.

### Embodiment 46

The method of embodiment 45, wherein said subject suffers from rosacea or redness from rosacea.

### Embodiment 47

A method for reducing local adipose deposits comprising administering to a subject in need thereof a therapeutically effective amount of a compound of any one of embodiments 1 to 28 and thereby reducing local adipose deposit.

### Embodiment 48

A method of treating an inflammatory condition in a human including administering to a subject in need thereof a therapeutically effective amount of a compound of any one of embodiments 1 to 28 and thereby treating an inflammatory condition.

### Embodiment 49

A method of reducing inflammation in a human including administering to a subject in need thereof a therapeutically effective amount of a compound of any one of embodiments 1 to 28 and thereby reducing inflammation.

### Embodiment 50

The method of embodiment 49, wherein the inflammation is of the skin.

### Embodiment 51

The method of embodiment 49, wherein the inflammation is of the eye.

### Embodiment 52

The method of embodiment 49, wherein the inflammation is of an epidermal tissue.

### Embodiment 53

A method of treating cachexia in a human including administering to a subject in need thereof, a therapeutically effective amount of a compound of any one of embodiments 1 to 28 and thereby treating cachexia.

### Embodiment 54

A method of increasing muscle mass in a human including administering to a subject in need thereof, a therapeutically effective amount of a compound of any one embodiments 1 to 28 and thereby increasing muscle mass.

### Embodiment 55

The method of embodiment 54, wherein the increase in muscle mass is through increased growth of muscle.

### Embodiment 56

The method of embodiment 54, wherein the muscle is skeletal muscle.

### Embodiment 57

A method of decreasing fat in a human including administering to a subject in need thereof, a therapeutically effective amount of a compound of any one of embodiments 1 to 28 and thereby decreasing fat in a human.

### Embodiment 58

A method of decreasing adipose tissue in a human including administering to a subject in need thereof, a therapeutically effective amount of a compound of any one embodiments 1 to 28 and thereby decreasing adipose tissue.

### Embodiment 59

A method of decreasing the weight of a human including administering to a subject in need thereof, a therapeutically effective amount of a compound of any one embodiments 1 to 28 and thereby decreasing the weight of a human.

### Embodiment 60

A method of reducing hair loss in a human including administering to a subject in need thereof, a therapeutically effective amount of a compound of any one embodiments 1 to 28 and thereby reducing hair loss.

### Embodiment 61

A method of treating glaucoma in a human including administering to a subject in need thereof, a therapeutically effective amount of a compound of any one embodiments 1 to 28 and thereby treating glaucoma.

### Embodiment 62

A method of preventing glaucoma in a human including administering to a subject at increased risk of glaucoma, a prophylactically effective amount of a compound of any one embodiments 1 to 28 and thereby preventing glaucoma.

### Embodiment 63

A method of treating intraocular hypertension in a human including administering to a subject in need thereof, a therapeutically effective amount of a compound of any one embodiments 1 to 28 and thereby treating intraocular hypertension.

### Embodiment 64

The method of any one of embodiments 45 to 63, wherein the administering is topical administering.

### Embodiment 65

The method of any one of embodiments 45 to 60, wherein the administering is topical epidermal administering.

### Embodiment 66

The method of any one of embodiments 42, 43, 44, 61, 62, or 63, wherein the administering is topical ocular administering.

### DETAILED DESCRIPTION OF THE INVENTION

### I. Definitions

Unless otherwise stated, the following terms used in the specification and claims are defined for the purposes of this application and have the following meaning. The abbreviations used herein have their conventional meaning within the chemical and biological arts. The chemical structures and formulae set forth herein are constructed according to the standard rules of chemical valency known in the chemical arts.

The term “alkyl,” by itself or as part of another substituent, means, unless otherwise stated, a straight (i.e. unbranched) or branched chain, or combination thereof, which may be fully saturated (referred to herein as a “saturated alkyl”), mono- or polyunsaturated and can include di- and multivalent radicals, having the number of carbon atoms designated (i.e. C₁-C₁₀ means one to ten carbons). In some embodiments, all alkyls set forth as a substituent of the compounds provided herein are saturated alkyls. Examples of saturated hydrocarbon radicals include, but are not limited to, groups such as methyl, ethyl, n-propyl, isopropyl, n-butyl, t-butyl, isobutyl, sec-butyl, homologs and isomers of, for example, n-pentyl, n-hexyl, n-heptyl, n-octyl, and the like. An unsaturated alkyl group is one having one or more double bonds or triple bonds. An “alkoxy” is an alkyl attached to the remainder of the molecule via an oxygen linker (—O—). An “alkylthio” is an alkyl attached to the remainder of the molecule via an sulfur linker (—S—). A “haloalkoxy” is an alkoxy substituted with a halogen. When the halogen is a fluoro, it is referred to herein as a “fluoroalkoxy.” The term “alkyl” includes saturated alkyl, alkenyl and alkynyl. A saturated alkyl may have from 1 to 10 or 1 to 6 carbon atoms. The term “alkenyl” by itself or as part of another substituent, means, unless otherwise stated, a straight (i.e. unbranched) or branched hydrocarbon chain (e.g., two to ten, or two to six carbon atoms) having one or more double bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), and the like. The term “alkynyl” by itself or as part of another substituent, means, unless otherwise stated, a straight (i.e. unbranched) or branched hydrocarbon chain (e.g., two to ten or two to six carbon atoms) having one or more triple bonds. Examples of alkynyl groups include, but are not limited to, ethynyl, 1- and 3-propynyl, 3-butynyl, and the like.

“Aminocarbonyl” means a —CONRR′ radical where R is independently hydrogen, unsubstituted alkyl, or alkyl substituted with a substituent group and R′ is hydrogen, unsubstituted alkyl, unsubstituted cycloalkyl, unsubstituted cycloalkylalkyl, unsubstituted aryl, unsubstituted aralkyl, unsubstituted heteroaryl, unsubstituted heteroaralkyl, unsubstituted heterocycloalkyl, unsubstituted heterocyclylalkyl, or alkyl substituted with a substituent group, each as defined herein and wherein the aryl, heteroaryl, or heterocyclyl ring either alone or part of another group e.g., aralkyl, is optionally substituted with one, two, or three substituent group(s). Likewise, “aminosulfonyl” means a —SO₂NRR′ radical where R and R′ are as defined for aminocarbonyl.

The term “alkylene”, “alkenylene, and “alkynylene” by itself or as part of another substituent means a divalent radical derived from an alkyl, alkenyl, or alkynyl as exemplified, but not limited, by methylene, ethylene, —CH₂CH₂CH₂CH₂—, vinylene and the like.

The term “amino” as used herein means a —NH₂. The term “carboxy” as used herein means —COOH (including pharmaceutically acceptable salts thereof).

The term “heteroalkyl,” by itself or in combination with another term, means, unless otherwise stated, a stable straight or branched chain or combinations thereof, consisting of at least one carbon atom and at least one heteroatom selected from the group consisting of O, N, P, Si or S, and wherein the nitrogen and sulfur atoms may optionally be oxidized and the nitrogen heteroatom may optionally be quaternized. The heteroatom(s) O, N, P, S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, —CH═CH—N(CH₃)—CH₃, —O—CH₃, —O—CH₂—CH₃, and —CN. Up to two heteroatoms may be consecutive, such as, for example, —CH₂—NH—OCH₃. Similarly, the term “heteroalkylene” by itself or as part of another substituent means a divalent radical derived from heteroalkyl, as exemplified, but not limited by, —CH₂—CH₂—S—CH₂—CH₂— and CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). As described above, heteroalkyl groups, as used herein, include those groups that are attached to the remainder of the molecule through a heteroatom

The terms “cycloalkyl” and “heterocycloalkyl,” by themselves or in combination with other terms, represent, unless otherwise stated, non-aromatic cyclic versions of “alkyl” and “heteroalkyl”, respectively (e.g., having 4 to 8 ring atoms). Additionally, for heterocycloalkyl, a heteroatom can occupy the position at which the heterocycle is attached to the remainder of the molecule. Heterocycloalkyls may include one or two ring heteroatoms selected from N, O, or S(O)_{n′}, where n′ is an integer from 0 to 2, the remaining ring atoms being carbon.

The heterocycloalkyl or cycloalkyl ring is optionally fused to one or more aryl or heteroaryl rings as defined herein (e.g., where the aryl and heteroaryl rings are monocyclic). The heterocycloalkyl or cycloalkyl ring fused to monocyclic aryl or heteroaryl ring may be referred to in this application as “bicyclic heterocycloalkyl” ring or a “bicyclic cycloalkyl” ring. Additionally, one or two ring carbon atoms in the heterocycloalkyl ring can optionally be replaced by a —C(O)— group. More specifically the term heterocycloalkyl includes, but is not limited to, pyrrolidino, piperidino, homopiperidino, 2-oxopyrrolidinyl, 2-oxopiperidinyl, morpholino, piperazino, tetrahydropyranyl, thiomorpholino, dihydroindolyl, and the like. When the heterocycloalkyl ring is unsaturated it can contain one or two ring double bonds provided that the ring is not aromatic. When the heterocycloalkyl group contains at least one nitrogen atom, it may also be referred to herein as heterocycloamino and is a subset of the heterocycloalkyl group. When the heterocycloalkyl group is a saturated ring and is not fused to aryl or heteroaryl ring as stated above, it may be referred to herein as a saturated monocyclic heterocycloalkyl. Examples of cycloalkyl include, but are not limited to, cyclopropyl, cyclobutyl, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1 piperazinyl, 2-piperazinyl, and the like. A “cycloalkylene” and a “heterocycloalkylene,” alone or as part of another substituent means a divalent radical derived from a cycloalkyl and heterocycloalkyl, respectively.

The terms “halo” or “halogen,” by themselves or as part of another substituent, mean, unless otherwise stated, a fluorine, chlorine, bromine, or iodine atom. Additionally, terms such as “haloalkyl,” are meant to include monohaloalkyl and polyhaloalkyl. For example, the term “halo(C₁-C₄)alkyl” is meant to include, but not be limited to, fluoromethyl, difluoromethyl, trifluoromethyl, 2,2,2-trifluoroethyl, 4-chlorobutyl, 3-bromopropyl, and the like.

The term “acyl” means —C(O)R where R is a substituted or unsubstituted alkyl, substituted or unsubstituted cycloalkyl, substituted or unsubstituted heteroalkyl, substituted or unsubstituted heterocycloalkyl, substituted or unsubstituted aryl or substituted or unsubstituted heteroaryl.

The term “aryl” means, unless otherwise stated, an aromatic substituent which can be a single ring or multiple rings (preferably from 1 to 3 rings) which may be fused together (i.e. a fused ring aryl) or linked covalently. A fused ring aryl refers to multiple rings fused together wherein at least one of the fused rings is an aryl ring (e.g., phenyl, 1-naphthyl, 2-naphthyl, or 4-biphenyl). The term “heteroaryl” refers to aryl groups (or rings) that contain one or more (e.g., 4) heteroatoms selected from N, O, and S, wherein the nitrogen and sulfur atoms are optionally oxidized, and the nitrogen atom(s) are optionally quaternized, the remaining ring atoms being carbon. The heteroaryl may be a monovalent monocyclic, bicyclic, or tricyclic (e.g., monocyclic or bicyclic) aromatic radical of 5 to 14 (e.g., 5 to 10) ring atoms where one or more, (e.g., one, two, or three or four) ring atoms are heteroatom selected from N, O, or S. Examples include, but are not limited to, thienyl, isoindolyl, benzoxazolyl, pyridazinyl, triazolyl, tetrazolyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidinyl, 4-pyrimidinyl, 5-benzothiazolyl, 2-benzimidazolyl, 5-indolyl, 1-isoquinolyl, 5-isoquinolyl, 2-quinoxalinyl, 5-quinoxalinyl, 3-quinolyl, and 6-quinolyl. Thus, the term “heteroaryl” includes fused ring heteroaryl groups (i.e. multiple rings fused together wherein at least one of the fused rings is a heteroaromatic ring). A 5,6-fused ring heteroaryl refers to two rings fused together, wherein one ring has 5 members and the other ring has 6 members, and wherein at least one ring is a heteroaryl ring. Likewise, a 6,6-fused ring heteroaryl refers to two rings fused together, wherein one ring has 6 members and the other ring has 6 members, and wherein at least one ring is a heteroaryl ring. And a 6,5-fused ring heteroaryl refers to two rings fused together, wherein one ring has 6 members and the other ring has 5 members, and wherein at least one ring is a heteroaryl ring. A heteroaryl group can be attached to the remainder of the molecule through a carbon or heteroatom. An “arylene” and a “heteroarylene,” alone or as part of another substituent means a divalent radical derived from an aryl and heteroaryl, respectively.

The terms “arylalkyl” and “heteroarylalkyl” is meant to include those radicals in which an aryl group or a heteroaryl group is attached to an alkyl group (e.g., benzyl, phenethyl, pyridylmethyl and the like) including those alkyl groups in which a carbon atom (e.g., a methylene group) has been replaced by, for example, an oxygen atom (e.g., phenoxymethyl, 2-pyridyloxymethyl, 3-(1-naphthyloxy)propyl, and the like).

The term “oxo” as used herein means an oxygen that is double bonded to a carbon atom. The term “carbonyl” as used herein refers to a —C(O)— group.

The symbol “ [symbol] ” indicates, as customary in the art, the point of attachment of a substituent.

“Optional” or “optionally” means that the subsequently described event or circumstance may but need not occur, and that the description includes instances where the event or circumstance occurs and instances in which it does not. For example, “heterocycloalkyl group optionally substituted with an alkyl group” means that the alkyl may but need not be present, and the description includes situations where the heterocycloalkyl group is substituted with an alkyl group and situations where the heterocycloalkyl group is not substituted with alkyl.

The term “alkylsulfonyl” as used herein means a moiety having the formula —S(O₂)—R′, where R′ is an alkyl group as defined above. R′ may have a specified number of carbons (e.g., “C₁-C₄ alkylsulfonyl”).

Each of the above terms (e.g., “alkyl”, “heteroalkyl”, “cycloalkyl”, “heterocycloalkyl”, “aryl” and “heteroaryl”) are meant to include both substituted and unsubstituted forms of the indicated radical unless stated otherwise.

Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) can be one or more of a variety of groups selected from, but not limited to: —OR′, ═O, ═NR′, ═N—OR′, —NR′R″, —SR′, -halogen, —SiR′R″R″′, —OC(O)R′, —C(O)R′, —CO₂R′, —CONR′R″, —OC(O)NR′R″, —NR″C(O)R′, —NR′—C(O)NR″R″′, —NR″C(O)₂R′, —NR′—C(NR′R″R″′)═NR″″, —NR—C(NR′R″)═NR″″, —S(O)R′, —S(O)₂R′, —S(O)₂NR′R″, —NRSO₂R′, —CN and —NO₂ in a number ranging from zero to (2m′+1), where m′ is the total number of carbon atoms in such radical. R′, R″, R″′ and R″″ each independently refer to hydrogen, substituted or unsubstituted heteroalkyl, substituted or unsubstituted cycloalkyl, substituted or unsubstituted heterocycloalkyl, substituted or unsubstituted aryl (e.g., aryl substituted with 1-3 halogens) substituted or unsubstituted heteroaryl, substituted or unsubstituted alkyl, alkoxy or thioalkoxy groups, or arylalkyl groups. When a compound of the invention includes more than one R group, for example, each of the R groups is independently selected as are each R′, R″, R″′ and R″″ groups when more than one of these groups is present. When R′ and R″ are attached to the same nitrogen atom, they can be combined with the nitrogen atom to form a 4-, 5-, 6-, or 7-membered ring. For example, —NR′R″ is meant to include, but not be limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and CH₂CF₃) and acyl (e.g., —C(O)CH₃, —C(O)CF₃, —C(O)CH₂OCH₃, and the like).

Similar to the substituents described for the alkyl radical, substituents for the aryl and heteroaryl groups are varied and may be selected from, for example: halogen, —OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR′R″, —NR″C(O)₂R′, —NR—C(NR′R″R″′)═NR″″, —NR′—C(NR′R″)═NR″′, —S(O)R′, —S(O)₂R′, —S(O)₂NR′R″, —NR′SO₂R′, —CN and NO₂, —R′, —N₃, —CH(Ph)₂, fluoro(C₁-C₄)alkoxy, and fluoro(C₁-C₄)alkyl, in a number ranging from zero to the total number of open valences on the aromatic ring system; and where R′, R″, R″′ and R″″ are preferably independently selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl and substituted or unsubstituted heteroaryl. When a compound of the invention includes more than one R group, for example, each of the R groups is independently selected as are each R′, R″, R″′ and R″″ groups when more than one of these groups is present.

Two of the substituents on adjacent atoms of the aryl or heteroaryl ring may optionally form a ring of the formula -T-C(O)—(CRR′)_{q}—U—, wherein T and U are independently NR—, —O—, —CRR′— or a single bond, and q is an integer of from 0 to 3. Alternatively, two of the substituents on adjacent atoms of the aryl or heteroaryl ring may optionally be replaced with a substituent of the formula -A-(CH₂)ᵣ—B—, wherein A and B are independently CRR′—, —O—, —NR—, —S—, —S(O)—, —S(O)₂—, —S(O)₂NR′— or a single bond, and r is an integer of from 1 to 4. One of the single bonds of the new ring so formed may optionally be replaced with a double bond. Alternatively, two of the substituents on adjacent atoms of the aryl or heteroaryl ring may optionally be replaced with a substituent of the formula —(CRR′)ₛ—X′—(C″R″′)_{d}—, where s and d are independently integers of from 0 to 3, and X′ is —O—, —NR′—, —S—, —S(O)—, —S(O)₂—, or S(O)₂NR′—. The substituents R, R′, R″ and R″′ are preferably independently selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl.

Unless otherwise stated, the term “heteroatom” or “ring heteroatom” is meant to include oxygen (O), nitrogen (N), sulfur (S), phosphorus (P), and silicon (Si).

A “substituent group,” as used herein, means a group selected from the following moieties:

(A) —OH, —NH₂, —SH, —CN, —CF₃, —NO₂, oxo, halogen, unsubstituted alkyl, unsubstituted heteroalkyl, unsubstituted cycloalkyl, unsubstituted heterocycloalkyl, unsubstituted aryl, unsubstituted heteroaryl, and

(B) alkyl, heteroalkyl, cycloalkyl, heterocycloalkyl, aryl, and heteroaryl, substituted with at least one substituent selected from:

(i) oxo, —OH, —NH₂, —SH, —CN, —CF₃, —NO₂, halogen, unsubstituted alkyl, unsubstituted heteroalkyl, unsubstituted cycloalkyl, unsubstituted heterocycloalkyl, unsubstituted aryl, unsubstituted heteroaryl, and

(ii) alkyl, heteroalkyl, cycloalkyl, heterocycloalkyl, aryl, and heteroaryl, substituted with at least one substituent selected from:

(a) oxo, —OH, —NH₂, —SH, —CN, —CF₃, —NO₂, halogen, unsubstituted alkyl, unsubstituted heteroalkyl, unsubstituted cycloalkyl, unsubstituted heterocycloalkyl, unsubstituted aryl, unsubstituted heteroaryl, and

(b) alkyl, heteroalkyl, cycloalkyl, heterocycloalkyl, aryl, or heteroaryl, substituted with at least one substituent selected from oxo, —OH, —NH₂, —SH, —CN, —CF₃, —NO₂, halogen, unsubstituted alkyl, unsubstituted heteroalkyl, unsubstituted cycloalkyl, unsubstituted heterocycloalkyl, unsubstituted aryl, and unsubstituted heteroaryl.

A “size-limited substituent” or “size-limited substituent group,” as used herein means a group selected from all of the substituents described above for a “substituent group,” wherein each substituted or unsubstituted alkyl is a substituted or unsubstituted C₁-C₂₀ alkyl, each substituted or unsubstituted heteroalkyl is a substituted or unsubstituted 2 to 20 membered heteroalkyl, each substituted or unsubstituted cycloalkyl is a substituted or unsubstituted C₄-C₈ cycloalkyl, and each substituted or unsubstituted heterocycloalkyl is a substituted or unsubstituted 4 to 8 membered heterocycloalkyl.

A “lower substituent” or “lower substituent group,” as used herein means a group selected from all of the substituents described above for a “substituent group,” wherein each substituted or unsubstituted alkyl is a substituted or unsubstituted C₁-C₈ alkyl, each substituted or unsubstituted heteroalkyl is a substituted or unsubstituted 2 to 8 membered heteroalkyl, each substituted or unsubstituted cycloalkyl is a substituted or unsubstituted C₅-C₇ cycloalkyl, and each substituted or unsubstituted heterocycloalkyl is a substituted or unsubstituted 5 to 7 membered heterocycloalkyl.

Unless indicated otherwise, the term “derivative” in the context of a compound disclosed herein refers to a compound afforded by chemical modification, e.g., by the bonding of one or more substituent groups as described herein.

Unless indicated otherwise, the term “monosaccharide moiety” in the context of a substituent for a compound as described herein is used in accordance with its plain ordinary meaning within biology and chemistry and refers to a carbohydrate moiety that may be linear (acyclic) or cyclic, unsubstituted or substituted with respect to non-carbohydrate groups (e.g. amino acids, acetyl moieties, sulphur containing moieties), and may be a single isomer (e.g. stereoisomers, enantiomers, linear or cyclic) or a mixture of isomers. A monosaccharide moiety is a monovalent form of a monosaccharide. In some embodiments, a monosaccharide is a diose, triose, tetrose, pentose, hexose, heptose, octose, or nonose, or may contain more carbon atoms. In some embodiments, a monosaccharide may be described by the formula C_{X}(H₂O)_{y}, wherein the symbols x and y are integers and each is at least 3. In some embodiments, a monosaccharide may be described by the formula CₓH₂(H₂O)_{y}, wherein the symbols x and y are integers, x is at least 3 and y is at least 2 (e.g. deoxyribose). Examples of monosaccharides include glycoaldehyde, glyceraldehyde (e.g. D or L), erythrose, threose, erythrulose, arabinose, lyxose, ribose, xylose, ribulose, xylulose, deoxyribose, allose, altrose, glucose, mannose, gulose, idose, galactose, talose, psicose, fructose, sorbose, tagatose. In some embodiments, a monosaccharide is a pyranose. In some embodiments, a monosaccharide is a furanose. In some embodiments a monosaccharide is cyclic. In some embodiments a monosaccharide is acyclic. In some embodiments a monosaccharide moiety is bonded to the remainder of a molecule through a —O— of the monosaccharide moiety. In some embodiments a monosaccharide moiety is bonded to the remainder of the molecule through a carbon of the monosaccharide moiety.

The term “pharmaceutically acceptable salts” is meant to include salts of the active compounds which are prepared with relatively nontoxic acids or bases, depending on the particular substituents found on the compounds described herein. When compounds of the present invention contain relatively acidic functionalities, base addition salts can be obtained by contacting the neutral form of such compounds with a sufficient amount of the desired base, either neat or in a suitable inert solvent. Examples of pharmaceutically acceptable base addition salts include sodium, potassium, calcium, ammonium, organic amino, or magnesium salt, or a similar salt. When compounds of the present invention contain relatively basic functionalities, acid addition salts can be obtained by contacting the neutral form of such compounds with a sufficient amount of the desired acid, either neat or in a suitable inert solvent. Examples of pharmaceutically acceptable acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids and the like, as well as the salts derived from relatively nontoxic organic acids like acetic, propionic, isobutyric, maleic, malonic, benzoic, succinic, suberic, fumaric, lactic, mandelic, phthalic, benzenesulfonic, p-tolylsulfonic, citric, tartaric, oxalic, methanesulfonic, and the like. Also included are salts of amino acids such as arginate and the like, and salts of organic acids like glucuronic or galactunoric acids and the like. See e.g., Berge et al., “Pharmaceutical Salts”, Journal of Pharmaceutical Science, 1977, 66, 1-19). Additional information on suitable pharmaceutically acceptable salts can be found in REMINGTON'S PHARMACEUTICAL SCIENCES, 17th ed., Mack Publishing Company, Easton, Pa., 1985, which is incorporated herein by reference. Certain specific compounds of the present invention contain both basic and acidic functionalities that allow the compounds to be converted into either base or acid addition salts.

Thus, the compounds disclosed herein may exist as salts. Examples of such salts include hydrochlorides, hydrobromides, sulfates, methanesulfonates, nitrates, maleates, acetates, citrates, fumarates, tartrates (e.g., (+)-tartrates, (−)-tartrates or mixtures thereof including racemic mixtures), succinates, benzoates and salts with amino acids such as glutamic acid. These salts may be prepared by methods known to those skilled in the art.

The neutral forms of the compounds are preferably regenerated by contacting the salt with a base or acid and isolating the parent compound in the conventional manner. The parent form of the compound differs from the various salt forms in certain physical properties, such as solubility in polar solvents.

The term “prodrug” is used according to its plain ordinary meaning and is intended to mean compounds that require a chemical or enzymatic transformation in order to release the active parent drug in vivo prior to producing a pharmacological effect.

The compounds of the present invention may have asymmetric centers and/or geometric isomers. Compounds of the present invention containing an asymmetrically substituted atom may be isolated in optically active or racemic forms. It is well known in the art how to prepare optically active forms, such as by resolution of materials. All chiral, diastereomeric, racemic forms are within the scope of this invention, unless the specific stereochemistry or isomeric form is specifically indicated. All possible tautomers and cis and trans isomers, as individual forms and mixtures thereof are within the scope of this invention. Additionally, as used herein the term alkyl includes all the possible isomeric forms of the alkyl group albeit only a few examples are set forth. Furthermore, when the cyclic groups such as aryl, heteroaryl, heterocycloalkyl are substituted, they include all the positional isomers albeit only a few examples are set forth. Furthermore, all polymorphic forms, including amorphous form, and hydrates of a compound disclosed herein are within the scope of this invention.

Certain compounds of the present invention possess asymmetric carbon atoms (optical centers) or double bonds; the racemates, diastereomers, tautomers, geometric isomers and individual isomers are encompassed within the scope of the present invention, as are enantiomers. The compounds of the present invention do not include those which are known in the art to be too unstable to synthesize and/or isolate.

The compounds of the present invention may also contain unnatural proportions of atomic isotopes at one or more of the atoms that constitute such compounds. For example, the compounds may be radiolabeled with radioactive isotopes, such as for example tritium (³H), iodine-125 (¹²⁵I) or carbon-14 (¹⁴C). All isotopic variations of the compounds of the present invention, whether radioactive or not, are encompassed within the scope of the present invention.

Where a substituent of a compound provided herein is “R-substituted” (e.g., R⁷-substituted), it is meant that the substituent is substituted with one or more of the named R groups (e.g., R⁷) as appropriate. Each appearance of the substituent may be different. In some embodiments, the substituent is substituted with only one of the named R groups. Each of the numbered R substituents provided herein may be alternatively referred to as a primed number such as a first prime (′), a second prime (″), a third prime (″′) and so on. For example, R⁷ may be alternatively referred to as R^{7′}, R^{7″}, R^{7″′} and so on. Unless otherwise noted, the primed number of the R substituent is accorded the same definition as the R substituent itself, but where the primed number of the R substituent is optionally different from the R substituent itself when both appear in a compound disclosed herein. For example, R⁷ and R^{7′}, unless otherwise stated, are independently chosen from the same Markush group definition. Unless indicated otherwise, a “substituted” moiety (e.g. substituted alkyl, substituted heteroalkyl, substituted cycloalkyl, substituted heterocycloalkyl, substituted aryl, substituted heteroaryl), may be substituted with one or more substituents and each substituent may optionally be different. When a group of possible substituents (e.g. a Markush group) for a moiety is provided, the moiety may be substituted with one or more of the possible substituents and each substituent may optionally be different. The terms “a” or “an,” as used in herein means one or more. In addition, the phrase “substituted with a[n],” as used herein, means the specified group may be substituted with one or more of any or all of the named substituents. For example, where a group, such as an alkyl or heteroaryl group, is “substituted with an unsubstituted C₁-C₂₀ alkyl, or unsubstituted 2 to 20 membered heteroalkyl,” the group may contain one or more unsubstituted C₁-C₂₀ alkyls, and/or one or more unsubstituted 2 to 20 membered heteroalkyls. It should be noted that throughout the application that alternatives are written in Markush groups, for example, each amino acid position that contains more than one possible amino acid. It is specifically contemplated that each member of the Markush group should be considered separately, thereby comprising another embodiment.

A “pharmaceutically acceptable carrier” or “pharmaceutically acceptable excipient” means a carrier or an excipient that is useful in preparing a pharmaceutical composition that is generally safe, non-toxic and neither biologically nor otherwise undesirable, and includes a carrier or an excipient that is acceptable for veterinary use as well as human pharmaceutical use. “A pharmaceutically acceptable carrier/excipient” as used in the specification and claims includes both one and more than one such excipient.

The terms “treating” or “treatment” refers to any indicia of success in the treatment or amelioration of an injury, pathology or condition, including any objective or subjective parameter such as abatement; remission; diminishing of symptoms or making the injury, pathology or condition more tolerable to the patient; slowing in the rate of degeneration or decline; making the final point of degeneration less debilitating; improving a patient's physical or mental well-being. The treatment or amelioration of symptoms can be based on objective or subjective parameters; including the results of a physical examination, neuropsychiatric exams, and/or a psychiatric evaluation. For example, the certain methods presented herein successfully treat inflammation by decreasing the incidence of inflammation, in inhibiting its spread and or causing reduction of existing inflammation. For example, the certain methods presented herein successfully treat alopecia by decreasing the incidence of hair loss or increasing the incidence of new hair growth or increasing the rate of hair growth. For example, the certain methods presented herein successfully treat glaucoma by reducing intraocular pressure, by increasing the flow rate of aqueous humor out of the eye; by increasing the flow rate of aqueous humor through the anterior chamber angle, or by reducing inflammation in the eye. For example, the certain methods presented herein successfully reduce adipocyte tissue by reducing the formation of adipocyte tissue or reducing the accumulation of adipose in the adipocyte tissue or increasing the reduction

An “effective amount” of a compound is an amount sufficient to contribute to the treatment, prevention, or reduction of a symptom or symptoms of a disease. Where recited in reference to a disease treatment, an “effective amount” may also be referred to as a “therapeutically effective amount.” A “reduction” of a symptom or symptoms (and grammatical equivalents of this phrase) means decreasing of the severity or frequency of the symptom(s), or elimination of the symptom(s). A “prophylactically effective amount” of a drug is an amount of a drug that, when administered to a subject, will have the intended prophylactic effect, e.g., preventing or delaying the onset (or reoccurrence) a disease, disorder or condition, or reducing the likelihood of the onset (or reoccurrence) of a disease, disorder or condition or symptoms thereof. The full prophylactic effect does not necessarily occur by administration of one dose, and may occur only after administration of a series of doses. Thus, a prophylactically effective amount may be administered in one or more administrations.

The term “topical” in the context of methods described herein relates in the customary sense to the administration of a compound or pharmaceutical composition which is incorporated into a suitable pharmaceutical carrier and administered at a topical treatment site of a subject. Accordingly, the term “topical pharmaceutical composition” includes those pharmaceutical forms in which the compound is administered externally by direct contact with a topical treatment site, e.g., the eye or the skin. The term “topical ocular pharmaceutical composition” refers to a pharmaceutical composition suitable for administering directly to the eye. The term “topical epidermal pharmaceutical composition” refers to a pharmaceutical composition suitable for administering directed to the epidermal layer of the skin, e.g., the palpebra, the supercilium, the scalp, or the body. The term “topical administering” refers to administering externally by direct contact with a topical treatment site. The term “topical epidermal administering” refers to administering externally by direct contact with the epidermis. The term “topical ocular administering” refers to administering externally by direct contact with the eye.

Methods of administering to the skin may include “topical palpebra administering” which refers to administering to the palpebra (i.e., eyelid) and especially the portion of the palpebra from which the cilia (i.e., eyelashes) grow. Methods of administering to the skin further include “topical supercilium administering” which refers to administering to the supercilium (i.e., the ridge above the eye) from which the supercilia (i.e., eyebrows) grow. Methods of administering to the skin further include “topical scalp administering” which refers to administering directly to the scalp. Methods of administering to the skin further include “topical body administering” which refers to administering directly to parts of the body excluding the scalp.

Conventional pharmaceutical forms for this purpose include ointments, liniments, creams, shampoos, lotions, pastes, jellies, sprays, aerosols, and the like, and may be applied in patches or impregnated dressings depending on the part of the body to be treated. The term “ointment” embraces formulations (including creams) having oleaginous, water-soluble and emulsion-type bases, e.g., petrolatum, lanolin, polyethylene glycols, as well as mixtures of these.

The term “piliation” refers in the customary sense to the formation and growth of hair. Accordingly, piliation and “hair growth” are used synonymously herein.

The term “prostamide” as used herein is used in accordance with its plain ordinary meaning within biology and chemistry and refers to prostaglandin-ethanolamide compounds that are cyclooxygenase-2 (COX-2) derived oxidation products of anandamide. In some embodiments, a prostamide is prostamide O₂, prostamide H₂, prostamide F₂, 9,11-prostamide F₂, or prostamide E₂.

### II. Compounds

In a first aspect, there is provided a compound with structure of Formula (I),

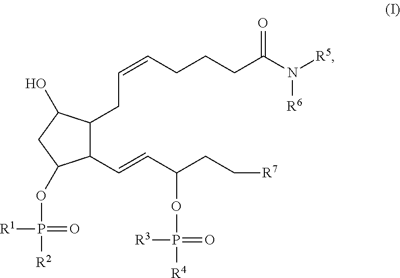

or derivative, isomer, or enantiomer thereof.
Referring to Formula (I), R¹ is —OR^{8A}, —NR^{9A}R^{10A}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R² is —OR^{8B}, —NR^{9B}R^{10B}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R³ is —OR^{8C}, —NR^{9C}R^{10C}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R⁴ is —OR^{8D}, —NR^{9D}R^{10D}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R⁵ and R⁶ are independently hydrogen, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R⁷ is substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl. R^{8A}, R^{8B}, R^{8C}, R^{8D}, R^{9A}, R^{9B}, R^{9C}, R^{9D}, R^{10A}, R^{10B}, R^{10C} and R^{10D} are independently hydrogen, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl.

In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently hydrogen, substituted or unsubstituted C₁-C₁₀ alkyl (e.g., substituted or unsubstituted C₁-C₁₀ saturated alkyl), substituted or unsubstituted C₃-C₈ cycloalkyl, or substituted or unsubstituted aryl. In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₁-C₆ alkyl (e.g., substituted or unsubstituted C₁-C₆ saturated alkyl). In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₁-C₃ alkyl (e.g., substituted or unsubstituted C₁-C₃ saturated alkyl). In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₁ alkyl. In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted methyl. In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted C₁-C₆ alkyl (e.g., unsubstituted C₁-C₆ saturated alkyl). In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted C₁-C₃ alkyl (e.g., unsubstituted C₁-C₃ saturated alkyl). In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted C₁ alkyl. In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₃-C₈ cycloalkyl (e.g., substituted or unsubstituted C₃-C₆ cycloalkyl). In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted aryl. In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted aryl. In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted phenyl. In one embodiment, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted phenyl.

In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently hydrogen, substituted or unsubstituted C₁-C₁₀ alkyl (e.g., substituted or unsubstituted C₁-C₁₀ saturated alkyl), substituted or unsubstituted C₃-C₈ cycloalkyl, or substituted or unsubstituted aryl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted C₁-C₆ alkyl (e.g., substituted or unsubstituted C₁-C₆ saturated alkyl). In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted C₁-C₃ alkyl (e.g., substituted or unsubstituted C₁-C₃ saturated alkyl). In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted C₁ alkyl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently methyl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently unsubstituted C₁-C₆ alkyl (e.g., unsubstituted C₁-C₆ saturated alkyl). In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently unsubstituted C₁-C₃ alkyl (e.g., unsubstituted C₁-C₃ saturated alkyl). In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently unsubstituted C₁ alkyl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted C₃-C₈ cycloalkyl (e.g., substituted or unsubstituted C₃-C₆ cycloalkyl). In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted aryl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently unsubstituted aryl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted phenyl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently unsubstituted phenyl.

In some embodiments with structure of Formula (I), at least one of R¹, R², R³ and R⁴ is not —OH. For example, in some embodiments, R¹ is not —OH, R² is not —OH, R³ is not —OH, or R⁴ is not —OH. In some embodiments, each of R¹ and R², each of R¹ and R³, each of R² and R³, each of R¹ and R² and R³, or each of R¹ and R⁴, each of R² and R⁴, each of R³ and R⁴, or each of R¹ and R² and R⁴, or each of R⁴ and R² and R3, or each of R¹ and R⁴ and R3, or each of R¹ and R² and R³ and R⁴ is not —OH.

In some embodiments, R¹ is —OR^{8A}, —NR^{9A}R^{10A}, substituted or unsubstituted cycloalkyl, substituted or unsubstituted heterocycloalkyl, substituted or unsubstituted aryl or substituted or unsubstituted heteroaryl. In some embodiments, R² is —OR^{8B}, —NR^{9B}R^{10B}, substituted or unsubstituted cycloalkyl, substituted or unsubstituted heterocycloalkyl, substituted or unsubstituted aryl or substituted or unsubstituted heteroaryl. In some embodiments, R³ is —OR^{8C}, —NR^{9C}R^{10C}, substituted or unsubstituted cycloalkyl, substituted or unsubstituted heterocycloalkyl, substituted or unsubstituted aryl or substituted or unsubstituted heteroaryl. In some embodiments, R⁴ is —OR^{8D}, —NR^{9D}R^{10D}, substituted or unsubstituted cycloalkyl, substituted or unsubstituted heterocycloalkyl, substituted or unsubstituted aryl or substituted or unsubstituted heteroaryl. In some embodiments, R¹ is —OR^{8A}, —NR^{9A}R^{10A}, or a monosaccharide moiety. In some embodiments, R² is —OR^{8B}, —NR^{9B}R^{10B}, or a monosaccharide moiety. In some embodiments, R³ is —OR^{8C}, —NR^{9C}R^{10C}, or a monosaccharide moiety. In some embodiments, R⁴ is —OR^{8D}, —NR^{9D}R^{10D}, or a monosaccharide moiety. In some embodiments, R¹ is a monosaccharide moiety. In some embodiments, R² is a monosaccharide moiety. In some embodiments, R³ is a monosaccharide moiety. In some embodiments, R⁴ is a monosaccharide moiety. In some embodiments, R¹ is a monovalent form of a diose, triose, tetrose, pentose, hexose, heptose, octose, or nonose. In some embodiments, R¹ is monovalent deoxyribose. In some embodiments, R¹ is a monovalent form of glycoaldehyde, glyceraldehyde (e.g. D or L), erythrose, threose, erythrulose, arabinose, lyxose, ribose, xylose, ribulose, xylulose, deoxyribose, allose, altrose, glucose, mannose, gulose, idose, galactose, talose, psicose, fructose, sorbose, or tagatose. In some embodiments, R¹ is a monovalent pyranose. In some embodiments, R¹ is a monovalent furanose. In some embodiments, R² is a monovalent form of a diose, triose, tetrose, pentose, hexose, heptose, octose, or nonose. In some embodiments, R² is monovalent deoxyribose. In some embodiments, R² is a monovalent form of glycoaldehyde, glyceraldehyde (e.g. D or L), erythrose, threose, erythrulose, arabinose, lyxose, ribose, xylose, ribulose, xylulose, deoxyribose, allose, altrose, glucose, mannose, gulose, idose, galactose, talose, psicose, fructose, sorbose, or tagatose. In some embodiments, R² is a monovalent pyranose. In some embodiments, R² is a monovalent furanose. In some embodiments, R³ is a monovalent form of a diose, triose, tetrose, pentose, hexose, heptose, octose, or nonose. In some embodiments, R³ is monovalent deoxyribose. In some embodiments, R³ is a monovalent form of glycoaldehyde, glyceraldehyde (e.g. D or L), erythrose, threose, erythrulose, arabinose, lyxose, ribose, xylose, ribulose, xylulose, deoxyribose, allose, altrose, glucose, mannose, gulose, idose, galactose, talose, psicose, fructose, sorbose, or tagatose. In some embodiments, R³ is a monovalent pyranose. In some embodiments, R³ is a monovalent furanose. In some embodiments, R⁴ is a monovalent form of a diose, triose, tetrose, pentose, hexose, heptose, octose, or nonose. In some embodiments, R⁴ is monovalent deoxyribose. In some embodiments, R⁴ is a monovalent form of glycoaldehyde, glyceraldehyde (e.g. D or L), erythrose, threose, erythrulose, arabinose, lyxose, ribose, xylose, ribulose, xylulose, deoxyribose, allose, altrose, glucose, mannose, gulose, idose, galactose, talose, psicose, fructose, sorbose, or tagatose. In some embodiments, R⁴ is a monovalent pyranose. In some embodiments, R⁴ is a monovalent furanose.

In some embodiments, R^{8A}, R^{8B}, R^{8C} and R^{8D} are independently hydrogen, or hydroxyl-substituted or unsubstituted C₁-C₁₀ alkyl. In some embodiments, R⁵ and R⁶ are independently hydrogen or hydroxyl-substituted or unsubstituted C₁-C₁₀ alkyl. In some embodiments, R⁵ and R⁶ are hydrogen. In some embodiments, R^{9A}, R^{9B}, R^{9C}, R^{9D}, R^{10A}, R^{10B}, R^{10C} and R^{10D} are independently hydrogen or hydroxyl-substituted or unsubstituted C₁-C₁₀ alkyl. In some embodiments, R⁷ is substituted or unsubstituted C₁-C₁₀ alkyl, substituted or unsubstituted cycloalkyl, substituted or unsubstituted heterocycloalkyl, substituted or unsubstituted aryl or substituted or unsubstituted heteroaryl. In some embodiments, R⁷ is substituted or unsubstituted cycloalkyl, substituted or unsubstituted heterocycloalkyl, substituted or unsubstituted aryl or substituted or unsubstituted heteroaryl. In some embodiments, R⁷ is substituted or unsubstituted aryl. In some embodiments, the compound has the formula:

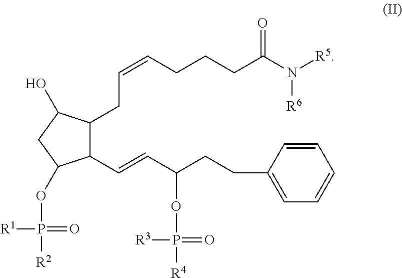

In some embodiments, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₁-C₈ alkyl. In some embodiments, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₁-C₃ alkyl. In some embodiments, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₁ alkyl. In some embodiments, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted methyl. In some embodiments, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted C₃-C₈ cycloalkyl. In some embodiments, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted C₃-C₈ cycloalkyl. In some embodiments, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently substituted or unsubstituted aryl. In some embodiments, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted aryl. In some embodiments, at least one of R^{8A}, R^{8B}, R^{8C}, R^{8D}, R^{9A}, R^{9B}, R^{9C}, R^{9D}, R^{10A}, R^{10B}, R^{10C} and R^{10D} is independently unsubstituted phenyl. In some embodiments, R⁵ is substituted or unsubstituted C₁-C₁₀ alkyl, or substituted or unsubstituted C₃-C₈ cycloalkyl. In some embodiments, R⁵ is substituted or unsubstituted C₁-C₆ alkyl. In some embodiments, R⁵ is substituted or unsubstituted C₁-C₃ alkyl. In some embodiments, R⁵ is substituted or unsubstituted C₂ alkyl. In some embodiments, R⁵ is unsubstituted ethyl. In some embodiments, R⁵ is substituted or unsubstituted C₃-C₈ cycloalkyl. In some embodiments, R⁶ is hydrogen. In some embodiments, the compound has the formula:

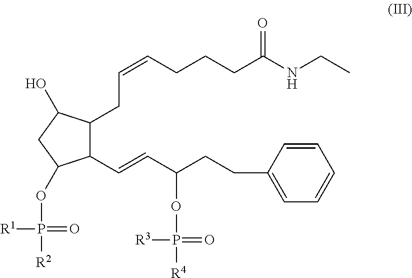

In some embodiments of the compounds provided herein, R¹ is —OR^{8a}, —NR^{9a}R^{10a}, R²⁰-substituted or unsubstituted C₁-C₁₀ alkyl, R²⁰-substituted or unsubstituted 2 to 10 membered heteroalkyl, R²⁰-substituted or unsubstituted cycloalkyl, R²⁰-substituted or unsubstituted heterocycloalkyl, R²⁰-substituted or unsubstituted aryl, or R²⁰-substituted or unsubstituted heteroaryl. In some embodiments of the compounds provided herein, R¹ is R²⁰-substituted or unsubstituted C₁-C₁₀ alkyl, R²⁰-substituted or unsubstituted 2 to 10 membered heteroalkyl, R²⁰-substituted or unsubstituted C₃-C₈ cycloalkyl, R²⁰-substituted or unsubstituted 3 to 8 membered heterocycloalkyl, R²⁰-substituted or unsubstituted C₅-C₁₀ aryl, or R²⁰-substituted or unsubstituted 5 to 10 membered heteroaryl. In some embodiments of the compounds provided herein, R¹ is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R¹ is R²⁰-substituted or unsubstituted C₁-C₁₀ saturated alkyl. In some embodiments of the compounds provided herein, R¹ is R²⁰-substituted or unsubstituted C₁-C₆ alkyl. In some embodiments of the compounds provided herein, R¹ is R²⁰-substituted or unsubstituted C₁-C₆ saturated alkyl. In some embodiments of the compounds provided herein, R¹ is R²⁰-substituted or unsubstituted C₁-C₄ alkyl. In some embodiments of the compounds provided herein, R¹ is R²⁰-substituted or unsubstituted C₁-C₄ saturated alkyl. In some embodiments of the compounds provided herein, R¹ is unsubstituted C₁-C₄ saturated alkyl. In some embodiments, R¹ is R²⁰-substituted or unsubstituted C₁-C₁₀ alkyl (e.g., R²⁰-substituted or unsubstituted C₁-C₁₀ saturated alkyl), R²⁰-substituted or unsubstituted C₃-C₈ cycloalkyl, or R²⁰-substituted or unsubstituted aryl. In some embodiments, R¹ is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R¹ is unsubstituted C₁-C₁₀ alkyl (e.g., unsubstituted C₁-C₁₀ saturated alkyl), or unsubstituted aryl (e.g., phenyl). In some embodiments, R¹ is unsubstituted C₁-C₅ alkyl (e.g., unsubstituted C₁-C₅ saturated alkyl), or unsubstituted aryl (e.g., phenyl).

R²⁰ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R²¹-substituted or unsubstituted alkyl (e.g. R²¹-substituted or unsubstituted saturated alkyl), R²¹-substituted or unsubstituted heteroalkyl, R²¹-substituted or unsubstituted cycloalkyl, R²¹-substituted or unsubstituted heterocycloalkyl, R²¹-substituted or unsubstituted aryl, or R²¹-substituted or unsubstituted heteroaryl. In some embodiments, R²⁰ is halogen, —CN, —CF₃, —OH, —NO₂, —C(O)NH₂, —SH, —NH₂, —SO₂, —COOH, R²¹-substituted or unsubstituted C₁-C₁₀ alkyl (e.g., R²¹-substituted or unsubstituted saturated C₁-C₁₀ alkyl), R²¹-substituted or unsubstituted 2 to 10 membered heteroalkyl, R²¹-substituted or unsubstituted C₃-C₈ cycloalkyl, R²¹-substituted or unsubstituted 3 to 8 membered heterocycloalkyl, R²¹-substituted or unsubstituted C₅-C₁₀ aryl, or R²¹-substituted or unsubstituted 5 to 10 membered heteroaryl. In some embodiments, R²⁰ is R²¹-substituted or unsubstituted C₁-C₁₀ alkyl (e.g., R²¹-substituted or unsubstituted saturated C₁-C₁₀ alkyl), R²¹-substituted or unsubstituted C₃-C₈ cycloalkyl, or R²¹-substituted or unsubstituted aryl. In some embodiments, R²⁰ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R²⁰ is unsubstituted C₁-C₁₀ alkyl (e.g., unsubstituted C₁ to C₁₀ saturated alkyl). In some embodiments, R²⁰ is unsubstituted C₁-C₄ alkyl (e.g., unsubstituted C₁ to C₄ saturated alkyl). In some embodiments, R²⁰ is unsubstituted C₃-C₈ cycloalkyl. In some embodiments, R²⁰ is unsubstituted aryl (e.g., phenyl).

R²¹ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R²²-substituted or unsubstituted alkyl (e.g., R²²-substituted or unsubstituted saturated alkyl), R²²-substituted or unsubstituted heteroalkyl, R²²-substituted or unsubstituted cycloalkyl, R²²-substituted or unsubstituted heterocycloalkyl, R²²-substituted or unsubstituted aryl, or R²²-substituted or unsubstituted heteroaryl. In some embodiments, R²¹ is halogen, —CN, —CF₃, —OH, —NO₂, —C(O)NH₂, —SH, —NH₂, —SO₂, —COOH, R²²-substituted or unsubstituted C₁-C₁₀ alkyl (e.g., R²²-substituted or unsubstituted saturated C₁-C₁₀ alkyl), R²²-substituted or unsubstituted 2 to 10 membered heteroalkyl, R²²-substituted or unsubstituted C₃-C₈ cycloalkyl, R²²-substituted or unsubstituted 3 to 8 membered heterocycloalkyl, R²²-substituted or unsubstituted C₅-C₁₀ aryl, or R²²-substituted or unsubstituted 5 to 10 membered heteroaryl. In some embodiments, R²¹ is R²²-substituted or unsubstituted C₁-C₁₀ alkyl (e.g., R²²-substituted or unsubstituted saturated C₁-C₁₀ alkyl), R²²-substituted or unsubstituted C₃-C₈ cycloalkyl or R²²-substituted or unsubstituted aryl. In some embodiments, R²¹ is unsubstituted C₁-C₁₀ alkyl (e.g., unsubstituted C₁ to C₁₀ saturated alkyl). In some embodiments, R²¹ is unsubstituted C₁-C₄ alkyl (e.g., unsubstituted C₁ to C₄ saturated alkyl). In some embodiments, R²¹ is unsubstituted C₃-C₈ cycloalkyl. In some embodiments, R²¹ is unsubstituted aryl (e.g., phenyl).

In some embodiments of the compounds provided herein, R² is —OR^{8b}, —NR^{9b}R^{10b}, R²³-substituted substituted or unsubstituted C₁-C₁₀ alkyl, R²³-substituted or unsubstituted 2 to 10 membered heteroalkyl, R²³-substituted or unsubstituted cycloalkyl, R²³-substituted or unsubstituted heterocycloalkyl, R²³-substituted or unsubstituted aryl, or R²³-substituted or unsubstituted heteroaryl. In some embodiments of the compounds provided herein, R² is R²³-substituted or unsubstituted C₁-C₁₀ alkyl, R²³-substituted or unsubstituted 2 to 10 membered heteroalkyl, R²³-substituted or unsubstituted C₃-C₈ cycloalkyl, R²³-substituted or unsubstituted 3 to 8 membered heterocycloalkyl, R²³-substituted or unsubstituted C₅-C₁₀ aryl, or R²³-substituted or unsubstituted 5 to 10 membered heteroaryl. In some embodiments of the compounds provided herein, R² is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R² is R²³-substituted or unsubstituted C₁-C₁₀ saturated alkyl. In some embodiments of the compounds provided herein, R² is R²³-substituted or unsubstituted C₁-C₆ alkyl. In some embodiments of the compounds provided herein, R² is R²³-substituted or unsubstituted C₁-C₆ saturated alkyl. In some embodiments of the compounds provided herein, R² is R²³-substituted or unsubstituted C₁-C₄ alkyl. In some embodiments of the compounds provided herein, R² is R²³-substituted or unsubstituted C₁-C₄ saturated alkyl. In some embodiments of the compounds provided herein, R² is unsubstituted C₁-C₄ saturated alkyl. In some embodiments, R² is R²³-substituted or unsubstituted C₁-C₁₀ alkyl (e.g., R²³-substituted or unsubstituted C₁-C₁₀ saturated alkyl), R²³-substituted or unsubstituted C₃-C₈ cycloalkyl, or R²³-substituted or unsubstituted aryl. In some embodiments, R² is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R² is unsubstituted C₁-C₁₀ alkyl (e.g., unsubstituted C₁-C₁₀ saturated alkyl), or unsubstituted aryl (e.g., phenyl). In some embodiments, R² is unsubstituted C₁-C₅ alkyl (e.g., unsubstituted C₁-C₅ saturated alkyl), or unsubstituted aryl (e.g., phenyl).

R²³ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R²⁴-substituted or unsubstituted alkyl (e.g. R²⁴-substituted or unsubstituted saturated alkyl), R²⁴-substituted or unsubstituted heteroalkyl, R²⁴-substituted or unsubstituted cycloalkyl, R²⁴-substituted or unsubstituted heterocycloalkyl, R²⁴-substituted or unsubstituted aryl, or R²⁴-substituted or unsubstituted heteroaryl. In some embodiments, R²³ is halogen, —CN, —CF₃, —OH, —NO₂, —C(O)NH₂, —SH, —NH₂, —SO₂, —COOH, R²⁴-substituted or unsubstituted C₁-C₁₀ alkyl (e.g., R²⁴-substituted or unsubstituted saturated C₁-C₁₀ alkyl), R²⁴-substituted or unsubstituted 2 to 10 membered heteroalkyl, R²⁴-substituted or unsubstituted C₃-C₈ cycloalkyl, R²⁴-substituted or unsubstituted 3 to 8 membered heterocycloalkyl, R²⁴-substituted or unsubstituted C₅-C₁₀ aryl, or R²⁴-substituted or unsubstituted 5 to 10 membered heteroaryl. In some embodiments, R²³ is R²⁴-substituted or unsubstituted C₁-C₁₀ alkyl (e.g., R²⁴-substituted or unsubstituted saturated C₁-C₁₀ alkyl), R²⁴-substituted or unsubstituted C₃-C₈ cycloalkyl, or R²⁴-substituted or unsubstituted aryl. In some embodiments, R²³ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R²³ is unsubstituted C₁-C₁₀ alkyl (e.g., unsubstituted C₁ to C₁₀ saturated alkyl). In some embodiments, R²³ is unsubstituted C₁-C₄ alkyl (e.g., unsubstituted C₁ to C₄ saturated alkyl). In some embodiments, R²³ is unsubstituted C₃-C₈ cycloalkyl. In some embodiments, R²³ is unsubstituted aryl (e.g., phenyl).

R²⁴ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R²⁵-substituted or unsubstituted alkyl (e.g., R²⁵-substituted or unsubstituted saturated alkyl), R²⁵-substituted or unsubstituted heteroalkyl, R²⁵-substituted or unsubstituted cycloalkyl, R²⁵-substituted or unsubstituted heterocycloalkyl, R²⁵-substituted or unsubstituted aryl, or R²⁵-substituted or unsubstituted heteroaryl. In some embodiments, R²⁴ is halogen, —CN, —CF₃, —OH, —NO₂, —C(O)NH₂, —SH, —NH₂, —SO₂, —COOH, R²⁵-substituted or unsubstituted C₁-C₁₀ alkyl (e.g., R²⁵-substituted or unsubstituted saturated C₁-C₁₀ alkyl), R²⁵-substituted or unsubstituted 2 to 10 membered heteroalkyl, R²⁵-substituted or unsubstituted C₃-C₈ cycloalkyl, R²⁵-substituted or unsubstituted 3 to 8 membered heterocycloalkyl, R²⁵-substituted or unsubstituted C₅-C₁₀ aryl, or R²⁵-substituted or unsubstituted 5 to 10 membered heteroaryl. In some embodiments, R²⁴ is R²⁵-substituted or unsubstituted C₁-C₁₀ alkyl (e.g., R²⁵-substituted or unsubstituted saturated C₁-C₁₀ alkyl), R²⁵-substituted or unsubstituted C₃-C₈ cycloalkyl or R²⁵-substituted or unsubstituted aryl. In some embodiments, R²⁴ is unsubstituted C₁-C₁₀ alkyl (e.g., unsubstituted C₁ to C₁₀ saturated alkyl). In some embodiments, R²⁴ is unsubstituted C₁-C₄ alkyl (e.g., unsubstituted C₁ to C₄ saturated alkyl). In some embodiments, R²⁴ is unsubstituted C₃-C₈ cycloalkyl. In some embodiments, R²⁴ is unsubstituted aryl (e.g., phenyl).

In some embodiments of the compounds provided herein, R³ is —OR^{8c}, —NR^{9c}R^{10c}, R²⁶-substituted or unsubstituted C₁-C₁₀ alkyl, R²⁶-substituted or unsubstituted 2 to 10 membered heteroalkyl, R²⁶-substituted or unsubstituted cycloalkyl, R²⁶-substituted or unsubstituted heterocycloalkyl, R²⁶-substituted or unsubstituted aryl, or R²⁶-substituted or unsubstituted heteroaryl. In some embodiments of the compounds provided herein, R³ is R²⁶-substituted or unsubstituted C₁-C₁₀ alkyl, R²⁶-substituted or unsubstituted 2 to 10 membered heteroalkyl, R²⁶-substituted or unsubstituted C₃-C₈ cycloalkyl, R²⁶-substituted or unsubstituted 3 to 8 membered heterocycloalkyl, R²⁶-substituted or unsubstituted C₅-C₁₀ aryl, or R²⁶-substituted or unsubstituted 5 to 10 membered heteroaryl. In some embodiments of the compounds provided herein, R³ is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R³ is R²⁶-substituted or unsubstituted C₁-C₁₀ saturated alkyl. In some embodiments of the compounds provided herein, R³ is R²⁶-substituted or unsubstituted C₁-C₆ alkyl. In some embodiments of the compounds provided herein, R³ is R²⁶-substituted or unsubstituted C₁-C₆ saturated alkyl. In some embodiments of the compounds provided herein, R³ is R²⁶-substituted or unsubstituted C₁-C₄ alkyl. In some embodiments of the compounds provided herein, R³ is R²⁶-substituted or unsubstituted C₁-C₄ saturated alkyl. In some embodiments of the compounds provided herein, R³ is unsubstituted C₁-C₄ saturated alkyl. In some embodiments, R³ is R²⁶-substituted or unsubstituted C₁-C₁₀ alkyl (e.g., R²⁶-substituted or unsubstituted C₁-C₁₀ saturated alkyl), R²⁶-substituted or unsubstituted C₃-C₈ cycloalkyl, or R²⁶-substituted or unsubstituted aryl. In some embodiments, R³ is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R³ is unsubstituted C₁-C₁₀ alkyl (e.g., unsubstituted C₁-C₁₀ saturated alkyl), or unsubstituted aryl (e.g., phenyl). In some embodiments, R³ is unsubstituted C₁-C₅ alkyl (e.g., unsubstituted C₁-C₅ saturated alkyl), or unsubstituted aryl (e.g., phenyl).

R²⁶ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R²⁷-substituted or unsubstituted alkyl (e.g. R²⁷-substituted or unsubstituted saturated alkyl), R²⁷-substituted or unsubstituted heteroalkyl, R²⁷-substituted or unsubstituted cycloalkyl, R²⁷ substituted or unsubstituted heterocycloalkyl, R²⁷-substituted or unsubstituted aryl, or R²⁷-substituted or unsubstituted heteroaryl. In some embodiments, R²⁶ is halogen, —CN, —CF₃, —OH, —NO₂, —C(O)NH₂, —SH, —NH₂, —SO₂, —COOH, R²⁷-substituted or unsubstituted C₁-C₁₀ alkyl (e.g., R²⁷-substituted or unsubstituted saturated C₁-C₁₀ alkyl), R²⁷-substituted or unsubstituted 2 to 10 membered heteroalkyl, R²⁷-substituted or unsubstituted C₃-C₈ cycloalkyl, R²⁷-substituted or unsubstituted 3 to 8 membered heterocycloalkyl, R²⁷-substituted or unsubstituted C₅-C₁₀ aryl, or R²⁷-substituted or unsubstituted 5 to 10 membered heteroaryl. In some embodiments, R²⁶ is R²⁷-substituted or unsubstituted C₁-C₁₀ alkyl (e.g., R²⁷-substituted or unsubstituted saturated C₁-C₁₀ alkyl), R²⁷-substituted or unsubstituted C₃-C₈ cycloalkyl, or R²⁷-substituted or unsubstituted aryl. In some embodiments, R²⁶ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R²⁶ is unsubstituted C₁-C₁₀ alkyl (e.g., unsubstituted C₁ to C₁₀ saturated alkyl). In some embodiments, R²⁶ is unsubstituted C₁-C₄ alkyl (e.g., unsubstituted C₁ to C₄ saturated alkyl). In some embodiments, R²⁶ is unsubstituted C₃-C₈ cycloalkyl. In some embodiments, R²⁶ is unsubstituted aryl (e.g., phenyl).

R²⁷ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R²⁸-substituted or unsubstituted alkyl (e.g., R²⁸-substituted or unsubstituted saturated alkyl), R²⁸-substituted or unsubstituted heteroalkyl, R²⁸-substituted or unsubstituted cycloalkyl, R²⁸-substituted or unsubstituted heterocycloalkyl, R²⁸-substituted or unsubstituted aryl, or R²⁸-substituted or unsubstituted heteroaryl. In some embodiments, R²⁷ is halogen, —CN, —CF₃, —OH, —NO₂, —C(O)NH₂, —SH, —NH₂, —SO₂, —COOH, R²⁸-substituted or unsubstituted C₁-C₁₀ alkyl (e.g., R²⁸-substituted or unsubstituted saturated C₁-C₁₀ alkyl), R²⁸-substituted or unsubstituted 2 to 10 membered heteroalkyl, R²⁸-substituted or unsubstituted C₃-C₈ cycloalkyl, R²⁸-substituted or unsubstituted 3 to 8 membered heterocycloalkyl, R²⁸-substituted or unsubstituted C₅-C₁₀ aryl, or R²⁸-substituted or unsubstituted 5 to 10 membered heteroaryl. In some embodiments, R²⁷ is R²⁸-substituted or unsubstituted C₁-C₁₀ alkyl (e.g., R²⁸-substituted or unsubstituted saturated C₁-C₁₀ alkyl), R²⁸-substituted or unsubstituted C₃-C₈ cycloalkyl or R²⁸-substituted or unsubstituted aryl. In some embodiments, R²⁷ is unsubstituted C₁-C₁₀ alkyl (e.g., unsubstituted C₁ to C₁₀ saturated alkyl). In some embodiments, R²⁷ is unsubstituted C₁-C₄ alkyl (e.g., unsubstituted C₁ to C₄ saturated alkyl). In some embodiments, R²⁷ is unsubstituted C₃-C₈ cycloalkyl. In some embodiments, R²⁷ is unsubstituted aryl (e.g., phenyl).

In some embodiments of the compounds provided herein, R⁴ is —OR^{8d}, —NR^{9d}R^{10d}, R²⁹-substituted substituted or unsubstituted C₁-C₁₀ alkyl, R²⁹-substituted or unsubstituted 2 to 10 membered heteroalkyl, R²⁹-substituted or unsubstituted cycloalkyl, R²⁹-substituted or unsubstituted heterocycloalkyl, R²⁹-substituted or unsubstituted aryl, or R²⁹-substituted or unsubstituted heteroaryl. In some embodiments of the compounds provided herein, R⁴ is R²⁹-substituted or unsubstituted C₁-C₁₀ alkyl, R²⁹-substituted or unsubstituted 2 to 10 membered heteroalkyl, R²⁹-substituted or unsubstituted C₃-C₈ cycloalkyl, R²⁹-substituted or unsubstituted 3 to 8 membered heterocycloalkyl, R²⁹-substituted or unsubstituted C₅-C₁₀ aryl, or R²⁹-substituted or unsubstituted 5 to 10 membered heteroaryl. In some embodiments of the compounds provided herein, R⁴ is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R⁴ is R²⁹-substituted or unsubstituted C₁-C₁₀ saturated alkyl. In some embodiments of the compounds provided herein, R⁴ is R²⁹-substituted or unsubstituted C₁-C₆ alkyl. In some embodiments of the compounds provided herein, R⁴ is R²⁹-substituted or unsubstituted C₁-C₆ saturated alkyl. In some embodiments of the compounds provided herein, R⁴ is R²⁹-substituted or unsubstituted C₁-C₄ alkyl. In some embodiments of the compounds provided herein, R⁴ is R²⁹-substituted or unsubstituted C₁-C₄ saturated alkyl. In some embodiments of the compounds provided herein, R⁴ is unsubstituted C₁-C₄ saturated alkyl. In some embodiments, R⁴ is R²⁹-substituted or unsubstituted C₁-C₁₀ alkyl (e.g., R²⁹-substituted or unsubstituted C₁-C₁₀ saturated alkyl), R²⁹-substituted or unsubstituted C₃-C₈ cycloalkyl, or R²⁹-substituted or unsubstituted aryl. In some embodiments, R⁴ is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R⁴ is unsubstituted C₁-C₁₀ alkyl (e.g., unsubstituted C₁-C₁₀ saturated alkyl), or unsubstituted aryl (e.g., phenyl). In some embodiments, R⁴ is unsubstituted C₁-C₅ alkyl (e.g., unsubstituted C₁-C₅ saturated alkyl), or unsubstituted aryl (e.g., phenyl).

R²⁹ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R³⁰-substituted or unsubstituted alkyl (e.g. R³⁰-substituted or unsubstituted saturated alkyl), R³⁰-substituted or unsubstituted heteroalkyl, R³⁰-substituted or unsubstituted cycloalkyl, R³⁰ substituted or unsubstituted heterocycloalkyl, R³⁰-substituted or unsubstituted aryl, or R³⁰-substituted or unsubstituted heteroaryl. In some embodiments, R²⁹ is halogen, —CN, —CF₃, —OH, —NO₂, —C(O)NH₂, —SH, —NH₂, —SO₂, —COOH, R³⁰-substituted or unsubstituted C₁-C₁₀ alkyl (e.g., R³⁰-substituted or unsubstituted saturated C₁-C₁₀ alkyl), R³⁰-substituted or unsubstituted 2 to 10 membered heteroalkyl, R³⁰-substituted or unsubstituted C₃-C₈ cycloalkyl, R³⁰-substituted or unsubstituted 3 to 8 membered heterocycloalkyl, R³⁰-substituted or unsubstituted C₅-C₁₀ aryl, or R³⁰-substituted or unsubstituted 5 to 10 membered heteroaryl. In some embodiments, R²⁹ is R³⁰-substituted or unsubstituted C₁-C₁₀ alkyl (e.g., R³⁰-substituted or unsubstituted saturated C₁-C₁₀ alkyl), R³⁰-substituted or unsubstituted C₃-C₈ cycloalkyl, or R³⁰-substituted or unsubstituted aryl. In some embodiments, R²⁹ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R²⁹ is unsubstituted C₁-C₁₀ alkyl (e.g., unsubstituted C₁ to C₁₀ saturated alkyl). In some embodiments, R²⁹ is unsubstituted C₁-C₄ alkyl (e.g., unsubstituted C₁ to C₄ saturated alkyl). In some embodiments, R²⁹ is unsubstituted C₃-C₈ cycloalkyl. In some embodiments, R²⁹ is unsubstituted aryl (e.g., phenyl).

R³⁰ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R³¹-substituted or unsubstituted alkyl (e.g., R³¹-substituted or unsubstituted saturated alkyl), R³¹-substituted or unsubstituted heteroalkyl, R³¹-substituted or unsubstituted cycloalkyl, R³¹-substituted or unsubstituted heterocycloalkyl, R³¹-substituted or unsubstituted aryl, or R³¹-substituted or unsubstituted heteroaryl. In some embodiments, R³⁰ is halogen, —CN, —CF₃, —OH, —NO₂, —C(O)NH₂, —SH, —NH₂, —SO₂, —COOH, R³¹-substituted or unsubstituted C₁-C₁₀ alkyl (e.g., R³¹-substituted or unsubstituted saturated C₁-C₁₀ alkyl), R³¹-substituted or unsubstituted 2 to 10 membered heteroalkyl, R³¹-substituted or unsubstituted C₃-C₈ cycloalkyl, R³¹-substituted or unsubstituted 3 to 8 membered heterocycloalkyl, R³¹-substituted or unsubstituted C₅-C₁₀ aryl, or R³¹-substituted or unsubstituted 5 to 10 membered heteroaryl. In some embodiments, R³⁰ is R³¹-substituted or unsubstituted C₁-C₁₀ alkyl (e.g., R³¹-substituted or unsubstituted saturated C₁-C₁₀ alkyl), R³¹-substituted or unsubstituted C₃-C₈ cycloalkyl or R³¹-substituted or unsubstituted aryl. In some embodiments, R³⁰ is unsubstituted C₁-C₁₀ alkyl (e.g., unsubstituted C₁ to C₁₀ saturated alkyl). In some embodiments, R³⁰ is unsubstituted C₁-C₄ alkyl (e.g., unsubstituted C₁ to C₄ saturated alkyl). In some embodiments, R³⁰ is unsubstituted C₃-C₈ cycloalkyl. In some embodiments, R³⁰ is unsubstituted aryl (e.g., phenyl).

In some embodiments of the compounds provided herein, R⁵ is hydrogen, R³²-substituted or unsubstituted C₁-C₁₀ alkyl, R³²-substituted or unsubstituted 2 to 10 membered heteroalkyl, R³²-substituted or unsubstituted cycloalkyl, R³²-substituted or unsubstituted heterocycloalkyl, R³²-substituted or unsubstituted aryl, or R³²-substituted or unsubstituted heteroaryl. In some embodiments of the compounds provided herein, R⁵ is R³²-substituted or unsubstituted C₁-C₁₀ alkyl, R³²-substituted or unsubstituted 2 to 10 membered heteroalkyl, R³²-substituted or unsubstituted C₃-C₈ cycloalkyl, R³²-substituted or unsubstituted 3 to 8 membered heterocycloalkyl, R³²-substituted or unsubstituted C₅-C₁₀ aryl, or R³²-substituted or unsubstituted 5 to 10 membered heteroaryl. In some embodiments of the compounds provided herein, R⁵ is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R⁵ is R³²-substituted or unsubstituted C₁-C₁₀ saturated alkyl. In some embodiments of the compounds provided herein, R⁵ is R³²-substituted or unsubstituted C₁-C₆ alkyl. In some embodiments of the compounds provided herein, R⁵ is R³²-substituted or unsubstituted C₁-C₆ saturated alkyl. In some embodiments of the compounds provided herein, R⁵ is R³²-substituted or unsubstituted C₁-C₄ alkyl. In some embodiments of the compounds provided herein, R⁵ is R³²-substituted or unsubstituted C₁-C₄ saturated alkyl. In some embodiments of the compounds provided herein, R⁵ is unsubstituted C₁-C₄ saturated alkyl. In some embodiments R⁵ is hydrogen. In other embodiments, R⁵ is substituted or unsubstituted C₁-C₁₀ alkyl (e.g., substituted or unsubstituted C₁-C₁₀ saturated alkyl), or substituted or unsubstituted C₃-C₈ cycloalkyl. In some embodiments, R⁵ is substituted or unsubstituted C₁-C₆ alkyl (e.g., substituted or unsubstituted C₁-C₆ saturated alkyl). In some embodiments, R⁵ is substituted or unsubstituted C₁-C₃ alkyl (e.g., substituted or unsubstituted C₁-C₃ saturated alkyl). In some embodiments, R⁵ is substituted or unsubstituted C₁-C₂ alkyl (e.g., substituted or unsubstituted C₁-C₂ saturated alkyl). In some embodiments, R⁵ is substituted or unsubstituted ethyl. In some embodiments, R⁵ is unsubstituted ethyl. In some embodiments, R⁵ is substituted or unsubstituted C₃-C₈ cycloalkyl. In some embodiments, R⁵ is unsubstituted C₁-C₁₀ alkyl (e.g., unsubstituted C₁-C₁₀ saturated alkyl), or unsubstituted C₃-C₈ cycloalkyl. In other embodiments, R⁵ is unsubstituted C₁-C₁₀ alkyl (e.g., unsubstituted C₁-C₁₀ saturated alkyl). In other embodiments, R⁵ is unsubstituted C₁-C₅ alkyl (e.g., unsubstituted C₁-C₅ saturated alkyl). In some embodiments, R⁵ is R³²-substituted or unsubstituted C₁-C₁₀ alkyl (e.g., R³²-substituted or unsubstituted C₁-C₁₀ saturated alkyl), or R³²-substituted or unsubstituted C₃-C₈ cycloalkyl.

R³² is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R³³-substituted or unsubstituted alkyl (e.g., R³³-substituted or unsubstituted C₁-C₁₀ saturated alkyl), R³³-substituted or unsubstituted heteroalkyl, R³³-substituted or unsubstituted cycloalkyl, R³³ substituted or unsubstituted heterocycloalkyl, R³³-substituted or unsubstituted aryl, or R³³-substituted or unsubstituted heteroaryl. In some embodiments, R³² is halogen, —CN, —CF₃, —OH, —NO₂, —C(O)NH₂, —SH, —NH₂, —SO₂, —COOH, R³³-substituted or unsubstituted C₁-C₁₀ alkyl (e.g., R³³-substituted or unsubstituted C₁-C₁₀ saturated alkyl), R³³-substituted or unsubstituted 2 to 10 membered heteroalkyl, R³³-substituted or unsubstituted C₃-C₈ cycloalkyl, R³³-substituted or unsubstituted 3 to 8 membered heterocycloalkyl, R³³-substituted or unsubstituted C₅-C₁₀ aryl, or R³³-substituted or unsubstituted 5 to 10 membered heteroaryl. In some embodiments, R³² is R³³-substituted or unsubstituted C₁-C₁₀ alkyl (e.g., R³³-substituted or unsubstituted C₁-C₁₀ saturated alkyl), R³³-substituted or unsubstituted C₃-C₈ cycloalkyl, or R³³-substituted or unsubstituted aryl. In some embodiments, R³² is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R³² is unsubstituted C₁-C₁₀ alkyl (e.g., unsubstituted C₁ to C₁₀ saturated alkyl). In some embodiments, R³² is unsubstituted C₁-C₄ alkyl (e.g., unsubstituted C₁ to C₄ saturated alkyl). In some embodiments, R³² is unsubstituted C₃-C₈ cycloalkyl. In some embodiments, R³² is unsubstituted aryl (e.g., phenyl). In some embodiments, R³² is unsubstituted C₁-C₁₀ alkyl (e.g., unsubstituted C₁ to C₁₀ saturated alkyl). In some embodiments, R³² is unsubstituted C₁-C₄ alkyl (e.g., unsubstituted C₁ to C₄ saturated alkyl). In some embodiments, R³² is unsubstituted C₃-C₈ cycloalkyl. In some embodiments, R³² is unsubstituted aryl (e.g., phenyl).

R³³ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R³⁴-substituted or unsubstituted alkyl (e.g., R³⁴-substituted or unsubstituted C₁-C₁₀ saturated alkyl), R³⁴-substituted or unsubstituted heteroalkyl, R³⁴-substituted or unsubstituted cycloalkyl, R³⁴-substituted or unsubstituted heterocycloalkyl, R³⁴-substituted or unsubstituted aryl, or R³⁴-substituted or unsubstituted heteroaryl. In some embodiments, R³³ is halogen, —CN, —CF₃, —OH, —NO₂, —C(O)NH₂, —SH, —NH₂, —SO₂, —COOH, R³⁴-substituted or unsubstituted C₁-C₁₀ alkyl (e.g., R³⁴-substituted or unsubstituted C₁-C₁₀ saturated alkyl), R³⁴-substituted or unsubstituted 2 to 10 membered heteroalkyl, R³⁴-substituted or unsubstituted C₃-C₈ cycloalkyl, R³⁴-substituted or unsubstituted 3 to 8 membered heterocycloalkyl, R³⁴-substituted or unsubstituted C₅-C₁₀ aryl, or R³⁴-substituted or unsubstituted 5 to 10 membered heteroaryl. In some embodiments, R³³ is R³⁴-substituted or unsubstituted C₁-C₁₀ alkyl (e.g., R³⁴-substituted or unsubstituted C₁-C₁₀ saturated alkyl), R³⁴-substituted or unsubstituted C₃-C₈ cycloalkyl or R³⁴-substituted or unsubstituted aryl. In some embodiments, R³³ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R³³ is unsubstituted C₁-C₁₀ alkyl (e.g., unsubstituted C₁ to C₁₀ saturated alkyl). In some embodiments, R³³ is unsubstituted C₁-C₄ alkyl (e.g., unsubstituted C₁ to C₄ saturated alkyl). In some embodiments, R³³ is unsubstituted C₃-C₈ cycloalkyl. In some embodiments, R³³ is unsubstituted aryl (e.g., phenyl). In some embodiments, R³³ is unsubstituted C₁-C₁₀ alkyl (e.g., unsubstituted C₁ to C₁₀ saturated alkyl). In some embodiments, R³³ is unsubstituted C₁-C₄ alkyl (e.g., unsubstituted C₁ to C₄ saturated alkyl). In some embodiments, R³³ is unsubstituted C₃-C₈ cycloalkyl. In some embodiments, R³³ is unsubstituted aryl (e.g., phenyl).

In some embodiments of the compounds provided herein, R⁶ is hydrogen, R³⁵-substituted or unsubstituted C₁-C₁₀ alkyl, R³⁵-substituted or unsubstituted 2 to 10 membered heteroalkyl, R³⁵-substituted or unsubstituted cycloalkyl, R³⁵-substituted or unsubstituted heterocycloalkyl, R³⁵-substituted or unsubstituted aryl, or R³⁵-substituted or unsubstituted heteroaryl. In some embodiments of the compounds provided herein, R⁶ is R³⁵-substituted or unsubstituted C₁-C₁₀ alkyl, R³⁵-substituted or unsubstituted 2 to 10 membered heteroalkyl, R³⁵-substituted or unsubstituted C₃-C₈ cycloalkyl, R³⁵-substituted or unsubstituted 3 to 8 membered heterocycloalkyl, R³⁵-substituted or unsubstituted C₅-C₁₀ aryl, or R³⁵-substituted or unsubstituted 5 to 10 membered heteroaryl. In some embodiments of the compounds provided herein, R⁶ is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R⁶ is R³⁵-substituted or unsubstituted C₁-C₁₀ saturated alkyl. In some embodiments of the compounds provided herein, R⁶ is R³⁵-substituted or unsubstituted C₁-C₆ alkyl. In some embodiments of the compounds provided herein, R⁶ is R³⁵-substituted or unsubstituted C₁-C₆ saturated alkyl. In some embodiments of the compounds provided herein, R⁶ is R³⁵-substituted or unsubstituted C₁-C₄ alkyl. In some embodiments of the compounds provided herein, R⁶ is R³⁵-substituted or unsubstituted C₁-C₄ saturated alkyl. In some embodiments of the compounds provided herein, R⁶ is unsubstituted C₁-C₄ saturated alkyl. In some embodiments R⁶ is hydrogen. In other embodiments, R⁶ is substituted or unsubstituted C₁-C₁₀ alkyl (e.g., substituted or unsubstituted C₁-C₁₀ saturated alkyl), or substituted or unsubstituted C₃-C₈ cycloalkyl. In some embodiments, R⁶ is substituted or unsubstituted C₁-C₆ alkyl (e.g., substituted or unsubstituted C₁-C₆ saturated alkyl). In some embodiments, R⁶ is substituted or unsubstituted C₁-C₃ alkyl (e.g., substituted or unsubstituted C₁-C₃ saturated alkyl). In some embodiments, R⁶ is substituted or unsubstituted C₁-C₂ alkyl (e.g., substituted or unsubstituted C₁-C₂ saturated alkyl). In some embodiments, R⁶ is substituted or unsubstituted ethyl. In some embodiments, R⁶ is unsubstituted ethyl. In some embodiments, R⁶ is substituted or unsubstituted C₃-C₈ cycloalkyl. In some embodiments, R⁶ is unsubstituted C₁-C₁₀ alkyl (e.g., unsubstituted C₁-C₁₀ saturated alkyl), or unsubstituted C₃-C₈ cycloalkyl. In other embodiments, R⁶ is unsubstituted C₁-C₁₀ alkyl (e.g., unsubstituted C₁-C₁₀ saturated alkyl). In other embodiments, R⁶ is unsubstituted C₁-C₅ alkyl (e.g., unsubstituted C₁-C₅ saturated alkyl). In some embodiments, R⁶ is R³⁵-substituted or unsubstituted C₁-C₁₀ alkyl (e.g., R³⁵-substituted or unsubstituted C₁-C₁₀ saturated alkyl), or R³⁵-substituted or unsubstituted C₃-C₈ cycloalkyl. In some embodiments, R⁶ is R³⁵-substituted or unsubstituted C₁-C₁₀ alkyl (e.g., R³⁵-substituted or unsubstituted C₁-C₁₀ saturated alkyl), R³⁵-substituted or unsubstituted C₃-C₈ cycloalkyl or R³⁵-substituted or unsubstituted aryl. In some embodiments, R⁶ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R⁶ is unsubstituted C₁-C₁₀ alkyl (e.g., unsubstituted C₁ to C₁₀ saturated alkyl). In some embodiments, R⁶ is unsubstituted C₁-C₄ alkyl (e.g., unsubstituted C₁ to C₄ saturated alkyl). In some embodiments, R⁶ is unsubstituted C₃-C₈ cycloalkyl. In some embodiments, R⁶ is unsubstituted aryl (e.g., phenyl). In some embodiments, R⁶ is unsubstituted C₁-C₁₀ alkyl (e.g., unsubstituted C₁ to C₁₀ saturated alkyl). In some embodiments, R⁶ is unsubstituted C₁-C₄ alkyl (e.g., unsubstituted C₁ to C₄ saturated alkyl). In some embodiments, R⁶ is unsubstituted C₃-C₈ cycloalkyl. In some embodiments, R⁶ is unsubstituted aryl (e.g., phenyl).

R³⁵ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R³⁶-substituted or unsubstituted alkyl (e.g., R³⁶-substituted or unsubstituted C₁-C₁₀ saturated alkyl), R³⁶-substituted or unsubstituted heteroalkyl, R³⁶-substituted or unsubstituted cycloalkyl, R³⁶ substituted or unsubstituted heterocycloalkyl, R³⁶-substituted or unsubstituted aryl, or R³⁶-substituted or unsubstituted heteroaryl. In some embodiments, R³⁵ is halogen, —CN, —CF₃, —OH, —NO₂, —C(O)NH₂, —SH, —NH₂, —SO₂, —COOH, R³⁶-substituted or unsubstituted C₁-C₁₀ alkyl (e.g., R³⁶-substituted or unsubstituted C₁-C₁₀ saturated alkyl), R³⁶-substituted or unsubstituted 2 to 10 membered heteroalkyl, R³⁶-substituted or unsubstituted C₃-C₈ cycloalkyl, R³⁶-substituted or unsubstituted 3 to 8 membered heterocycloalkyl, R³⁶-substituted or unsubstituted C₅-C₁₀ aryl, or R³⁶-substituted or unsubstituted 5 to 10 membered heteroaryl. In some embodiments, R³⁵ is R³⁶-substituted or unsubstituted C₁-C₁₀ alkyl (e.g., R³⁶-substituted or unsubstituted C₁-C₁₀ saturated alkyl), R³⁶-substituted or unsubstituted C₃-C₈ cycloalkyl, or R³⁶-substituted or unsubstituted aryl. In some embodiments, R³⁵ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R³⁵ is unsubstituted C₁-C₁₀ alkyl (e.g., unsubstituted C₁ to C₁₀ saturated alkyl). In some embodiments, R³⁵ is unsubstituted C₁-C₄ alkyl (e.g., unsubstituted C₁ to C₄ saturated alkyl). In some embodiments, R³⁵ is unsubstituted C₃-C₈ cycloalkyl. In some embodiments, R³⁵ is unsubstituted aryl (e.g., phenyl).

R³⁶ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R³⁷-substituted or unsubstituted alkyl (e.g., R³⁷-substituted or unsubstituted C₁-C₁₀ saturated alkyl), R³⁷-substituted or unsubstituted heteroalkyl, R³⁷-substituted or unsubstituted cycloalkyl, R³⁷-substituted or unsubstituted heterocycloalkyl, R³⁷-substituted or unsubstituted aryl, or R³⁷-substituted or unsubstituted heteroaryl. In some embodiments, R³⁶ is halogen, —CN, —CF₃, —OH, —NO₂, —C(O)NH₂, —SH, —NH₂, —SO₂, —COOH, R³⁷-substituted or unsubstituted C₁-C₁₀ alkyl (e.g., R³⁷-substituted or unsubstituted C₁-C₁₀ saturated alkyl), R³⁷-substituted or unsubstituted 2 to 10 membered heteroalkyl, R³⁷-substituted or unsubstituted C₃-C₈ cycloalkyl, R³⁷-substituted or unsubstituted 3 to 8 membered heterocycloalkyl, R³⁷-substituted or unsubstituted C₅-C₁₀ aryl, or R³⁷-substituted or unsubstituted 5 to 10 membered heteroaryl. In some embodiments, R³⁶ is R³⁷-substituted or unsubstituted C₁-C₁₀ alkyl (e.g., R³⁷-substituted or unsubstituted C₁-C₁₀ saturated alkyl), R³⁷-substituted or unsubstituted C₃-C₈ cycloalkyl or R³⁷-substituted or unsubstituted aryl. In some embodiments, R³⁶ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R³⁶ is unsubstituted C₁-C₁₀ alkyl (e.g., unsubstituted C₁ to C₁₀ saturated alkyl). In some embodiments, R³⁶ is unsubstituted C₁-C₄ alkyl (e.g., unsubstituted C₁ to C₄ saturated alkyl). In some embodiments, R³⁶ is unsubstituted C₃-C₈ cycloalkyl. In some embodiments, R³⁶ is unsubstituted aryl (e.g., phenyl). In some embodiments, R³⁶ is unsubstituted C₁-C₁₀ alkyl (e.g., unsubstituted C₁ to C₁₀ saturated alkyl). In some embodiments, R³⁶ is unsubstituted C₁-C₄ alkyl (e.g., unsubstituted C₁ to C₄ saturated alkyl). In some embodiments, R³⁶ is unsubstituted C₃-C₈ cycloalkyl. In some embodiments, R³⁶ is unsubstituted aryl (e.g., phenyl).

In some embodiments of the compounds provided herein, R⁷ is hydrogen, R³⁸-substituted or unsubstituted C₁-C₁₀ alkyl, R³⁸-substituted or unsubstituted 2 to 10 membered heteroalkyl, R³⁸-substituted or unsubstituted cycloalkyl, R³⁸-substituted or unsubstituted heterocycloalkyl, R³⁸-substituted or unsubstituted aryl, or R³⁸-substituted or unsubstituted heteroaryl. In some embodiments of the compounds provided herein, R⁷ is R³⁸-substituted or unsubstituted C₁-C₁₀ alkyl, R³⁸-substituted or unsubstituted 2 to 10 membered heteroalkyl, R³⁸-substituted or unsubstituted C₃-C₈ cycloalkyl, R³⁸-substituted or unsubstituted 3 to 8 membered heterocycloalkyl, R³⁸-substituted or unsubstituted C₅-C₁₀ aryl, or R³⁸-substituted or unsubstituted 5 to 10 membered heteroaryl. In some embodiments of the compounds provided herein, R⁷ is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R⁷ is R³⁸-substituted or unsubstituted C₁-C₁₀ saturated alkyl. In some embodiments of the compounds provided herein, R⁷ is R³⁸-substituted or unsubstituted C₁-C₆ alkyl. In some embodiments of the compounds provided herein, R⁷ is R³⁸-substituted or unsubstituted C₁-C₆ saturated alkyl. In some embodiments of the compounds provided herein, R⁷ is R³⁸-substituted or unsubstituted C₁-C₄ alkyl. In some embodiments of the compounds provided herein, R⁷ is R³⁸-substituted or unsubstituted C₁-C₄ saturated alkyl. In some embodiments of the compounds provided herein, R⁷ is unsubstituted C₁-C₄ saturated alkyl. In some embodiments R⁷ is hydrogen. In other embodiments, R⁷ is substituted or unsubstituted C₁-C₁₀ alkyl (e.g., substituted or unsubstituted C₁-C₁₀ saturated alkyl), or substituted or unsubstituted C₃-C₈ cycloalkyl. In some embodiments, R⁷ is substituted or unsubstituted C₁-C₆ alkyl (e.g., substituted or unsubstituted C₁-C₆ saturated alkyl). In some embodiments, R⁷ is substituted or unsubstituted C₁-C₃ alkyl (e.g., substituted or unsubstituted C₁-C₃ saturated alkyl). In some embodiments, R⁷ is substituted or unsubstituted C₁-C₂ alkyl (e.g., substituted or unsubstituted C₁-C₂ saturated alkyl). In some embodiments, R⁷ is substituted or unsubstituted ethyl. In some embodiments, R⁷ is unsubstituted ethyl. In some embodiments, R⁷ is substituted or unsubstituted propyl. In some embodiments, R⁷ is unsubstituted propyl. In some embodiments, R⁷ is substituted or unsubstituted C₃-C₈ cycloalkyl. In some embodiments, R⁷ is unsubstituted C₁-C₁₀ alkyl (e.g., unsubstituted C₁-C₁₀ saturated alkyl), or unsubstituted C₃-C₈ cycloalkyl. In other embodiments, R⁷ is unsubstituted C₁-C₁₀ alkyl (e.g., unsubstituted C₁-C₁₀ saturated alkyl). In other embodiments, R⁷ is unsubstituted C₁-C₅ alkyl (e.g., unsubstituted C₁-C₅ saturated alkyl). In some embodiments, R⁷ is R³⁸-substituted or unsubstituted C₁-C₁₀ alkyl (e.g., R³⁸-substituted or unsubstituted C₁-C₁₀ saturated alkyl), or R³⁸-substituted or unsubstituted C₃-C₈ cycloalkyl. In some embodiments, R⁷ is R³⁸-substituted or unsubstituted phenyl. In some embodiments, R⁷ is R³⁸-substituted phenyl. In some embodiments, R⁷ is unsubstituted phenyl. In some embodiments, R⁷ is R³⁸-substituted or unsubstituted 5 to 9 membered heteroaryl. In some embodiments, R⁷ is unsubstituted 5 to 9 membered heteroaryl. In some embodiments, R⁷ is R³⁸-substituted 5 to 9 membered heteroaryl. In some embodiments, R⁷ is R³⁸-substituted or unsubstituted 5 to 6 membered heteroaryl. In some embodiments, R⁷ is unsubstituted 5 to 6 membered heteroaryl. In some embodiments, R⁷ is R³⁸-substituted 5 to 6 membered heteroaryl.

R³⁸ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R³⁹-substituted or unsubstituted alkyl (e.g., R³⁹-substituted or unsubstituted C₁-C₁₀ saturated alkyl), R³⁹-substituted or unsubstituted heteroalkyl, R³⁹-substituted or unsubstituted cycloalkyl, R³⁹ substituted or unsubstituted heterocycloalkyl, R³⁹-substituted or unsubstituted aryl, or R³⁹-substituted or unsubstituted heteroaryl. In some embodiments, R³⁸ is halogen, —CN, —CF₃, —OH, —NO₂, —C(O)NH₂, —SH, —NH₂, —SO₂, —COOH, R³⁹-substituted or unsubstituted C₁-C₁₀ alkyl (e.g., R³⁹-substituted or unsubstituted C₁-C₁₀ saturated alkyl), R³⁹-substituted or unsubstituted 2 to 10 membered heteroalkyl, R³⁹-substituted or unsubstituted C₃-C₈ cycloalkyl, R³⁹-substituted or unsubstituted 3 to 8 membered heterocycloalkyl, R³⁹-substituted or unsubstituted C₅-C₁₀ aryl, or R³⁹-substituted or unsubstituted 5 to 10 membered heteroaryl. In some embodiments, R³⁸ is R³⁹-substituted or unsubstituted C₁-C₁₀ alkyl (e.g., R³⁹-substituted or unsubstituted C₁-C₁₀ saturated alkyl), R³⁹-substituted or unsubstituted C₃-C₈ cycloalkyl, or R³⁹-substituted or unsubstituted aryl. In some embodiments, R³⁸ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R³⁸ is unsubstituted C₁-C₁₀ alkyl (e.g., unsubstituted C₁ to C₁₀ saturated alkyl). In some embodiments, R³⁸ is unsubstituted C₁-C₄ alkyl (e.g., unsubstituted C₁ to C₄ saturated alkyl). In some embodiments, R³⁸ is unsubstituted C₃-C₈ cycloalkyl. In some embodiments, R³⁸ is unsubstituted aryl (e.g., phenyl).

R³⁹ is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R⁴⁰-substituted or unsubstituted alkyl (e.g., R⁴⁰-substituted or unsubstituted C₁-C₁₀ saturated alkyl), R⁴⁰-substituted or unsubstituted heteroalkyl, R⁴⁰-substituted or unsubstituted cycloalkyl, R⁴⁰-substituted or unsubstituted heterocycloalkyl, R⁴⁰-substituted or unsubstituted aryl, or R⁴⁰-substituted or unsubstituted heteroaryl. In some embodiments, R³⁹ is halogen, —CN, —CF₃, —OH, —NO₂, —C(O)NH₂, —SH, —NH₂, —SO₂, —COOH, R⁴⁰-substituted or unsubstituted C₁-C₁₀ alkyl (e.g., R⁴⁰-substituted or unsubstituted C₁-C₁₀ saturated alkyl), R⁴⁰-substituted or unsubstituted 2 to 10 membered heteroalkyl, R⁴⁰-substituted or unsubstituted C₃-C₈ cycloalkyl, R⁴⁰-substituted or unsubstituted 3 to 8 membered heterocycloalkyl, R⁴⁰-substituted or unsubstituted C₅-C₁₀ aryl, or R⁴⁰-substituted or unsubstituted 5 to 10 membered heteroaryl. In some embodiments, R³⁹ is R⁴⁰-substituted or unsubstituted C₁-C₁₀ alkyl (e.g., R⁴⁰-substituted or unsubstituted C₁-C₁₀ saturated alkyl), R⁴⁰-substituted or unsubstituted C₃-C₈ cycloalkyl or R⁴⁰-substituted or unsubstituted aryl. In some embodiments, R³⁹ is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R³⁹ is unsubstituted C₁-C₁₀ alkyl (e.g., unsubstituted C₁ to C₁₀ saturated alkyl). In some embodiments, R³⁹ is unsubstituted C₁-C₄ alkyl (e.g., unsubstituted C₁ to C₄ saturated alkyl). In some embodiments, R³⁹ is unsubstituted C₃-C₈ cycloalkyl. In some embodiments, R³⁹ is unsubstituted aryl (e.g., phenyl). In some embodiments, R³⁹ is unsubstituted C₁-C₁₀ alkyl (e.g., unsubstituted C₁ to C₁₀ saturated alkyl). In some embodiments, R³⁹ is unsubstituted C₁-C₄ alkyl (e.g., unsubstituted C₁ to C₄ saturated alkyl). In some embodiments, R³⁹ is unsubstituted C₃-C₈ cycloalkyl. In some embodiments, R³⁹ is unsubstituted aryl (e.g., phenyl).

In some embodiments of the compounds provided herein, R^{8a} is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{41a}-substituted or unsubstituted C₁-C₁₀ alkyl, R^{41a}-substituted or unsubstituted 2 to 10 membered heteroalkyl, R^{41a}-substituted or unsubstituted cycloalkyl, R^{41a}-substituted or unsubstituted heterocycloalkyl, R^{41a}-substituted or unsubstituted aryl, or R^{41a}-substituted or unsubstituted heteroaryl. In some embodiments of the compounds provided herein, R^{8a} is R^{41a}-substituted or unsubstituted C₁-C₁₀ alkyl, R^{41a}-substituted or unsubstituted 2 to 10 membered heteroalkyl, R^{41a}-substituted or unsubstituted C₃-C₈ cycloalkyl, R^{41a}-substituted or unsubstituted 3 to 8 membered heterocycloalkyl, R^{41a}-substituted or unsubstituted C₅-C₁₀ aryl, or R^{41a}-substituted or unsubstituted 5 to 10 membered heteroaryl. In some embodiments of the compounds provided herein, R^{8a} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{8a} is R^{41a}-substituted or unsubstituted C₁-C₁₀ saturated alkyl. In some embodiments of the compounds provided herein, R^{8a} is R^{41a}-substituted or unsubstituted C₁-C₆ alkyl. In some embodiments of the compounds provided herein, R^{8a} is R^{41a}-substituted or unsubstituted C₁-C₆ saturated alkyl. In some embodiments of the compounds provided herein, R^{8a} is R^{41a}-substituted or unsubstituted C₁-C₄ alkyl. In some embodiments of the compounds provided herein, R^{8a} is R^{41a}-substituted or unsubstituted C₁-C₄ saturated alkyl. In some embodiments of the compounds provided herein, R^{8a} is unsubstituted C₁-C₄ saturated alkyl. In some embodiments, R^{8a} is R^{41a}-substituted or unsubstituted C₁-C₁₀ alkyl (e.g., R^{41a}-substituted or unsubstituted C₁-C₁₀ saturated alkyl), R^{41a}-substituted or unsubstituted C₃-C₈ cycloalkyl, or R^{41a}-substituted or unsubstituted aryl. In some embodiments, R^{8a} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{8a} is unsubstituted C₁-C₁₀ alkyl (e.g., unsubstituted C₁-C₁₀ saturated alkyl), or unsubstituted aryl (e.g., phenyl). In some embodiments, R^{8a} is unsubstituted C₁-C₅ alkyl (e.g., unsubstituted C₁-C₅ saturated alkyl), or unsubstituted aryl (e.g., phenyl).

R^{41a} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{42a}-substituted or unsubstituted alkyl (e.g. R^{42a}-substituted or unsubstituted saturated alkyl), R^{42a}-substituted or unsubstituted heteroalkyl, R^{42a}-substituted or unsubstituted cycloalkyl, R^{42a}-substituted or unsubstituted heterocycloalkyl, R^{42a}-substituted or unsubstituted aryl, or R^{42a}-substituted or unsubstituted heteroaryl. In some embodiments, R^{41a} is halogen, —CN, —CF₃, —OH, —NO₂, —C(O)NH₂, —SH, —NH₂, —SO₂, —COOH, R^{42a}-substituted or unsubstituted C₁-C₁₀ alkyl (e.g., R^{42a}-substituted or unsubstituted saturated C₁-C₁₀ alkyl), R^{42a}-substituted or unsubstituted 2 to 10 membered heteroalkyl, R^{42a}-substituted or unsubstituted C₃-C₈ cycloalkyl, R^{42a}-substituted or unsubstituted 3 to 8 membered heterocycloalkyl, R^{42a}-substituted or unsubstituted C₅-C₁₀ aryl, or R^{42a}-substituted or unsubstituted 5 to 10 membered heteroaryl. In some embodiments, R^{41a} is R^{42a}-substituted or unsubstituted C₁-C₁₀ alkyl (e.g., R^{42a}-substituted or unsubstituted saturated C₁-C₁₀ alkyl), R^{42a}-substituted or unsubstituted C₃-C₈ cycloalkyl, or R^{42a}-substituted or unsubstituted aryl. In some embodiments, R^{41a} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{41a} is unsubstituted C₁-C₁₀ alkyl (e.g., unsubstituted C₁ to C₁₀ saturated alkyl). In some embodiments, R^{41a} is unsubstituted C₁-C₄ alkyl (e.g., unsubstituted C₁ to C₄ saturated alkyl). In some embodiments, R^{41a} is unsubstituted C₃-C₈ cycloalkyl. In some embodiments, R^{41a} is unsubstituted aryl (e.g., phenyl).

R^{42a} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{43a}-substituted or unsubstituted alkyl (e.g., R^{43a}-substituted or unsubstituted saturated alkyl), R^{43a}-substituted or unsubstituted heteroalkyl, R^{43a}-substituted or unsubstituted cycloalkyl, R^{43a}-substituted or unsubstituted heterocycloalkyl, R^{43a}-substituted or unsubstituted aryl, or R^{43a}-substituted or unsubstituted heteroaryl. In some embodiments, R^{42a} is halogen, —CN, —CF₃, —OH, —NO₂, —C(O)NH₂, —SH, —NH₂, —SO₂, —COOH, R^{43a}-substituted or unsubstituted C₁-C₁₀ alkyl (e.g., R^{43a}-substituted or unsubstituted saturated C₁-C₁₀ alkyl), R^{43a}-substituted or unsubstituted 2 to 10 membered heteroalkyl, R^{43a}-substituted or unsubstituted C₃-C₈ cycloalkyl, R^{43a}-substituted or unsubstituted 3 to 8 membered heterocycloalkyl, R^{43a}-substituted or unsubstituted C₈-C₁₀ aryl, or R^{43a}-substituted or unsubstituted 5 to 10 membered heteroaryl. In some embodiments, R^{42a} is R^{43a}-substituted or unsubstituted C₁-C₁₀ alkyl (e.g., R^{43a}-substituted or unsubstituted saturated C₁-C₁₀ alkyl), R^{43a}-substituted or unsubstituted C₃-C₈ cycloalkyl or R^{43a}-substituted or unsubstituted aryl. In some embodiments, R^{42a} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{42a} is unsubstituted C₁-C₁₀ alkyl (e.g., unsubstituted C₁ to C₁₀ saturated alkyl). In some embodiments, R^{42a} is unsubstituted C₁-C₄ alkyl (e.g., unsubstituted C₁ to C₄ saturated alkyl). In some embodiments, R^{42a} is unsubstituted C₃-C₈ cycloalkyl. In some embodiments, R^{42a} is unsubstituted aryl (e.g., phenyl). In some embodiments, R^{42a} is unsubstituted C₁-C₁₀ alkyl (e.g., unsubstituted C₁ to C₁₀ saturated alkyl). In some embodiments, R^{42a} is unsubstituted C₁-C₄ alkyl (e.g., unsubstituted C₁ to C₄ saturated alkyl). In some embodiments, R^{42a} is unsubstituted C₃-C₈ cycloalkyl. In some embodiments, R^{42a} is unsubstituted aryl (e.g., phenyl).

In some embodiments of the compounds provided herein, R^{9a} is hydrogen, halogen, —CF₃, —CN, —OH, —NH₂, —COOH, —CONH₂, —NO₂, —SH, —SO₂, —SO₂O, —SO₃H, —SO₄H, —SO₂NH₂, NHNH₂, ONH₂, NHC═(O)NHNH₂, R^{44a}-substituted or unsubstituted C₁-C₁₀ alkyl, R^{44a}-substituted or unsubstituted 2 to 10 membered heteroalkyl, R^{44a}-substituted or unsubstituted cycloalkyl, R^{44a}-substituted or unsubstituted heterocycloalkyl, R^{44a}-substituted or unsubstituted aryl, or R^{44a}-substituted or unsubstituted heteroaryl. In some embodiments of the compounds provided herein, R^{9a} is R^{44a}-substituted or unsubstituted C₁-C₁₀ alkyl, R^{44a}-substituted or unsubstituted 2 to 10 membered heteroalkyl, R^{44a}-substituted or unsubstituted C₃-C₈ cycloalkyl, R^{44a}-substituted or unsubstituted 3 to 8 membered heterocycloalkyl, R^{44a}-substituted or unsubstituted C₅-C₁₀ aryl, or R^{44a}-substituted or unsubstituted 5 to 10 membered heteroaryl. In some embodiments of the compounds provided herein, R^{9a} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{9a} is R^{44a}-substituted or unsubstituted C₁-C₁₀ saturated alkyl. In some embodiments of the compounds provided herein, R^{9a} is R^{44a}-substituted or unsubstituted C₁-C₆ alkyl. In some embodiments of the compounds provided herein, R^{9a} is R^{44a}-substituted or unsubstituted C₁-C₆ saturated alkyl. In some embodiments of the compounds provided herein, R^{9a} is R^{44a}-substituted or unsubstituted C₁-C₄ alkyl. In some embodiments of the compounds provided herein, R^{9a} is R^{44a}-substituted or unsubstituted C₁-C₄ saturated alkyl. In some embodiments of the compounds provided herein, R^{9a} is unsubstituted C₁-C₄ saturated alkyl. In some embodiments, R^{9a} is R^{44a}-substituted or unsubstituted C₁-C₁₀ alkyl (e.g., R^{44a}-substituted or unsubstituted C₁-C₁₀ saturated alkyl), R^{44a}-substituted or unsubstituted C₃-C₈ cycloalkyl, or R^{44a}-substituted or unsubstituted aryl. In some embodiments, R^{9a} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{9a} is unsubstituted C₁-C₁₀ alkyl (e.g., unsubstituted C₁-C₁₀ saturated alkyl), or unsubstituted aryl (e.g., phenyl). In some embodiments, R^{9a} is unsubstituted C₁-C₅ alkyl (e.g., unsubstituted C₁-C₅ saturated alkyl), or unsubstituted aryl (e.g., phenyl).

R^{44a} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{44a}-substituted or unsubstituted alkyl (e.g. R^{44a}-substituted or unsubstituted saturated alkyl), R^{44a}-substituted or unsubstituted heteroalkyl, R^{45a}-substituted or unsubstituted cycloalkyl, R^{44a}-substituted or unsubstituted heterocycloalkyl, R^{44a}-substituted or unsubstituted aryl, or R^{44a}-substituted or unsubstituted heteroaryl. In some embodiments, R^{44a} is halogen, —CN, —CF₃, —OH, —NO₂, —C(O)NH₂, —SH, —NH₂, —SO₂, —COOH, R^{45a}-substituted or unsubstituted C₁-C₁₀ alkyl (e.g., R^{45a}-substituted or unsubstituted saturated C₁-C₁₀ alkyl), R^{45a}-substituted or unsubstituted 2 to 10 membered heteroalkyl, R^{44a}-substituted or unsubstituted C₃-C₈ cycloalkyl, R^{45a}-substituted or unsubstituted 3 to 8 membered heterocycloalkyl, R^{45a}-substituted or unsubstituted C₅-C₁₀ aryl, or R^{44a}-substituted or unsubstituted 5 to 10 membered heteroaryl. In some embodiments, R^{44a} is R^{45a}-substituted or unsubstituted C₁-C₁₀ alkyl (e.g., R^{45a}-substituted or unsubstituted saturated C₁-C₁₀ alkyl), R^{44a}-substituted or unsubstituted C₃-C₈ cycloalkyl, or R^{45a}-substituted or unsubstituted aryl. In some embodiments, R^{44a} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{44a} is unsubstituted C₁-C₁₀ alkyl (e.g., unsubstituted C₁ to C₁₀ saturated alkyl). In some embodiments, R^{44a} is unsubstituted C₁-C₄ alkyl (e.g., unsubstituted C₁ to C₄ saturated alkyl). In some embodiments, R^{44a} is unsubstituted C₃-C₈ cycloalkyl. In some embodiments, R^{44a} is unsubstituted aryl (e.g., phenyl).

R^{45a} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{46a}-substituted or unsubstituted alkyl (e.g., R^{46a}-substituted or unsubstituted saturated alkyl), R^{46a}-substituted or unsubstituted heteroalkyl, R^{46a}-substituted or unsubstituted cycloalkyl, R^{46a}-substituted or unsubstituted heterocycloalkyl, R^{46a}-substituted or unsubstituted aryl, or R^{46a}-substituted or unsubstituted heteroaryl. In some embodiments, R^{45a} is halogen, —CN, —CF₃, —OH, —NO₂, —C(O)NH₂, —SH, —NH₂, —SO₂, —COOH, R^{46a}-substituted or unsubstituted C₁-C₁₀ alkyl (e.g., R^{46a}-substituted or unsubstituted saturated C₁-C₁₀ alkyl), R^{46a}-substituted or unsubstituted 2 to 10 membered heteroalkyl, R^{46a}-substituted or unsubstituted C₃-C₈ cycloalkyl, R^{46a}-substituted or unsubstituted 3 to 8 membered heterocycloalkyl, R^{46a}-substituted or unsubstituted C₅-C₁₀ aryl, or R^{46a}-substituted or unsubstituted 5 to 10 membered heteroaryl. In some embodiments, R^{45a} is R^{46a}-substituted or unsubstituted C₁-C₁₀ alkyl (e.g., R^{46a}-substituted or unsubstituted saturated C₁-C₁₀ alkyl), R^{46a}-substituted or unsubstituted C₃-C₈ cycloalkyl or R^{46a}-substituted or unsubstituted aryl. In some embodiments, R^{45a} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{45a} is unsubstituted C₁-C₁₀ alkyl (e.g., unsubstituted C₁ to C₁₀ saturated alkyl). In some embodiments, R^{45a} is unsubstituted C₁-C₄ alkyl (e.g., unsubstituted C₁ to C₄ saturated alkyl). In some embodiments, R^{45a} is unsubstituted C₃-C₈ cycloalkyl. In some embodiments, R^{45a} is unsubstituted aryl (e.g., phenyl). In some embodiments, R^{45a} is unsubstituted C₁-C₁₀ alkyl (e.g., unsubstituted C₁ to C₁₀ saturated alkyl). In some embodiments, R^{45a} is unsubstituted C₁-C₄ alkyl (e.g., unsubstituted C₁ to C₄ saturated alkyl). In some embodiments, R^{45a} is unsubstituted C₃-C₈ cycloalkyl. In some embodiments, R^{45a} is unsubstituted aryl (e.g., phenyl).

In some embodiments of the compounds provided herein, R^{10a} is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{47a}-substituted or unsubstituted C₁-C₁₀ alkyl, R^{47a}-substituted or unsubstituted 2 to 10 membered heteroalkyl, R^{47a}-substituted or unsubstituted cycloalkyl, R^{44a}-substituted or unsubstituted heterocycloalkyl, R^{47a}-substituted or unsubstituted aryl, or R^{47a}-substituted or unsubstituted heteroaryl. In some embodiments of the compounds provided herein, R^{10a} is R^{47a}-substituted or unsubstituted C₁-C₁₀ alkyl, R^{47a}-substituted or unsubstituted 2 to 10 membered heteroalkyl, R^{47a}-substituted or unsubstituted C₃-C₈ cycloalkyl, R^{44a}-substituted or unsubstituted 3 to 8 membered heterocycloalkyl, R^{44a}-substituted or unsubstituted C₅-C₁₀ aryl, or R^{44a}-substituted or unsubstituted 5 to 10 membered heteroaryl. In some embodiments of the compounds provided herein, R^{10a} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{10a} is R^{47a}-substituted or unsubstituted C₁-C₁₀ saturated alkyl. In some embodiments of the compounds provided herein, R^{10a} is R^{47a}-substituted or unsubstituted C₁-C₆ alkyl. In some embodiments of the compounds provided herein, R^{10a} is R^{47a}-substituted or unsubstituted C₁-C₆ saturated alkyl. In some embodiments of the compounds provided herein, R^{10a} is R^{47a}-substituted or unsubstituted C₁-C₄ alkyl. In some embodiments of the compounds provided herein, R^{10a} is R^{47a}-substituted or unsubstituted C₁-C₄ saturated alkyl. In some embodiments of the compounds provided herein, R^{10a} is unsubstituted C₁-C₄ saturated alkyl. In some embodiments, R^{10a} is R^{47a}-substituted or unsubstituted C₁-C₁₀ alkyl (e.g., R^{47a}-substituted or unsubstituted C₁-C₁₀ saturated alkyl), R^{44a}-substituted or unsubstituted C₃-C₈ cycloalkyl, or R^{44a}-substituted or unsubstituted aryl. In some embodiments, R^{10a} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{10a} is unsubstituted C₁-C₁₀ alkyl (e.g., unsubstituted C₁-C₁₀ saturated alkyl), or unsubstituted aryl (e.g., phenyl). In some embodiments, R^{10a} is unsubstituted C₁-C₅ alkyl (e.g., unsubstituted C₁-C₅ saturated alkyl), or unsubstituted aryl (e.g., phenyl). In some embodiments, R^{10a} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{10a} is unsubstituted C₁-C₁₀ alkyl (e.g., unsubstituted C₁ to C₁₀ saturated alkyl). In some embodiments, R^{10a} is unsubstituted C₁-C₄ alkyl (e.g., unsubstituted C₁ to C₄ saturated alkyl). In some embodiments, R^{10a} is unsubstituted C₃-C₈ cycloalkyl. In some embodiments, R^{10a} is unsubstituted aryl (e.g., phenyl). In some embodiments, R^{10a} is unsubstituted C₁-C₁₀ alkyl (e.g., unsubstituted C₁ to C₁₀ saturated alkyl). In some embodiments, R^{10a} is unsubstituted C₁-C₄ alkyl (e.g., unsubstituted C₁ to C₄ saturated alkyl). In some embodiments, R^{19a} is unsubstituted C₃-C₈ cycloalkyl. In some embodiments, R^{10a} is unsubstituted aryl (e.g., phenyl).

R^{47a} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{48a}-substituted or unsubstituted alkyl (e.g. R^{48a}-substituted or unsubstituted saturated alkyl), R^{48a}-substituted or unsubstituted heteroalkyl, R^{48a}-substituted or unsubstituted cycloalkyl, R^{48a}-substituted or unsubstituted heterocycloalkyl, R^{48a}-substituted or unsubstituted aryl, or R^{48a}-substituted or unsubstituted heteroaryl. In some embodiments, R^{47a} is halogen, —CN, —CF₃, —OH, —NO₂, —C(O)NH₂, —SH, —NH₂, —SO₂, —COOH, R^{48a}-substituted or unsubstituted C₁-C₁₀ alkyl (e.g., R^{48a}-substituted or unsubstituted saturated C₁-C₁₀ alkyl), R^{48a}-substituted or unsubstituted 2 to 10 membered heteroalkyl, R^{48a}-substituted or unsubstituted C₃-C₈ cycloalkyl, R^{48a}-substituted or unsubstituted 3 to 8 membered heterocycloalkyl, R^{48a}-substituted or unsubstituted C₅-C₁₀ aryl, or R^{48a}-substituted or unsubstituted 5 to 10 membered heteroaryl. In some embodiments, R^{47a} is R^{48a}-substituted or unsubstituted C₁-C₁₀ alkyl (e.g., R^{48a}-substituted or unsubstituted saturated C₁-C₁₀ alkyl), R^{48a}-substituted or unsubstituted C₃-C₈ cycloalkyl, or R^{48a}-substituted or unsubstituted aryl. In some embodiments, R^{47a} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{47a} is unsubstituted C₁-C₁₀ alkyl (e.g., unsubstituted C₁ to C₁₀ saturated alkyl). In some embodiments, R^{47a} is unsubstituted C₁-C₄ alkyl (e.g., unsubstituted C₁ to C₄ saturated alkyl). In some embodiments, R^{47a} is unsubstituted C₃-C₈ cycloalkyl. In some embodiments, R^{47a} is unsubstituted aryl (e.g., phenyl).

R^{48a} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{49a}-substituted or unsubstituted alkyl (e.g., R^{49a}-substituted or unsubstituted saturated alkyl), R^{49a}-substituted or unsubstituted heteroalkyl, R^{49a}-substituted or unsubstituted cycloalkyl, R^{49a}-substituted or unsubstituted heterocycloalkyl, R^{49a}-substituted or unsubstituted aryl, or R^{49a}-substituted or unsubstituted heteroaryl. In some embodiments, R^{48a} is halogen, —CN, —CF₃, —OH, —NO₂, —C(O)NH₂, —SH, —NH₂, —SO₂, —COOH, R^{49a}-substituted or unsubstituted C₁-C₁₀ alkyl (e.g., R^{49a}-substituted or unsubstituted saturated C₁-C₁₀ alkyl), R^{49a}-substituted or unsubstituted 2 to 10 membered heteroalkyl, R^{49a}-substituted or unsubstituted C₃-C₈ cycloalkyl, R^{49a}-substituted or unsubstituted 3 to 8 membered heterocycloalkyl, R^{49a}-substituted or unsubstituted C₅-C₁₀ aryl, or R^{49a}-substituted or unsubstituted 5 to 10 membered heteroaryl. In some embodiments, R^{48a} is R^{49a}-substituted or unsubstituted C₁-C₁₀ alkyl (e.g., R^{49a}-substituted or unsubstituted saturated C₁-C₁₀ alkyl), R^{49a}-substituted or unsubstituted C₃-C₈ cycloalkyl or R^{49a}-substituted or unsubstituted aryl. In some embodiments, R^{48a} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{48a} is unsubstituted C₁-C₁₀ alkyl (e.g., unsubstituted C₁ to C₁₀ saturated alkyl). In some embodiments, R^{48a} is unsubstituted C₁-C₄ alkyl (e.g., unsubstituted C₁ to C₄ saturated alkyl). In some embodiments, R^{48a} is unsubstituted C₃-C₈ cycloalkyl. In some embodiments, R^{48a} is unsubstituted aryl (e.g., phenyl). In some embodiments, R^{48a} is unsubstituted C₁-C₁₀ alkyl (e.g., unsubstituted C₁ to C₁₀ saturated alkyl). In some embodiments, R^{48a} is unsubstituted C₁-C₄ alkyl (e.g., unsubstituted C₁ to C₄ saturated alkyl). In some embodiments, R^{48a} is unsubstituted C₃-C₈ cycloalkyl. In some embodiments, R^{48a} is unsubstituted aryl (e.g., phenyl).

In some embodiments of the compounds provided herein, R^{8b} is hydrogen, halogen, —CF₃, —CN, —OH, —NH₂, —COOH, —CONH₂, —NO₂, —SH, —SO₂, —SO₂O, —SO₃H, —SO₄H, —SO₂NH₂, NHNH₂, ONH₂, NHC═(O)NHNH₂, R^{41b}-substituted or unsubstituted C₁-C₁₀ alkyl, R^{41b}-substituted or unsubstituted 2 to 10 membered heteroalkyl, R^{41b}-substituted or unsubstituted cycloalkyl, R^{41b}-substituted or unsubstituted heterocycloalkyl, R^{41b}-substituted or unsubstituted aryl, or R^{41b}-substituted or unsubstituted heteroaryl. In some embodiments of the compounds provided herein, R^{8b} is R^{41b}-substituted or unsubstituted C₁-C₁₀ alkyl, R^{41b}-substituted or unsubstituted 2 to 10 membered heteroalkyl, R^{41b}-substituted or unsubstituted C₃-C₈ cycloalkyl, R^{41b}-substituted or unsubstituted 3 to 8 membered heterocycloalkyl, R^{41b}-substituted or unsubstituted C₅-C₁₀ aryl, or R^{41b}-substituted or unsubstituted 5 to 10 membered heteroaryl. In some embodiments of the compounds provided herein, R^{8b} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{8b} is R^{41b}-substituted or unsubstituted C₁-C₁₀ saturated alkyl. In some embodiments of the compounds provided herein, R^{8b} is R^{41b}-substituted or unsubstituted C₁-C₈ alkyl. In some embodiments of the compounds provided herein, R^{8b} is R^{41b}-substituted or unsubstituted C₁-C₆ saturated alkyl. In some embodiments of the compounds provided herein, R^{8b} is R^{41b}-substituted or unsubstituted C₁-C₄ alkyl. In some embodiments of the compounds provided herein, R^{8b} is R^{41b}-substituted or unsubstituted C₁-C₄ saturated alkyl. In some embodiments of the compounds provided herein, R^{8b} is unsubstituted C₁-C₄ saturated alkyl. In some embodiments, R^{8b} is R^{41b}-substituted or unsubstituted C₁-C₁₀ alkyl (e.g., R^{41b}-substituted or unsubstituted C₁-C₁₀ saturated alkyl), R^{41b}-substituted or unsubstituted C₃-C₈ cycloalkyl, or R^{41b}-substituted or unsubstituted aryl. In some embodiments, R^{8b} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{8b} is unsubstituted C₁-C₁₀ alkyl (e.g., unsubstituted C₁-C₁₀ saturated alkyl), or unsubstituted aryl (e.g., phenyl). In some embodiments, R^{8b} is unsubstituted C₁-C₅ alkyl (e.g., unsubstituted C₁-C₅ saturated alkyl), or unsubstituted aryl (e.g., phenyl).

R^{41b} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{42b}-substituted or unsubstituted alkyl (e.g. R^{42b}-substituted or unsubstituted saturated alkyl), R^{42b}-substituted or unsubstituted heteroalkyl, R^{42b}-substituted or unsubstituted cycloalkyl, R^{42b}-substituted or unsubstituted heterocycloalkyl, R^{42b}-substituted or unsubstituted aryl, or R^{42b}-substituted or unsubstituted heteroaryl. In some embodiments, R^{41b} is halogen, —CN, —CF₃, —OH, —NO₂, —C(O)NH₂, —SH, —NH₂, —SO₂, —COOH, R^{42b}-substituted or unsubstituted C₁-C₁₀ alkyl (e.g., R^{42b}-substituted or unsubstituted saturated C₁-C₁₀ alkyl), R^{42b}-substituted or unsubstituted 2 to 10 membered heteroalkyl, R^{42b}-substituted or unsubstituted C₃-C₈ cycloalkyl, R^{42b}-substituted or unsubstituted 3 to 8 membered heterocycloalkyl, R^{42b}-substituted or unsubstituted C₅-C₁₀ aryl, or R^{42b}-substituted or unsubstituted 5 to 10 membered heteroaryl. In some embodiments, R^{41b} is R^{42b}-substituted or unsubstituted C₁-C₁₀ alkyl (e.g., R^{42b}-substituted or unsubstituted saturated C₁-C₁₀ alkyl), R^{42b}-substituted or unsubstituted C₃-C₈ cycloalkyl, or R^{42b}-substituted or unsubstituted aryl. In some embodiments, R^{41b} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{41b} is unsubstituted C₁-C₁₀ alkyl (e.g., unsubstituted C₁ to C₁₀ saturated alkyl). In some embodiments, R^{41b} is unsubstituted C₁-C₄ alkyl (e.g., unsubstituted C₁ to C₄ saturated alkyl). In some embodiments, R^{41b} is unsubstituted C₃-C₈ cycloalkyl. In some embodiments, R^{41b} is unsubstituted aryl (e.g., phenyl).

R^{42b} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{43b}-substituted or unsubstituted alkyl (e.g., R^{43b}-substituted or unsubstituted saturated alkyl), R^{43b}-substituted or unsubstituted heteroalkyl, R^{43b}-substituted or unsubstituted cycloalkyl, R^{43b}-substituted or unsubstituted heterocycloalkyl, R^{43b}-substituted or unsubstituted aryl, or R^{43b}-substituted or unsubstituted heteroaryl. In some embodiments, R^{42b} is halogen, —CN, —CF₃, —OH, —NO₂, —C(O)NH₂, —SH, —NH₂, —SO₂, —COOH, R^{43b}-substituted or unsubstituted C₁-C₁₀ alkyl (e.g., R^{43b}-substituted or unsubstituted saturated C₁-C₁₀ alkyl), R^{43b}-substituted or unsubstituted 2 to 10 membered heteroalkyl, R^{43b}-substituted or unsubstituted C₃-C₈ cycloalkyl, R^{43b}-substituted or unsubstituted 3 to 8 membered heterocycloalkyl, R^{43b}-substituted or unsubstituted C₅-C₁₀ aryl, or R^{43b}-substituted or unsubstituted 5 to 10 membered heteroaryl. In some embodiments, R^{42b} is R^{43b}-substituted or unsubstituted C₁-C₁₀ alkyl (e.g., R^{43b}-substituted or unsubstituted saturated C₁-C₁₀ alkyl), R^{43b}-substituted or unsubstituted C₃-C₈ cycloalkyl or R^{43b}-substituted or unsubstituted aryl. In some embodiments, R^{42b} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{42b} is unsubstituted C₁-C₁₀ alkyl (e.g., unsubstituted C₁ to C₁₀ saturated alkyl). In some embodiments, R^{42b} is unsubstituted C₁-C₄ alkyl (e.g., unsubstituted C₁ to C₄ saturated alkyl). In some embodiments, R^{42b} is unsubstituted C₃-C₈ cycloalkyl. In some embodiments, R^{42b} is unsubstituted aryl (e.g., phenyl). In some embodiments, R^{42b} is unsubstituted C₁-C₁₀ alkyl (e.g., unsubstituted C₁ to C₁₀ saturated alkyl). In some embodiments, R^{42b} is unsubstituted C₁-C₄ alkyl (e.g., unsubstituted C₁ to C₄ saturated alkyl). In some embodiments, R^{42b} is unsubstituted C₃-C₈ cycloalkyl. In some embodiments, R^{42b} is unsubstituted aryl (e.g., phenyl).

In some embodiments of the compounds provided herein, R^{9b} is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{44b}-substituted or unsubstituted C₁-C₁₀ alkyl, R^{44b}-substituted or unsubstituted 2 to 10 membered heteroalkyl, R^{44b}-substituted or unsubstituted cycloalkyl, R^{44b}-substituted or unsubstituted heterocycloalkyl, R^{44b}-substituted or unsubstituted aryl, or R^{44b}-substituted or unsubstituted heteroaryl. In some embodiments of the compounds provided herein, R^{9b} is R^{44b}-substituted or unsubstituted C₁-C₁₀ alkyl, R^{44b}-substituted or unsubstituted 2 to 10 membered heteroalkyl, R^{44b}-substituted or unsubstituted C₃-C₈ cycloalkyl, R^{44b}-substituted or unsubstituted 3 to 8 membered heterocycloalkyl, R^{44b}-substituted or unsubstituted C₅-C₁₀ aryl, or R^{44b}-substituted or unsubstituted 5 to 10 membered heteroaryl. In some embodiments of the compounds provided herein, R^{9b} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{9b} is R^{44b}-substituted or unsubstituted C₁-C₁₀ saturated alkyl. In some embodiments of the compounds provided herein, R^{9b} is R^{44b}-substituted or unsubstituted C₁-C₆ alkyl. In some embodiments of the compounds provided herein, R^{9b} is R^{44b}-substituted or unsubstituted C₁-C₆ saturated alkyl. In some embodiments of the compounds provided herein, R^{9b} is R^{44b}-substituted or unsubstituted C₁-C₄ alkyl. In some embodiments of the compounds provided herein, R^{9b} is R^{44b}-substituted or unsubstituted C₁-C₄ saturated alkyl. In some embodiments of the compounds provided herein, R^{9b} is unsubstituted C₁-C₄ saturated alkyl. In some embodiments, R^{9b} is R^{44b}-substituted or unsubstituted C₁-C₁₀ alkyl (e.g., R^{44b}-substituted or unsubstituted C₁-C₁₀ saturated alkyl), R^{44b}-substituted or unsubstituted C₃-C₈ cycloalkyl, or R^{44b}-substituted or unsubstituted aryl. In some embodiments, R^{9b} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{9b} is unsubstituted C₁-C₁₀ alkyl (e.g., unsubstituted C₁-C₁₀ saturated alkyl), or unsubstituted aryl (e.g., phenyl). In some embodiments, R^{9b} is unsubstituted C₁-C₅ alkyl (e.g., unsubstituted C₁-C₅ saturated alkyl), or unsubstituted aryl (e.g., phenyl).

R^{44b} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{45b}-substituted or unsubstituted alkyl (e.g. R^{45b}-substituted or unsubstituted saturated alkyl), R^{45b}-substituted or unsubstituted heteroalkyl, R^{45b}— substituted or unsubstituted cycloalkyl, R^{45b}-substituted or unsubstituted heterocycloalkyl, R^{45b}-substituted or unsubstituted aryl, or R^{45b}-substituted or unsubstituted heteroaryl. In some embodiments, R^{44b} is halogen, —CN, —CF₃, —OH, —NO₂, —C(O)NH₂, —SH, —NH₂, —SO₂, —COOH, R^{45b}-substituted or unsubstituted C₁-C₁₀ alkyl (e.g., R^{45b}-substituted or unsubstituted saturated C₁-C₁₀ alkyl), R^{45b}-substituted or unsubstituted 2 to 10 membered heteroalkyl, R^{45b}-substituted or unsubstituted C₃-C₈ cycloalkyl, R^{45b}-substituted or unsubstituted 3 to 8 membered heterocycloalkyl, R^{45b}-substituted or unsubstituted C₅-C₁₀ aryl, or R^{45b}-substituted or unsubstituted 5 to 10 membered heteroaryl. In some embodiments, R^{44b} is R^{45b}-substituted or unsubstituted C₁-C₁₀ alkyl (e.g., R^{45b}-substituted or unsubstituted saturated C₁-C₁₀ alkyl), R^{45b}-substituted or unsubstituted C₃-C₈ cycloalkyl, or R^{45b}-substituted or unsubstituted aryl. In some embodiments, R^{44b} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{44b} is unsubstituted C₁-C₁₀ alkyl (e.g., unsubstituted C₁ to C₁₀ saturated alkyl). In some embodiments, R^{44b} is unsubstituted C₁-C₄ alkyl (e.g., unsubstituted C₁ to C₄ saturated alkyl). In some embodiments, R^{44b} is unsubstituted C₃-C₈ cycloalkyl. In some embodiments, R^{44b} is unsubstituted aryl (e.g., phenyl).

R^{45b} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{46b}-substituted or unsubstituted alkyl (e.g., R^{46b}-substituted or unsubstituted saturated alkyl), R^{46b}-substituted or unsubstituted heteroalkyl, R^{46b}-substituted or unsubstituted cycloalkyl, R^{46b}-substituted or unsubstituted heterocycloalkyl, R^{46b}-substituted or unsubstituted aryl, or R^{46b}-substituted or unsubstituted heteroaryl. In some embodiments, R^{45b} is halogen, —CN, —CF₃, —OH, —NO₂, —C(O)NH₂, —SH, —NH₂, —SO₂, —COOH, R^{46b}-substituted or unsubstituted C₁-C₁₀ alkyl (e.g., R^{46b}-substituted or unsubstituted saturated C₁-C₁₀ alkyl), R^{46b}-substituted or unsubstituted 2 to 10 membered heteroalkyl, R^{46b}-substituted or unsubstituted C₃-C₈ cycloalkyl, R^{46b}-substituted or unsubstituted 3 to 8 membered heterocycloalkyl, R^{46b}-substituted or unsubstituted C₅-C₁₀ aryl, or R^{46b}-substituted or unsubstituted 5 to 10 membered heteroaryl. In some embodiments, R^{45b} is R^{46b}-substituted or unsubstituted C₁-C₁₀ alkyl (e.g., R^{46b}-substituted or unsubstituted saturated C₁-C₁₀ alkyl), R^{46b}-substituted or unsubstituted C₃-C₈ cycloalkyl or R^{46b}-substituted or unsubstituted aryl. In some embodiments, R^{45b} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{45b} is unsubstituted C₁-C₁₀ alkyl (e.g., unsubstituted C₁ to C₁₀ saturated alkyl). In some embodiments, R^{45b} is unsubstituted C₁-C₄ alkyl (e.g., unsubstituted C₁ to C₄ saturated alkyl). In some embodiments, R^{45b} is unsubstituted C₃-C₈ cycloalkyl. In some embodiments, R^{45b} is unsubstituted aryl (e.g., phenyl). In some embodiments, R^{45b} is unsubstituted C₁-C₁₀ alkyl (e.g., unsubstituted C₁ to C₁₀ saturated alkyl). In some embodiments, R^{45b} is unsubstituted C₁-C₄ alkyl (e.g., unsubstituted C₁ to C₄ saturated alkyl). In some embodiments, R^{45b} is unsubstituted C₃-C₈ cycloalkyl. In some embodiments, R^{45b} is unsubstituted aryl (e.g., phenyl).

In some embodiments of the compounds provided herein, R^{10b} is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{47b}-substituted or unsubstituted C₁-C₁₀ alkyl, R^{47b}-substituted or unsubstituted 2 to 10 membered heteroalkyl, R^{47b}-substituted or unsubstituted cycloalkyl, R^{47b}-substituted or unsubstituted heterocycloalkyl, R^{47b}-substituted or unsubstituted aryl, or R^{47b}-substituted or unsubstituted heteroaryl. In some embodiments of the compounds provided herein, R^{10b} is R^{47b}-substituted or unsubstituted C₁-C₁₀ alkyl, R^{47b}-substituted or unsubstituted 2 to 10 membered heteroalkyl, R^{47b}-substituted or unsubstituted C₃-C₈ cycloalkyl, R^{47b}-substituted or unsubstituted 3 to 8 membered heterocycloalkyl, R^{47b}-substituted or unsubstituted C₅-C₁₀ aryl, or R^{47b}-substituted or unsubstituted 5 to 10 membered heteroaryl. In some embodiments of the compounds provided herein, R^{10b} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{10b} is R^{47b}-substituted or unsubstituted C₁-C₁₀ saturated alkyl. In some embodiments of the compounds provided herein, R^{10b} is R^{47b}-substituted or unsubstituted C₁-C₆ alkyl. In some embodiments of the compounds provided herein, R^{10b} is R^{47b}-substituted or unsubstituted C₁-C₆ saturated alkyl. In some embodiments of the compounds provided herein, R^{10b} is R^{47b}-substituted or unsubstituted C₁-C₄ alkyl. In some embodiments of the compounds provided herein, R^{10b} is R^{47b}-substituted or unsubstituted C₁-C₄ saturated alkyl. In some embodiments of the compounds provided herein, R^{10b} is unsubstituted C₁-C₄ saturated alkyl. In some embodiments, R^{10b} is R^{47b-}substituted or unsubstituted C₁-C₁₀ alkyl (e.g., R^{47b}-substituted or unsubstituted C₁-C₁₀ saturated alkyl), R^{47b}-substituted or unsubstituted C₃-C₈ cycloalkyl, or R^{47b}-substituted or unsubstituted aryl. In some embodiments, R^{10b} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{10b} is unsubstituted C₁-C₁₀ alkyl (e.g., unsubstituted C₁-C₁₀ saturated alkyl), or unsubstituted aryl (e.g., phenyl). In some embodiments, R^{10b} is unsubstituted C₁-C₅ alkyl (e.g., unsubstituted C₁-C₅ saturated alkyl), or unsubstituted aryl (e.g., phenyl). In some embodiments, R^{10b} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{10b} is unsubstituted C₁-C₁₀ alkyl (e.g., unsubstituted C₁ to C₁₀ saturated alkyl). In some embodiments, R^{10b} is unsubstituted C₁-C₄ alkyl (e.g., unsubstituted C₁ to C₄ saturated alkyl). In some embodiments, R^{10b} is unsubstituted C₃-C₈ cycloalkyl. In some embodiments, R^{10b} is unsubstituted aryl (e.g., phenyl). In some embodiments, R^{10b} is unsubstituted C₁-C₁₀ alkyl (e.g., unsubstituted C₁ to C₁₀ saturated alkyl). In some embodiments, R^{10b} is unsubstituted C₁-C₄ alkyl (e.g., unsubstituted C₁ to C₄ saturated alkyl). In some embodiments, R^{10b} is unsubstituted C₃-C₈ cycloalkyl. In some embodiments, R^{10b} is unsubstituted aryl (e.g., phenyl).

R^{47b} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{48b}-substituted or unsubstituted alkyl (e.g. R^{48b}-substituted or unsubstituted saturated alkyl), R^{48b}-substituted or unsubstituted heteroalkyl, R^{48b}-substituted or unsubstituted cycloalkyl, R^{48b}-substituted or unsubstituted heterocycloalkyl, R^{48b}-substituted or unsubstituted aryl, or R^{48b}-substituted or unsubstituted heteroaryl. In some embodiments, R^{47b} is halogen, —CN, —CF₃, —OH, —NO₂, —C(O)NH₂, —SH, —NH₂, —SO₂, —COOH, R^{48b}-substituted or unsubstituted C₁-C₁₀ alkyl (e.g., R^{48b}-substituted or unsubstituted saturated C₁-C₁₀ alkyl), R^{48b}-substituted or unsubstituted 2 to 10 membered heteroalkyl, R^{48b}-substituted or unsubstituted C₃-C₈ cycloalkyl, R^{48b}-substituted or unsubstituted 3 to 8 membered heterocycloalkyl, R^{48b}-substituted or unsubstituted C₅-C₁₀ aryl, or R^{48b}-substituted or unsubstituted 5 to 10 membered heteroaryl. In some embodiments, R^{47b} is R^{48b}-substituted or unsubstituted C₁-C₁₀ alkyl (e.g., R^{48b}-substituted or unsubstituted saturated C₁-C₁₀ alkyl), R^{48b}-substituted or unsubstituted C₃-C₈ cycloalkyl, or R^{48b}-substituted or unsubstituted aryl. In some embodiments, R^{47b} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{47b} is unsubstituted C₁-C₁₀ alkyl (e.g., unsubstituted C₁ to C₁₀ saturated alkyl). In some embodiments, R^{47b} is unsubstituted C₁-C₄ alkyl (e.g., unsubstituted C₁ to C₄ saturated alkyl). In some embodiments, R^{47b} is unsubstituted C₃-C₈ cycloalkyl. In some embodiments, R^{47b} is unsubstituted aryl (e.g., phenyl).

R^{48b} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{49b}-substituted or unsubstituted alkyl (e.g., R^{49b}-substituted or unsubstituted saturated alkyl), R^{49b}-substituted or unsubstituted heteroalkyl, R^{49b}-substituted or unsubstituted cycloalkyl, R^{49b}-substituted or unsubstituted heterocycloalkyl, R^{49b}-substituted or unsubstituted aryl, or R^{49b}-substituted or unsubstituted heteroaryl. In some embodiments, R^{48b} is halogen, —CN, —CF₃, —OH, —NO₂, —C(O)NH₂, —SH, —NH₂, —SO₂, —COOH, R^{49b}-substituted or unsubstituted C₁-C₁₀ alkyl (e.g., R^{49b}-substituted or unsubstituted saturated C₁-C₁₀ alkyl), R^{49b}-substituted or unsubstituted 2 to 10 membered heteroalkyl, R^{49b}-substituted or unsubstituted C₃-C₈ cycloalkyl, R^{49b}-substituted or unsubstituted 3 to 8 membered heterocycloalkyl, R^{49b}-substituted or unsubstituted C₅-C₁₀ aryl, or R^{49b}-substituted or unsubstituted 5 to 10 membered heteroaryl. In some embodiments, R^{48b} is R^{49b}-substituted or unsubstituted C₁-C₁₀ alkyl (e.g., R^{49b}-substituted or unsubstituted saturated C₁-C₁₀ alkyl), R^{49b}-substituted or unsubstituted C₃-C₈ cycloalkyl or R^{49b}-substituted or unsubstituted aryl. In some embodiments, R^{48b} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{48b} is unsubstituted C₁-C₁₀ alkyl (e.g., unsubstituted C₁ to C₁₀ saturated alkyl). In some embodiments, R^{48b} is unsubstituted C₁-C₄ alkyl (e.g., unsubstituted C₁ to C₄ saturated alkyl). In some embodiments, R^{48b} is unsubstituted C₃-C₈ cycloalkyl. In some embodiments, R^{48b} is unsubstituted aryl (e.g., phenyl). In some embodiments, R^{48b} is unsubstituted C₁-C₁₀ alkyl (e.g., unsubstituted C₁ to C₁₀ saturated alkyl). In some embodiments, R^{48b} is unsubstituted C₁-C₄ alkyl (e.g., unsubstituted C₁ to C₄ saturated alkyl). In some embodiments, R^{48b} is unsubstituted C₃-C₈ cycloalkyl. In some embodiments, R^{48b} is unsubstituted aryl (e.g., phenyl).

In some embodiments of the compounds provided herein, R⁸ is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{41c}-substituted or unsubstituted C₁-C₁₀ alkyl, R^{41c}-substituted or unsubstituted 2 to 10 membered heteroalkyl, R^{41c}-substituted or unsubstituted cycloalkyl, R^{41c}-substituted or unsubstituted heterocycloalkyl, R^{41c}-substituted or unsubstituted aryl, or R^{41c}-substituted or unsubstituted heteroaryl. In some embodiments of the compounds provided herein, R⁸ is R^{41c}-substituted or unsubstituted C₁-C₁₀ alkyl, R^{41c}-substituted or unsubstituted 2 to 10 membered heteroalkyl, R^{41c}-substituted or unsubstituted C₃-C₈ cycloalkyl, R^{41c}-substituted or unsubstituted 3 to 8 membered heterocycloalkyl, R^{41c}-substituted or unsubstituted C₅-C₁₀ aryl, or R^{41c}-substituted or unsubstituted 5 to 10 membered heteroaryl. In some embodiments of the compounds provided herein, R^{8c} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₈-C₁₀ aryl, or unsubstituted 5 to 10 membered heteroaryl. In some embodiments of the compounds provided herein, R⁸ is R^{41c}-substituted or unsubstituted C₁-C₁₀ saturated alkyl. In some embodiments of the compounds provided herein, R^{8C} is R^{41c}-substituted or unsubstituted C₁-C₈ alkyl. In some embodiments of the compounds provided herein, R^{8C} is R^{41c}-substituted or unsubstituted C₁-C₆ saturated alkyl. In some embodiments of the compounds provided herein, R^{8C} is R^{41c}-substituted or unsubstituted C₁-C₄ alkyl. In some embodiments of the compounds provided herein, R⁸ is R^{41c}-substituted or unsubstituted C₁-C₄ saturated alkyl. In some embodiments of the compounds provided herein, R^{8C} is unsubstituted C₁-C₄ saturated alkyl. In some embodiments, R^{8C} is R^{41c}-substituted or unsubstituted C₁-C₁₀ alkyl (e.g., R^{41c}-substituted or unsubstituted C₁-C₁₀ saturated alkyl), R^{41c}-substituted or unsubstituted C₃-C₈ cycloalkyl, or R^{41c}-substituted or unsubstituted aryl. In some embodiments, R^{8C} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{8C} is unsubstituted C₁-C₁₀ alkyl (e.g., unsubstituted C₁-C₁₀ saturated alkyl), or unsubstituted aryl (e.g., phenyl). In some embodiments, R^{8C} is unsubstituted C₁-C₈ alkyl (e.g., unsubstituted C₁-C₅ saturated alkyl), or unsubstituted aryl (e.g., phenyl).

R^{41c} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{42c}-substituted or unsubstituted alkyl (e.g. R^{42c}-substituted or unsubstituted saturated alkyl), R^{42c}-substituted or unsubstituted heteroalkyl, R^{42c}-substituted or unsubstituted cycloalkyl, R^{42c}-substituted or unsubstituted heterocycloalkyl, R^{42c}-substituted or unsubstituted aryl, or R^{42c}-substituted or unsubstituted heteroaryl. In some embodiments, R^{41c} is halogen, —CN, —CF₃, —OH, —NO₂, —C(O)NH₂, —SH, —NH₂, —SO₂, —COOH, R^{42c}-substituted or unsubstituted C₁-C₁₀ alkyl (e.g., R^{42c}-substituted or unsubstituted saturated C₁-C₁₀ alkyl), R^{42c}-substituted or unsubstituted 2 to 10 membered heteroalkyl, R^{42c}-substituted or unsubstituted C₃-C₈ cycloalkyl, R^{42c}-substituted or unsubstituted 3 to 8 membered heterocycloalkyl, R^{42c}-substituted or unsubstituted C₅-C₁₀ aryl, or R^{42c}-substituted or unsubstituted 5 to 10 membered heteroaryl. In some embodiments, R^{41c} is R^{42c}-substituted or unsubstituted C₁-C₁₀ alkyl (e.g., R^{42c}-substituted or unsubstituted saturated C₁-C₁₀ alkyl), R^{42c}-substituted or unsubstituted C₃-C₈ cycloalkyl, or R^{42c}-substituted or unsubstituted aryl. In some embodiments, R^{41c} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{41c} is unsubstituted C₁-C₁₀ alkyl (e.g., unsubstituted C₁ to C₁₀ saturated alkyl). In some embodiments, R^{41c} is unsubstituted C₁-C₄ alkyl (e.g., unsubstituted C₁ to C₄ saturated alkyl). In some embodiments, R^{41c} is unsubstituted C₃-C₈ cycloalkyl. In some embodiments, R^{41c} is unsubstituted aryl (e.g., phenyl).

R^{42c} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{43c}-substituted or unsubstituted alkyl (e.g., R^{43c}-substituted or unsubstituted saturated alkyl), R^{43c}-substituted or unsubstituted heteroalkyl, R^{43c}-substituted or unsubstituted cycloalkyl, R^{43c}-substituted or unsubstituted heterocycloalkyl, R^{43c}-substituted or unsubstituted aryl, or R^{43c}-substituted or unsubstituted heteroaryl. In some embodiments, R^{42c} is halogen, —CN, —CF₃, —OH, —NO₂, —C(O)NH₂, —SH, —NH₂, —SO₂, —COOH, R^{43c}-substituted or unsubstituted C₁-C₁₀ alkyl (e.g., R^{43c}-substituted or unsubstituted saturated C₁-C₁₀ alkyl), R^{43c}-substituted or unsubstituted 2 to 10 membered heteroalkyl, R^{43c}-substituted or unsubstituted C₃-C₈ cycloalkyl, R^{43c}-substituted or unsubstituted 3 to 8 membered heterocycloalkyl, R^{43c}-substituted or unsubstituted C₅-C₁₀ aryl, or R^{43c}-substituted or unsubstituted 5 to 10 membered heteroaryl. In some embodiments, R^{42c} is R^{43c}-substituted or unsubstituted C₁-C₁₀ alkyl (e.g., R^{43c}-substituted or unsubstituted saturated C₁-C₁₀ alkyl), R^{43c}-substituted or unsubstituted C₃-C₈ cycloalkyl or R^{43c}-substituted or unsubstituted aryl. In some embodiments, R^{42c} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{42c} is unsubstituted C₁-C₁₀ alkyl (e.g., unsubstituted C₁ to C₁₀ saturated alkyl). In some embodiments, R^{42c} is unsubstituted C₁-C₄ alkyl (e.g., unsubstituted C₁ to C₄ saturated alkyl). In some embodiments, R^{42c} is unsubstituted C₃-C₈ cycloalkyl. In some embodiments, R^{42c} is unsubstituted aryl (e.g., phenyl). In some embodiments, R^{42c} is unsubstituted C₁-C₁₀ alkyl (e.g., unsubstituted C₁ to C₁₀ saturated alkyl). In some embodiments, R^{42c} is unsubstituted C₁-C₄ alkyl (e.g., unsubstituted C₁ to C₄ saturated alkyl). In some embodiments, R^{42c} is unsubstituted C₃-C₈ cycloalkyl. In some embodiments, R^{42c} is unsubstituted aryl (e.g., phenyl).

In some embodiments of the compounds provided herein, R⁹ is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{44c}-substituted or unsubstituted C₁-C₁₀ alkyl, R^{44c}-substituted or unsubstituted 2 to 10 membered heteroalkyl, R^{44c}-substituted or unsubstituted cycloalkyl, R^{44c}-substituted or unsubstituted heterocycloalkyl, R^{44c}-substituted or unsubstituted aryl, or R^{44c}-substituted or unsubstituted heteroaryl. In some embodiments of the compounds provided herein, R^{9C} is R^{44c}-substituted or unsubstituted C₁-C₁₀ alkyl, R^{44c}-substituted or unsubstituted 2 to 10 membered heteroalkyl, R^{44c}-substituted or unsubstituted C₃-C₈ cycloalkyl, R^{44c}-substituted or unsubstituted 3 to 8 membered heterocycloalkyl, R^{44c}-substituted or unsubstituted C₅-C₁₀ aryl, or R^{44c}-substituted or unsubstituted 5 to 10 membered heteroaryl. In some embodiments of the compounds provided herein, R^{9C} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{9C} is R^{44c}-substituted or unsubstituted C₁-C₁₀ saturated alkyl. In some embodiments of the compounds provided herein, R^{9C} is R^{44c}-substituted or unsubstituted C₁-C₆ alkyl. In some embodiments of the compounds provided herein, R^{9C} is R^{44c}-substituted or unsubstituted C₁-C₆ saturated alkyl. In some embodiments of the compounds provided herein, R⁹ is R^{44c}-substituted or unsubstituted C₁-C₄ alkyl. In some embodiments of the compounds provided herein, R⁹⁰ is R^{44c}-substituted or unsubstituted C₁-C₄ saturated alkyl. In some embodiments of the compounds provided herein, R⁹ is unsubstituted C₁-C₄ saturated alkyl. In some embodiments, R^{9C} is R^{44c}-substituted or unsubstituted C₁-C₁₀ alkyl (e.g., R^{44c}-substituted or unsubstituted C₁-C₁₀ saturated alkyl), R^{44c}-substituted or unsubstituted C₃-C₈ cycloalkyl, or R^{44c}-substituted or unsubstituted aryl. In some embodiments, R^{9C} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{9C} is unsubstituted C₁-C₁₀ alkyl (e.g., unsubstituted C₁-C₁₀ saturated alkyl), or unsubstituted aryl (e.g., phenyl). In some embodiments, R^{9c} is unsubstituted C₁-C₅ alkyl (e.g., unsubstituted C₁-C₅ saturated alkyl), or unsubstituted aryl (e.g., phenyl).

R^{44c} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{45c}-substituted or unsubstituted alkyl (e.g. R^{45c}-substituted or unsubstituted saturated alkyl), R^{45c}-substituted or unsubstituted heteroalkyl, R^{45c}-substituted or unsubstituted cycloalkyl, R^{45c}-substituted or unsubstituted heterocycloalkyl, R^{45c}-substituted or unsubstituted aryl, or R^{45c}-substituted or unsubstituted heteroaryl. In some embodiments, R^{44c} is halogen, —CN, —CF₃, —OH, —NO₂, —C(O)NH₂, —SH, —NH₂, —SO₂, —COOH, R^{c}-substituted or unsubstituted C₁-C₁₀ alkyl (e.g., R^{45c}-substituted or unsubstituted saturated C₁-C₁₀ alkyl), R^{45c}-substituted or unsubstituted 2 to 10 membered heteroalkyl, R^{45c}-substituted or unsubstituted C₃-C₈ cycloalkyl, R^{45c}-substituted or unsubstituted 3 to 8 membered heterocycloalkyl, R^{45c}-substituted or unsubstituted C₅-C₁₀ aryl, or R^{45c}-substituted or unsubstituted 5 to 10 membered heteroaryl. In some embodiments, R^{44c} is R^{45c}-substituted or unsubstituted C₁-C₁₀ alkyl (e.g., R^{45c}-substituted or unsubstituted saturated C₁-C₁₀ alkyl), R^{45c}-substituted or unsubstituted C₃-C₈ cycloalkyl, or R^{45c}-substituted or unsubstituted aryl. In some embodiments, R^{44c} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{44c} is unsubstituted C₁-C₁₀ alkyl (e.g., unsubstituted C₁ to C₁₀ saturated alkyl). In some embodiments, R^{44c} is unsubstituted C₁-C₄ alkyl (e.g., unsubstituted C₁ to C₄ saturated alkyl). In some embodiments, R^{44c} is unsubstituted C₃-C₈ cycloalkyl. In some embodiments, R^{44c} is unsubstituted aryl (e.g., phenyl).

R^{45c} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{46c}-substituted or unsubstituted alkyl (e.g., R^{46c}-substituted or unsubstituted saturated alkyl), R^{46c}-substituted or unsubstituted heteroalkyl, R^{46c}-substituted or unsubstituted cycloalkyl, R^{46c}-substituted or unsubstituted heterocycloalkyl, R^{46c}-substituted or unsubstituted aryl, or R^{46c}-substituted or unsubstituted heteroaryl. In some embodiments, R^{45c} is halogen, —CN, —CF₃, —OH, —NO₂, —C(O)NH₂, —SH, —NH₂, —SO₂, —COOH, R^{46c}-substituted or unsubstituted C₁-C₁₀ alkyl (e.g., R^{46c}-substituted or unsubstituted saturated C₁-C₁₀ alkyl), R^{46c}-substituted or unsubstituted 2 to 10 membered heteroalkyl, R^{46c}-substituted or unsubstituted C₃-C₈ cycloalkyl, R^{46c}-substituted or unsubstituted 3 to 8 membered heterocycloalkyl, R^{46c}-substituted or unsubstituted C₅-C₁₀ aryl, or R^{46c}-substituted or unsubstituted 5 to 10 membered heteroaryl. In some embodiments, R^{45c} is R^{46c}-substituted or unsubstituted C₁-C₁₀ alkyl (e.g., R^{46c}-substituted or unsubstituted saturated C₁-C₁₀ alkyl), R^{46c}-substituted or unsubstituted C₃-C₈ cycloalkyl or R^{46c}-substituted or unsubstituted aryl. In some embodiments, R^{45c} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{45c} is unsubstituted C₁-C₁₀ alkyl (e.g., unsubstituted C₁ to C₁₀ saturated alkyl). In some embodiments, R^{45c} is unsubstituted C₁-C₄ alkyl (e.g., unsubstituted C₁ to C₄ saturated alkyl). In some embodiments, R^{45c} is unsubstituted C₃-C₈ cycloalkyl. In some embodiments, R^{45c} is unsubstituted aryl (e.g., phenyl). In some embodiments, R^{45c} is unsubstituted C₁-C₁₀ alkyl (e.g., unsubstituted C₁ to C₁₀ saturated alkyl). In some embodiments, R^{45c} is unsubstituted C₁-C₄ alkyl (e.g., unsubstituted C₁ to C₄ saturated alkyl). In some embodiments, R^{45c} is unsubstituted C₃-C₈ cycloalkyl. In some embodiments, R^{45c} is unsubstituted aryl (e.g., phenyl).

In some embodiments of the compounds provided herein, R^{10c} is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{47c}-substituted or unsubstituted C₁-C₁₀ alkyl, R^{47c}-substituted or unsubstituted 2 to 10 membered heteroalkyl, R^{47c}-substituted or unsubstituted cycloalkyl, R^{47c}-substituted or unsubstituted heterocycloalkyl, R^{47c}-substituted or unsubstituted aryl, or R^{47c}-substituted or unsubstituted heteroaryl. In some embodiments of the compounds provided herein, R^{10c} is R^{47c}-substituted or unsubstituted C₁-C₁₀ alkyl, R^{47c}-substituted or unsubstituted 2 to 10 membered heteroalkyl, R^{47c}-substituted or unsubstituted C₃-C₈ cycloalkyl, R^{47c}-substituted or unsubstituted 3 to 8 membered heterocycloalkyl, R^{47c}-substituted or unsubstituted C₅-C₁₀ aryl, or R^{47c}-substituted or unsubstituted 5 to 10 membered heteroaryl. In some embodiments of the compounds provided herein, R^{10c} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{10c} is R^{47c}-substituted or unsubstituted C₁-C₁₀ saturated alkyl. In some embodiments of the compounds provided herein, R^{10c} is R^{47c}-substituted or unsubstituted C₁-C₈ alkyl. In some embodiments of the compounds provided herein, R^{10c} is R^{47c}-substituted or unsubstituted C₁-C₆ saturated alkyl. In some embodiments of the compounds provided herein, R^{10c} is R^{47c}-substituted or unsubstituted C₁-C₄ alkyl. In some embodiments of the compounds provided herein, R^{10c} is R^{47c}-substituted or unsubstituted C₁-C₄ saturated alkyl. In some embodiments of the compounds provided herein, R^{10c} is unsubstituted C₁-C₄ saturated alkyl. In some embodiments, R^{10c} is R^{47c}-substituted or unsubstituted C₁-C₁₀ alkyl (e.g., R^{47c}-substituted or unsubstituted C₁-C₁₀ saturated alkyl), R^{47c}-substituted or unsubstituted C₃-C₈ cycloalkyl, or R^{47c}-substituted or unsubstituted aryl. In some embodiments, R^{10c} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{10c} is unsubstituted C₁-C₁₀ alkyl (e.g., unsubstituted C₁-C₁₀ saturated alkyl), or unsubstituted aryl (e.g., phenyl). In some embodiments, R^{10c} is unsubstituted C₁-C₅ alkyl (e.g., unsubstituted C₁-C₅ saturated alkyl), or unsubstituted aryl (e.g., phenyl). In some embodiments, R^{10c} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{10c} is unsubstituted C₁-C₁₀ alkyl (e.g., unsubstituted C₁ to C₁₀ saturated alkyl). In some embodiments, R^{10c} is unsubstituted C₁-C₄ alkyl (e.g., unsubstituted C₁ to C₄ saturated alkyl). In some embodiments, Roc is unsubstituted C₃-C₈ cycloalkyl. In some embodiments, R^{10c} is unsubstituted aryl (e.g., phenyl). In some embodiments, R^{10c} is unsubstituted C₁-C₁₀ alkyl (e.g., unsubstituted C₁ to C₁₀ saturated alkyl). In some embodiments, R^{10c} is unsubstituted C₁-C₄ alkyl (e.g., unsubstituted C₁ to C₄ saturated alkyl). In some embodiments, R^{10c} is unsubstituted C₃-C₈ cycloalkyl. In some embodiments, R^{10c} is unsubstituted aryl (e.g., phenyl).

R^{47c} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{48c}-substituted or unsubstituted alkyl (e.g. R^{48c}-substituted or unsubstituted saturated alkyl), R^{48c}-substituted or unsubstituted heteroalkyl, R^{48c}-substituted or unsubstituted cycloalkyl, R^{48c}-substituted or unsubstituted heterocycloalkyl, R^{48c}-substituted or unsubstituted aryl, or R^{48c}-substituted or unsubstituted heteroaryl. In some embodiments, R^{47c} is halogen, —CN, —CF₃, —OH, —NO₂, —C(O)NH₂, —SH, —NH₂, —SO₂, —COOH, R^{48c}-substituted or unsubstituted C₁-C₁₀ alkyl (e.g., R^{48c}-substituted or unsubstituted saturated C₁-C₁₀ alkyl), R^{48c}-substituted or unsubstituted 2 to 10 membered heteroalkyl, R^{48c}-substituted or unsubstituted C₃-C₈ cycloalkyl, R^{48c}-substituted or unsubstituted 3 to 8 membered heterocycloalkyl, R^{48c}-substituted or unsubstituted C₅-C₁₀ aryl, or R^{48c}-substituted or unsubstituted 5 to 10 membered heteroaryl. In some embodiments, R^{47c} is R^{48c}-substituted or unsubstituted C₁-C₁₀ alkyl (e.g., R^{48c}-substituted or unsubstituted saturated C₁-C₁₀ alkyl), R^{48c}-substituted or unsubstituted C₃-C₈ cycloalkyl, or R^{48c}-substituted or unsubstituted aryl. In some embodiments, R^{47c} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{47c} is unsubstituted C₁-C₁₀ alkyl (e.g., unsubstituted C₁ to C₁₀ saturated alkyl). In some embodiments, R^{47c} is unsubstituted C₁-C₄ alkyl (e.g., unsubstituted C₁ to C₄ saturated alkyl). In some embodiments, R^{47c} is unsubstituted C₃-C₈ cycloalkyl. In some embodiments, R^{47c} is unsubstituted aryl (e.g., phenyl).

R^{48c} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{49c}-substituted or unsubstituted alkyl (e.g., R^{49c}-substituted or unsubstituted saturated alkyl), R^{49c}-substituted or unsubstituted heteroalkyl, R^{49c}-substituted or unsubstituted cycloalkyl, R^{49c}-substituted or unsubstituted heterocycloalkyl, R^{49c}-substituted or unsubstituted aryl, or R^{49c}-substituted or unsubstituted heteroaryl. In some embodiments, R^{48c} is halogen, —CN, —CF₃, —OH, —NO₂, —C(O)NH₂, —SH, —NH₂, —SO₂, —COOH, R^{49c}-substituted or unsubstituted C₁-C₁₀ alkyl (e.g., R^{49c}-substituted or unsubstituted saturated C₁-C₁₀ alkyl), R^{49c}-substituted or unsubstituted 2 to 10 membered heteroalkyl, R^{49c}-substituted or unsubstituted C₃-C₈ cycloalkyl, R^{49c}-substituted or unsubstituted 3 to 8 membered heterocycloalkyl, R^{49c}-substituted or unsubstituted C₅-C₁₀ aryl, or R^{49c}-substituted or unsubstituted 5 to 10 membered heteroaryl. In some embodiments, R^{48c} is R^{49c}-substituted or unsubstituted C₁-C₁₀ alkyl (e.g., R^{49c}-substituted or unsubstituted saturated C₁-C₁₀ alkyl), R^{49c}-substituted or unsubstituted C₃-C₈ cycloalkyl or R^{49c}-substituted or unsubstituted aryl. In some embodiments, R^{48c} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{48c} is unsubstituted C₁-C₁₀ alkyl (e.g., unsubstituted C₁ to C₁₀ saturated alkyl). In some embodiments, R^{48c} is unsubstituted C₁-C₄ alkyl (e.g., unsubstituted C₁ to C₄ saturated alkyl). In some embodiments, R^{48c} is unsubstituted C₃-C₈ cycloalkyl. In some embodiments, R^{48c} is unsubstituted aryl (e.g., phenyl). In some embodiments, R^{48c} is unsubstituted C₁-C₁₀ alkyl (e.g., unsubstituted C₁ to C₁₀ saturated alkyl). In some embodiments, R^{48c} is unsubstituted C₁-C₄ alkyl (e.g., unsubstituted C₁ to C₄ saturated alkyl). In some embodiments, R^{48c} is unsubstituted C₃-C₈ cycloalkyl. In some embodiments, R^{48c} is unsubstituted aryl (e.g., phenyl).

In some embodiments of the compounds provided herein, R^{8d} is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{41d}-substituted or unsubstituted C₁-C₁₀ alkyl, R^{41d}-substituted or unsubstituted 2 to 10 membered heteroalkyl, R^{41d}-substituted or unsubstituted cycloalkyl, R^{41d}-substituted or unsubstituted heterocycloalkyl, R^{41d}-substituted or unsubstituted aryl, or R^{41d}-substituted or unsubstituted heteroaryl. In some embodiments of the compounds provided herein, R^{8d} is R^{41d}-substituted or unsubstituted C₁-C₁₀ alkyl, R^{41d}-substituted or unsubstituted 2 to 10 membered heteroalkyl, R^{41d}-substituted or unsubstituted C₃-C₈ cycloalkyl, R^{41d}-substituted or unsubstituted 3 to 8 membered heterocycloalkyl, R^{41d}-substituted or unsubstituted C₅-C₁₀ aryl, or R^{41d}-substituted or unsubstituted 5 to 10 membered heteroaryl. In some embodiments of the compounds provided herein, R^{8d} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{8d} is R^{41d}-substituted or unsubstituted C₁-C₁₀ saturated alkyl. In some embodiments of the compounds provided herein, R^{8d} is R^{41d}-substituted or unsubstituted C₁-C₆ alkyl. In some embodiments of the compounds provided herein, R^{8d} is R^{41d}-substituted or unsubstituted C₁-C₆ saturated alkyl. In some embodiments of the compounds provided herein, R^{8d} is R^{41d}-substituted or unsubstituted C₁-C₄ alkyl. In some embodiments of the compounds provided herein, R^{8d} is R^{41d}-substituted or unsubstituted C₁-C₄ saturated alkyl. In some embodiments of the compounds provided herein, R^{8d} is unsubstituted C₁-C₄ saturated alkyl. In some embodiments, R^{8d} is R^{41d}-substituted or unsubstituted C₁-C₁₀ alkyl (e.g., R^{41d}-substituted or unsubstituted C₁-C₁₀ saturated alkyl), R^{41d}-substituted or unsubstituted C₃-C₈ cycloalkyl, or R^{41d}-substituted or unsubstituted aryl. In some embodiments, R^{8d} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{8d} is unsubstituted C₁-C₁₀ alkyl (e.g., unsubstituted C₁-C₁₀ saturated alkyl), or unsubstituted aryl (e.g., phenyl). In some embodiments, R^{8d} is unsubstituted C₁-C₅ alkyl (e.g., unsubstituted C₁-C₅ saturated alkyl), or unsubstituted aryl (e.g., phenyl).

R^{41d} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{42d}-substituted or unsubstituted alkyl (e.g. R^{42d}-substituted or unsubstituted saturated alkyl), R^{42d}-substituted or unsubstituted heteroalkyl, R^{42d}-substituted or unsubstituted cycloalkyl, R^{42d}-substituted or unsubstituted heterocycloalkyl, R^{42d}-substituted or unsubstituted aryl, or R^{42d}-substituted or unsubstituted heteroaryl. In some embodiments, R^{41d} is halogen, —CN, —CF₃, —OH, —NO₂, —C(O)NH₂, —SH, —NH₂, —SO₂, —COOH, R^{42d}-substituted or unsubstituted C₁-C₁₀ alkyl (e.g., R^{42d}-substituted or unsubstituted saturated C₁-C₁₀ alkyl), R^{42d}-substituted or unsubstituted 2 to 10 membered heteroalkyl, R^{42d}-substituted or unsubstituted C₃-C₈ cycloalkyl, R^{42d}-substituted or unsubstituted 3 to 8 membered heterocycloalkyl, R^{42d}-substituted or unsubstituted C₅-C₁₀ aryl, or R^{42d}-substituted or unsubstituted 5 to 10 membered heteroaryl. In some embodiments, R^{41d} is R^{42d}-substituted or unsubstituted C₁-C₁₀ alkyl (e.g., R^{42d}-substituted or unsubstituted saturated C₁-C₁₀ alkyl), R^{42d}-substituted or unsubstituted C₃-C₈ cycloalkyl, or R^{42d}-substituted or unsubstituted aryl. In some embodiments, R^{41d} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{41d} is unsubstituted C₁-C₁₀ alkyl (e.g., unsubstituted C₁ to C₁₀ saturated alkyl). In some embodiments, R^{41d} is unsubstituted C₁-C₄ alkyl (e.g., unsubstituted C₁ to C₄ saturated alkyl). In some embodiments, R^{41d} is unsubstituted C₃-C₈ cycloalkyl. In some embodiments, R^{41d} is unsubstituted aryl (e.g., phenyl).

R^{42d} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{43d}-substituted or unsubstituted alkyl (e.g., R^{43d}-substituted or unsubstituted saturated alkyl), R^{43d}-substituted or unsubstituted heteroalkyl, R^{43d}-substituted or unsubstituted cycloalkyl, R^{43d}-substituted or unsubstituted heterocycloalkyl, R^{43d}-substituted or unsubstituted aryl, or R^{43d}-substituted or unsubstituted heteroaryl. In some embodiments, R^{42d} is halogen, —CN, —CF₃, —OH, —NO₂, —C(O)NH₂, —SH, —NH₂, —SO₂, —COOH, R^{43d}-substituted or unsubstituted C₁-C₁₀ alkyl (e.g., R^{43d}-substituted or unsubstituted saturated C₁-C₁₀ alkyl), R^{43d}-substituted or unsubstituted 2 to 10 membered heteroalkyl, R^{43d}-substituted or unsubstituted C₃-C₈ cycloalkyl, R^{d}-substituted or unsubstituted 3 to 8 membered heterocycloalkyl, R^{43d}-substituted or unsubstituted C₅-C₁₀ aryl, or R^{d}-substituted or unsubstituted 5 to 10 membered heteroaryl. In some embodiments, R^{42d} is R^{43d}-substituted or unsubstituted C₁-C₁₀ alkyl (e.g., R^{43d}-substituted or unsubstituted saturated C₁-C₁₀ alkyl), R^{43d}-substituted or unsubstituted C₃-C₈ cycloalkyl or R^{43d}-substituted or unsubstituted aryl. In some embodiments, R^{42d} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{42d} is unsubstituted C₁-C₁₀ alkyl (e.g., unsubstituted C₁ to C₁₀ saturated alkyl). In some embodiments, R^{42d} is unsubstituted C₁-C₄ alkyl (e.g., unsubstituted C₁ to C₄ saturated alkyl). In some embodiments, R^{42d} is unsubstituted C₃-C₈ cycloalkyl. In some embodiments, R^{42d} is unsubstituted aryl (e.g., phenyl). In some embodiments, R^{42d} is unsubstituted C₁-C₁₀ alkyl (e.g., unsubstituted C₁ to C₁₀ saturated alkyl). In some embodiments, R^{42d} is unsubstituted C₁-C₄ alkyl (e.g., unsubstituted C₁ to C₄ saturated alkyl). In some embodiments, R^{42d} is unsubstituted C₃-C₈ cycloalkyl. In some embodiments, R^{42d} is unsubstituted aryl (e.g., phenyl).

In some embodiments of the compounds provided herein, R^{9d} is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{44d}-substituted or unsubstituted C₁-C₁₀ alkyl, R^{44d}-substituted or unsubstituted 2 to 10 membered heteroalkyl, R^{44d}-substituted or unsubstituted cycloalkyl, R^{44d}-substituted or unsubstituted heterocycloalkyl, R^{44d}-substituted or unsubstituted aryl, or R^{44d}-substituted or unsubstituted heteroaryl. In some embodiments of the compounds provided herein, R^{9d} is R^{44d}-substituted or unsubstituted C₁-C₁₀ alkyl, R^{44d}-substituted or unsubstituted 2 to 10 membered heteroalkyl, R^{44d}-substituted or unsubstituted C₃-C₈ cycloalkyl, R^{44d}-substituted or unsubstituted 3 to 8 membered heterocycloalkyl, R^{44d}-substituted or unsubstituted C₅-C₁₀ aryl, or R^{44d}-substituted or unsubstituted 5 to 10 membered heteroaryl. In some embodiments of the compounds provided herein, R^{9d} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{9d} is R^{44d}-substituted or unsubstituted C₁-C₁₀ saturated alkyl. In some embodiments of the compounds provided herein, R^{9d} is R^{44d}-substituted or unsubstituted C₁-C₆ alkyl. In some embodiments of the compounds provided herein, R^{9d} is R^{44d}-substituted or unsubstituted C₁-C₆ saturated alkyl. In some embodiments of the compounds provided herein, R^{9d} is R^{44d}-substituted or unsubstituted C₁-C₄ alkyl. In some embodiments of the compounds provided herein, R^{9d} is R^{44d}-substituted or unsubstituted C₁-C₄ saturated alkyl. In some embodiments of the compounds provided herein, R^{9d} is unsubstituted C₁-C₄ saturated alkyl. In some embodiments, R^{9d} is R^{44d}-substituted or unsubstituted C₁-C₁₀ alkyl (e.g., R^{44d}-substituted or unsubstituted C₁-C₁₀ saturated alkyl), R^{44d}-substituted or unsubstituted C₃-C₈ cycloalkyl, or R^{44d}-substituted or unsubstituted aryl. In some embodiments, R^{9d} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{9d} is unsubstituted C₁-C₁₀ alkyl (e.g., unsubstituted C₁-C₁₀ saturated alkyl), or unsubstituted aryl (e.g., phenyl). In some embodiments, R^{9d} is unsubstituted C₁-C₅ alkyl (e.g., unsubstituted C₁-C₅ saturated alkyl), or unsubstituted aryl (e.g., phenyl).

R^{44d} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{45d}-substituted or unsubstituted alkyl (e.g. R^{45d}-substituted or unsubstituted saturated alkyl), R^{45d}-substituted or unsubstituted heteroalkyl, R^{45d}-substituted or unsubstituted cycloalkyl, R^{45d}-substituted or unsubstituted heterocycloalkyl, R^{45d}-substituted or unsubstituted aryl, or R^{45d}-substituted or unsubstituted heteroaryl. In some embodiments, R^{44d} is halogen, —CN, —CF₃, —OH, —NO₂, —C(O)NH₂, —SH, —NH₂, —SO₂, —COOH, R^{d}-substituted or unsubstituted C₁-C₁₀ alkyl (e.g., R^{45d}-substituted or unsubstituted saturated C₁-C₁₀ alkyl), R^{45d}-substituted or unsubstituted 2 to 10 membered heteroalkyl, R^{45d}-substituted or unsubstituted C₃-C₈ cycloalkyl, R^{45d}-substituted or unsubstituted 3 to 8 membered heterocycloalkyl, R^{45d}-substituted or unsubstituted C₅-C₁₀ aryl, or R^{d}-substituted or unsubstituted 5 to 10 membered heteroaryl. In some embodiments, R^{44d} is R^{45d}-substituted or unsubstituted C₁-C₁₀ alkyl (e.g., R^{45d}-substituted or unsubstituted saturated C₁-C₁₀ alkyl), R^{45d}-substituted or unsubstituted C₃-C₈ cycloalkyl, or R^{45d}-substituted or unsubstituted aryl. In some embodiments, R^{44d} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{44d} is unsubstituted C₁-C₁₀ alkyl (e.g., unsubstituted C₁ to C₁₀ saturated alkyl). In some embodiments, R^{44d} is unsubstituted C₁-C₄ alkyl (e.g., unsubstituted C₁ to C₄ saturated alkyl). In some embodiments, R^{44d} is unsubstituted C₃-C₈ cycloalkyl. In some embodiments, R^{44d} is unsubstituted aryl (e.g., phenyl).

R^{45d} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{46d}-substituted or unsubstituted alkyl (e.g., R^{46d}-substituted or unsubstituted saturated alkyl), R^{46d}-substituted or unsubstituted heteroalkyl, R^{46d}-substituted or unsubstituted cycloalkyl, R^{46d}-substituted or unsubstituted heterocycloalkyl, R^{46d}-substituted or unsubstituted aryl, or R^{46d}-substituted or unsubstituted heteroaryl. In some embodiments, R^{45d} is halogen, —CN, —CF₃, —OH, —NO₂, —C(O)NH₂, —SH, —NH₂, —SO₂, —COOH, R^{46d}-substituted or unsubstituted C₁-C₁₀ alkyl (e.g., R^{46d}-substituted or unsubstituted saturated C₁-C₁₀ alkyl), R^{46d}-substituted or unsubstituted 2 to 10 membered heteroalkyl, R^{46d}-substituted or unsubstituted C₃-C₈ cycloalkyl, R^{46d}-substituted or unsubstituted 3 to 8 membered heterocycloalkyl, R^{46d}-substituted or unsubstituted C₅-C₁₀ aryl, or R^{46d}-substituted or unsubstituted 5 to 10 membered heteroaryl. In some embodiments, R^{45d} is R^{46d}-substituted or unsubstituted C₁-C₁₀ alkyl (e.g., R^{46d}-substituted or unsubstituted saturated C₁-C₁₀ alkyl), R^{46d}-substituted or unsubstituted C₃-C₈ cycloalkyl or R^{46d}-substituted or unsubstituted aryl. In some embodiments, R^{45d} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{45d} is unsubstituted C₁-C₁₀ alkyl (e.g., unsubstituted C₁ to C₁₀ saturated alkyl). In some embodiments, R^{45d} is unsubstituted C₁-C₄ alkyl (e.g., unsubstituted C₁ to C₄ saturated alkyl). In some embodiments, R^{45d} is unsubstituted C₃-C₈ cycloalkyl. In some embodiments, R^{45d} is unsubstituted aryl (e.g., phenyl). In some embodiments, R^{45d} is unsubstituted C₁-C₁₀ alkyl (e.g., unsubstituted C₁ to C₁₀ saturated alkyl). In some embodiments, R^{45d} is unsubstituted C₁-C₄ alkyl (e.g., unsubstituted C₁ to C₄ saturated alkyl). In some embodiments, R^{45d} is unsubstituted C₃-C₈ cycloalkyl. In some embodiments, R^{45d} is unsubstituted aryl (e.g., phenyl).

In some embodiments of the compounds provided herein, R^{10d} is hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{47d}-substituted or unsubstituted C₁-C₁₀ alkyl, R^{47d}-substituted or unsubstituted 2 to 10 membered heteroalkyl, R^{47d}-substituted or unsubstituted cycloalkyl, R^{47d}-substituted or unsubstituted heterocycloalkyl, R^{47d}-substituted or unsubstituted aryl, or R^{47d}-substituted or unsubstituted heteroaryl. In some embodiments of the compounds provided herein, R^{10c} is R^{47d}-substituted or unsubstituted C₁-C₁₀ alkyl, R^{47d}-substituted or unsubstituted 2 to 10 membered heteroalkyl, R^{47d}-substituted or unsubstituted C₃-C₈ cycloalkyl, R^{47d}-substituted or unsubstituted 3 to 8 membered heterocycloalkyl, R^{47d}-substituted or unsubstituted C₅-C₁₀ aryl, or R^{47d}-substituted or unsubstituted 5 to 10 membered heteroaryl. In some embodiments of the compounds provided herein, R^{10d} is unsubstituted C₁-C₁₀ alkyl, unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments of the compounds provided herein, R^{10d} is R^{47d}-substituted or unsubstituted C₁-C₁₀ saturated alkyl. In some embodiments of the compounds provided herein, R^{10d} is R^{47d}-substituted or unsubstituted C₁-C₆ alkyl. In some embodiments of the compounds provided herein, R^{10d} is R^{47d}-substituted or unsubstituted C₁-C₆ saturated alkyl. In some embodiments of the compounds provided herein, R^{10d} is R^{47d}-substituted or unsubstituted C₁-C₄ alkyl. In some embodiments of the compounds provided herein, R^{10d} is R^{47d}-substituted or unsubstituted C₁-C₄ saturated alkyl. In some embodiments of the compounds provided herein, R^{10d} is unsubstituted C₁-C₄ saturated alkyl. In some embodiments, R^{10d} is R^{47d}-substituted or unsubstituted C₁-C₁₀ alkyl (e.g., R^{47d}-substituted or unsubstituted C₁-C₁₀ saturated alkyl), R^{47d}-substituted or unsubstituted C₃-C₈ cycloalkyl, or R^{47d}-substituted or unsubstituted aryl. In some embodiments, R^{10d} is unsubstituted C₁-C₁₀ alkyl (e.g., unsubstituted C₁-C₁₀ saturated alkyl), unsubstituted C₃-C₈ cycloalkyl, or unsubstituted aryl (e.g., phenyl). In some embodiments, R^{10c} is unsubstituted C₁-C₁₀ alkyl (e.g., unsubstituted C₁-C₁₀ saturated alkyl), or unsubstituted aryl (e.g., phenyl). In some embodiments, R^{10c} is unsubstituted C₁-C₅ alkyl (e.g., unsubstituted C₁-C₅ saturated alkyl), or unsubstituted aryl (e.g., phenyl). In some embodiments, R^{10d} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{10d} is unsubstituted C₁-C₁₀ alkyl (e.g., unsubstituted C₁ to C₁₀ saturated alkyl). In some embodiments, R^{10c} is unsubstituted C₁-C₄ alkyl (e.g., unsubstituted C₁ to C₄ saturated alkyl). In some embodiments, Roc is unsubstituted C₃-C₈ cycloalkyl. In some embodiments, R^{10c} is unsubstituted aryl (e.g., phenyl). In some embodiments, R^{10d} is unsubstituted C₁-C₁₀ alkyl (e.g., unsubstituted C₁ to C₁₀ saturated alkyl). In some embodiments, R^{10d} is unsubstituted C₁-C₄ alkyl (e.g., unsubstituted C₁ to C₄ saturated alkyl). In some embodiments, R^{am} is unsubstituted C₃-C₈ cycloalkyl. In some embodiments, R^{10d} is unsubstituted aryl (e.g., phenyl).

R^{47d} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{48d}-substituted or unsubstituted alkyl (e.g. R^{48d}-substituted or unsubstituted saturated alkyl), R^{48d}-substituted or unsubstituted heteroalkyl, R^{48d}-substituted or unsubstituted cycloalkyl, R^{48d}-substituted or unsubstituted heterocycloalkyl, R^{48d}-substituted or unsubstituted aryl, or R^{48d}-substituted or unsubstituted heteroaryl. In some embodiments, R^{47d} is halogen, —CN, —CF₃, —OH, —NO₂, —C(O)NH₂, —SH, —NH₂, —SO₂, —COOH, R^{48d}-substituted or unsubstituted C₁-C₁₀ alkyl (e.g., R^{48d}-substituted or unsubstituted saturated C₁-C₁₀ alkyl), R^{48d}-substituted or unsubstituted 2 to 10 membered heteroalkyl, R^{48d}-substituted or unsubstituted C₃-C₈ cycloalkyl, R^{48d}-substituted or unsubstituted 3 to 8 membered heterocycloalkyl, R^{48d}-substituted or unsubstituted C₅-C₁₀ aryl, or R^{48d}-substituted or unsubstituted 5 to 10 membered heteroaryl. In some embodiments, R^{47d} is R^{48d}-substituted or unsubstituted C₁-C₁₀ alkyl (e.g., R^{48d}-substituted or unsubstituted saturated C₁-C₁₀ alkyl), R^{48d}-substituted or unsubstituted C₃-C₈ cycloalkyl, or R^{48d}-substituted or unsubstituted aryl. In some embodiments, R^{47d} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{47d} is unsubstituted C₁-C₁₀ alkyl (e.g., unsubstituted C₁ to C₁₀ saturated alkyl). In some embodiments, R^{47d} is unsubstituted C₁-C₄ alkyl (e.g., unsubstituted C₁ to C₄ saturated alkyl). In some embodiments, R^{47d} is unsubstituted C₃-C₈ cycloalkyl. In some embodiments, R^{47d} is unsubstituted aryl (e.g., phenyl).

R^{48d} is independently halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, R^{49d}-substituted or unsubstituted alkyl (e.g., R^{49d}-substituted or unsubstituted saturated alkyl), R^{49d}-substituted or unsubstituted heteroalkyl, R^{d}-substituted or unsubstituted cycloalkyl, R^{49d}-substituted or unsubstituted heterocycloalkyl, R^{49d}-substituted or unsubstituted aryl, or R^{49d}-substituted or unsubstituted heteroaryl. In some embodiments, R^{48d} is halogen, —CN, —CF₃, —OH, —NO₂, —C(O)NH₂, —SH, —NH₂, —SO₂, —COOH, R^{d}-substituted or unsubstituted C₁-C₁₀ alkyl (e.g., R^{49d}-substituted or unsubstituted saturated C₁-C₁₀ alkyl), R^{49d}-substituted or unsubstituted 2 to 10 membered heteroalkyl, R^{49d}-substituted or unsubstituted C₃-C₈ cycloalkyl, R^{49d}-substituted or unsubstituted 3 to 8 membered heterocycloalkyl, R^{49d}-substituted or unsubstituted C₅-C₁₀ aryl, or R^{49d}-substituted or unsubstituted 5 to 10 membered heteroaryl. In some embodiments, R^{48d} is R^{49d}-substituted or unsubstituted C₁-C₁₀ alkyl (e.g., R^{49d}-substituted or unsubstituted saturated C₁-C₁₀ alkyl), R^{49d}-substituted or unsubstituted C₃-C₈ cycloalkyl or R^{49d}-substituted or unsubstituted aryl. In some embodiments, R^{48d} is unsubstituted C₁-C₁₀ alkyl (e.g., unsubstituted C₁-C₁₀ saturated alkyl), unsubstituted C₃-C₈ cycloalkyl, or unsubstituted aryl. In some embodiments, R^{48d} is unsubstituted C₁-C₁₀ alkyl (e.g., unsubstituted C₁ to C₁₀ saturated alkyl). In some embodiments, R^{48d} is unsubstituted C₁-C₄ alkyl (e.g., unsubstituted C₁ to C₄ saturated alkyl). In some embodiments, R^{48d} is unsubstituted C₃-C₈ cycloalkyl. In some embodiments, R^{48d} is unsubstituted aryl (e.g., phenyl). In some embodiments, R^{48d} is unsubstituted C₁-C₁₀ alkyl (e.g., unsubstituted C₁ to C₁₀ saturated alkyl). In some embodiments, R^{48d} is unsubstituted C₁-C₄ alkyl (e.g., unsubstituted C₁ to C₄ saturated alkyl). In some embodiments, R^{48d} is unsubstituted C₃-C₈ cycloalkyl. In some embodiments, R^{48d} is unsubstituted aryl (e.g., phenyl).

R²², R²⁵, R²⁸, R³¹, R³⁴, R³⁷, R⁴⁰, R^{43a}, R^{46a}, R^{49a}, R^{43b}, R^{46b}, R^{49b}, R^{43c}, R^{46c}, R^{49c}, R^{43d}, R^{46d}, and R^{49d} are independently hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, NHC═(O)NHNH₂, unsubstituted alkyl (e.g., unsubstituted saturated alkyl), unsubstituted heteroalkyl, unsubstituted cycloalkyl, unsubstituted heterocycloalkyl, unsubstituted aryl, or unsubstituted heteroaryl. In some embodiments, R²², R²⁵, R²⁸, R³¹, R³⁴, R³⁷, R⁴⁰, R^{43a}, R^{46a}, R^{49a}, R^{43b}, R^{46b}, R^{49b}, R^{43c}, R^{46c}, R^{49c}, R^{43d}, R^{46d}, and R^{49d} are independently hydrogen. In some embodiments, R²², R²⁵, R²⁸, R³¹, R³⁴, R³⁷, R⁴⁰, R^{43a}, R^{46a}, R^{49a}, R^{43b}, R^{46b}, R^{49b}, R^{43C}, R^{46c}, R^{49c}, R^{43d}, R^{46d}, and R^{49d} are independently hydrogen, unsubstituted C₁-C₁₀ alkyl (e.g., unsubstituted C₁-C₁₀ saturated alkyl), unsubstituted 2 to 10 membered heteroalkyl, unsubstituted C₃-C₈ cycloalkyl, unsubstituted 3 to 8 membered heterocycloalkyl, unsubstituted C₅-C₁₀ aryl, or unsubstituted 5 to 10 membered heteroaryl. In some embodiments, R²², R²⁵, R²⁸, R³¹, R³⁴, R³⁷, R⁴⁰, R^{43a}, R^{46a}, R^{49a}, R^{43b}, R^{46b}, R^{49b}, R^{43c}, R^{46c}, R^{49c}, R^{43d}, R^{46d}, and R^{49d} are independently hydrogen, halogen, —CF₃, —CN, —OH, —NH₂, —COOH, —CONH₂, —NO₂, —SH, —SO₂, —SO₂Cl, —SO₃H, —SO₄H, —SO₂NH₂, NHNH₂, ONH₂, or NHC═(O)NHNH₂. In some embodiments, R²², R²⁵, R²⁸, R³¹, R³⁴, R³⁷, R⁴⁰, R^{43a}, R^{46a}, R^{49a}, R^{43b}, R^{46b}, R^{49b}, R^{43c}, R^{46c}, R^{49c}, R^{43d}, R^{46d}, and R^{49d} are independently unsubstituted C₁-C₁₀ alkyl (e.g., unsubstituted C₁-C₁₀ saturated alkyl), unsubstituted C₃-C₈ cycloalkyl, or unsubstituted aryl.

Further to any of the Formulae described herein, in some embodiments one of R⁵ or R⁶ is hydrogen.

In some embodiments of the compounds described herein, a substituent is a size-limited substituent. For example without limitation, in some embodiments each substituted or unsubstituted alkyl may be a substituted or unsubstituted C₁-C₂₀, C₁-C₁₀, C₁-C₆, or even C₁ alkyl. In some embodiments each substituted or unsubstituted heteroalkyl may be a substituted or unsubstituted 2-20 membered, 2-10 membered, or 2-6 membered heteroalkyl. In some embodiments, each substituted or unsubstituted cycloalkyl is a substituted or unsubstituted C₃-C₈, C₄-C₈, C₅-C₇ cycloalkyl. In some embodiments, each substituted or unsubstituted heterocycloalkyl is a substituted or unsubstituted 3-8 membered, 4-8 membered, or 3-6 membered heterocycloalkyl. In some embodiments, each substituted or unsubstituted heteroaryl is a substituted or unsubstituted 4-14 membered, 4-10 membered, 5-8 membered, 4-6 membered, 5-6 membered, or 6-membered heteroaryl. In some embodiments, each substituted or unsubstituted aryl is a substituted or unsubstituted C₄-C₁₄, C₄-C₁₀, C₆-C₁₀, C₅-C₈, C₅-C₆, or C₆ aryl (phenyl).

In some embodiments of a compound described herein, at least one of R¹, R², R³, R⁴, R^{8A}, R^{8B}, R^{8C}, R^{8D}, R^{9A}, R^{9B}, R^{9C}, R^{9D}, R^{10A}, R^{10B}, R^{10C} and R^{10D} is unsubstituted C₁-C₄ saturated alkyl or unsubstituted aryl (e.g., phenyl), R⁵ is unsubstituted C₁-C₄ saturated alkyl, R⁶ is hydrogen, and R⁷ is unsubstituted aryl (e.g. phenyl) or unsubstituted C₁-C₄ saturated alkyl (e.g. propyl). In some embodiments of a compound described herein, at least one of R¹, R², R³, R⁴, R^{8A}, R^{8B}, R^{8C}, R^{8D}, R^{9A}, R^{9B}, R^{9C}, R^{9D}, R^{10A}, R^{10B}, R^{10C} and R^{10D} is unsubstituted C₁-C₄ saturated alkyl, R⁵ is unsubstituted C₁-C₄ saturated alkyl, R⁶ is hydrogen, and R⁷ is unsubstituted phenyl. In some embodiments of a compound described herein, at least one of R¹, R², R³, R⁴, R^{8A}, R^{8B}, R^{8C}, R^{8D}, R^{9A}, R^{9B}, R^{9C}, R^{9D}, R^{10A}, R^{10B}, R^{10C} and R^{10D} is unsubstituted C₁-C₃ saturated alkyl, R⁵ is unsubstituted C₁-C₃ saturated alkyl, R⁶ is hydrogen, and R⁷ is unsubstituted phenyl. In some embodiments a compound described herein, at least one of R¹, R², R³, R⁴, R^{8A}, R^{8B}, R^{8C}, R^{8D}, R^{9A}, R^{9B}, R^{9C}, R^{9D}, R^{10A}, R^{10B}, R^{10C} and R^{10b} is methyl, ethyl, propyl or isopropyl, R⁵ is unsubstituted ethyl or methyl, R⁶ is hydrogen, and R⁷ is unsubstituted phenyl. In some embodiments a compound described herein, at least one of R¹, R², R³, R⁴, R^{8A}, R^{8B}, R^{8C}, R^{8D}, R^{9A}, R^{9B}, R^{9C}, R^{9D}, R^{10A}, R^{10B}, R^{10C} and R^{10D} is phenyl, R⁵ is unsubstituted ethyl or methyl, R⁶ is hydrogen, and R⁷ is unsubstituted phenyl. In some embodiments, R⁵ is —H, R⁶ is —H, and R⁷ is —CH₂CH₂CH₃. In some embodiments, R⁵ is —CH₃, R⁶ is —H, and R⁷ is —CH₂CH₂CH₃. In some embodiments, R⁵ is —CH₂CH₃, R⁶ is —H, and R⁷ is —CH₂CH₂CH₃. In some embodiments, R⁵ is —(CH₂)₂CH₃, R⁶ is —H, and R⁷ is —CH₂CH₂CH₃. In some embodiments, R⁵ is —(CH₂)₃CH₃, R⁶ is —H, and R⁷ is —CH₂CH₂CH₃. In some embodiments, R⁵ is —(CH₂)₄—CH₃, R⁶ is —H, and R⁷ is —CH₂CH₂CH₃. In some embodiments, R⁵ is —(CH₂)₅CH₃, R⁶ is —H, and R⁷ is —CH₂CH₂CH₃. In some embodiments, R⁵ is —(CH₂)₇CH₃, R⁶ is —H, and R⁷ is —CH₂CH₂CH₃. In some embodiments, R⁵ is —(CH₂)₂OH, R⁶ is —H, and R⁷ is —CH₂CH₂CH₃. In some embodiments, R⁵ is —(CH₂)₄OH, R⁶ is —H, and R⁷ is —CH₂CH₂CH₃. In some embodiments, R⁵ is —CH₃, R⁶ is —CH₃, and R⁷ is —CH₂CH₂CH₃.

In some embodiments of a compound described herein, R⁵ is —(CH₂)₉CH₃. In some embodiments, In some embodiments, R⁵ is —(CH₂)₈CH₃. In some embodiments, R⁵ is —(CH₂)₇CH₃. In some embodiments, R⁵ is —(CH₂)₆CH₃. In some embodiments, R⁵ is —(CH₂)₅CH₃. In some embodiments, R⁵ is —(CH₂)₄—CH₃. In some embodiments, R⁵ is —(CH₂)₃CH₃. In some embodiments, R⁵ is —(CH₂)₂CH₃. In some embodiments, R⁵ is —CH₂CH₃. In some embodiments, R⁵ is —CH₃. In some embodiments, R⁵ is —(CH₂)₁₀OH. In some embodiments, R⁵ is —(CH₂)₉OH. In some embodiments, R⁵ is —(CH₂)₈OH. In some embodiments, R⁵ is —(CH₂)₇OH. In some embodiments, R⁵ is —(CH₂)₆OH. In some embodiments, R⁵ is —(CH₂)₅OH. In some embodiments, R⁵ is —(CH₂)₄OH. In some embodiments, R⁵ is —(CH₂)₃OH. In some embodiments, R⁵ is —(CH₂)₂OH. In some embodiments, R⁵ is —CH₂OH. In some embodiments, R⁵ is —OH. In some embodiments, R⁵ is —H.

In some embodiments of a compound described herein, R⁶ is —(CH₂)₉CH₃. In some embodiments, In some embodiments, R⁶ is —(CH₂)₈CH₃. In some embodiments, R⁶ is —(CH₂)₇CH₃. In some embodiments, R⁶ is —(CH₂)₆CH₃. In some embodiments, R⁶ is —(CH₂)₅CH₃. In some embodiments, R⁶ is —(CH₂)₄—CH₃. In some embodiments, R⁶ is —(CH₂)₃CH₃. In some embodiments, R⁶ is —(CH₂)₂CH₃. In some embodiments, R⁶ is —CH₂CH₃. In some embodiments, R⁶ is —CH₃. In some embodiments, R⁶ is —(CH₂)₁₀OH. In some embodiments, R⁶ is —(CH₂)₉OH. In some embodiments, R⁶ is —(CH₂)₈OH. In some embodiments, R⁶ is —(CH₂)₇OH. In some embodiments, R⁶ is —(CH₂)₆OH. In some embodiments, R⁶ is —(CH₂)₅OH. In some embodiments, R⁶ is —(CH₂)₄OH. In some embodiments, R⁶ is —(CH₂)₃OH. In some embodiments, R⁶ is —(CH₂)₂OH. In some embodiments, R⁶ is —CH₂OH. In some embodiments, R⁶ is —OH. In some embodiments, R⁶ is —H.

In some embodiments of a compound described herein, R⁷ is —(CH₂)₉CH₃. In some embodiments, In some embodiments, R⁷ is —(CH₂)₈CH₃. In some embodiments, R⁷ is —(CH₂)₇CH₃. In some embodiments, R⁷ is —(CH₂)₆CH₃. In some embodiments, R⁷ is —(CH₂)₅CH₃. In some embodiments, R⁷ is —(CH₂)₄—CH₃. In some embodiments, R⁷ is —(CH₂)₃CH₃. In some embodiments, R⁷ is —(CH₂)₂CH₃. In some embodiments, R⁷ is —CH₂CH₃. In some embodiments, R⁷ is —CH₃. In some embodiments, R⁷ is —(CH₂)₁₀OH. In some embodiments, R⁷ is —(CH₂)₉OH. In some embodiments, R⁷ is —(CH₂)₈OH. In some embodiments, R⁷ is —(CH₂)₇OH. In some embodiments, R⁷ is —(CH₂)₆OH. In some embodiments, R⁷ is —(CH₂)₅OH. In some embodiments, R⁷ is —(CH₂)₄OH. In some embodiments, R⁷ is —(CH₂)₃OH. In some embodiments, R⁷ is —(CH₂)₂OH. In some embodiments, R⁷ is —CH₂OH. In some embodiments, R⁷ is —OH. In some embodiments, R⁷ is —H.

In some embodiments of a compound described herein, R^{8a} is —(CH₂)₉CH₃. In some embodiments, In some embodiments, R^{8a} is —(CH₂)₈CH₃. In some embodiments, R^{8a} is —(CH₂)₇CH₃. In some embodiments, R^{8a} is —(CH₂)₆CH₃. In some embodiments, R^{8a} is —(CH₂)₅CH₃. In some embodiments, R^{8a} is —(CH₂)₄—CH₃. In some embodiments, R^{8a} is —(CH₂)₃CH₃. In some embodiments, R^{8a} is —(CH₂)₂CH₃. In some embodiments, R^{8a} is —CH₂CH₃. In some embodiments, R^{8a} is —CH₃. In some embodiments, R^{8a} is —(CH₂)₁₀OH. In some embodiments, R^{8a} is —(CH₂)₉OH. In some embodiments, R^{8a} is —(CH₂)₈OH. In some embodiments, R^{8a} is —(CH₂)₇OH. In some embodiments, R^{8a} is —(CH₂)₆OH. In some embodiments, R^{8a} is —(CH₂)₅OH. In some embodiments, R^{8a} is —(CH₂)₄OH. In some embodiments, R^{8a} is —(CH₂)₃OH. In some embodiments, R^{8a} is —(CH₂)₂OH. In some embodiments, R^{8a} is —CH₂OH. In some embodiments, R^{8a} is —OH. In some embodiments, R^{8a} is —H. In some embodiments of a compound described herein, R^{9a} is —(CH₂)₉CH₃. In some embodiments, In some embodiments, R^{9a} is —(CH₂)₈CH₃. In some embodiments, R^{9a} is —(CH₂)₇CH₃. In some embodiments, R^{9a} is —(CH₂)₆CH₃. In some embodiments, R^{9a} is —(CH₂)₅CH₃. In some embodiments, R^{9a} is —(CH₂)₄—CH₃. In some embodiments, R^{9a} is —(CH₂)₃CH₃. In some embodiments, R^{9a} is —(CH₂)₂CH₃. In some embodiments, R^{9a} is —CH₂CH₃. In some embodiments, R^{9a} is —CH₃. In some embodiments, R^{9a} is —(CH₂)₁₀OH. In some embodiments, R^{9a} is —(CH₂)₉OH. In some embodiments, R^{9a} is —(CH₂)₈OH. In some embodiments, R^{9a} is —(CH₂)₇OH. In some embodiments, R^{9a} is —(CH₂)₆OH. In some embodiments, R^{9a} is —(CH₂)₅OH. In some embodiments, R^{9a} is —(CH₂)₄OH. In some embodiments, R^{9a} is —(CH₂)₃OH. In some embodiments, R^{9a} is —(CH₂)₂OH. In some embodiments, R^{9a} is —CH₂OH. In some embodiments, R^{9a} is —OH. In some embodiments, R^{9a} is —H. In some embodiments of a compound described herein, R^{10a} is —(CH₂)₉CH₃. In some embodiments, In some embodiments, R^{10a} is —(CH₂)₈CH₃. In some embodiments, R^{10a} is —(CH₂)₇CH₃. In some embodiments, R^{10a} is —(CH₂)₆CH₃. In some embodiments, R^{10a} is —(CH₂)₅CH₃. In some embodiments, R^{10a} is —(CH₂)₄—CH₃. In some embodiments, R^{10a} is —(CH₂)₃CH₃. In some embodiments, R^{10a} is —(CH₂)₂CH₃. In some embodiments, R^{10a} is —CH₂CH₃. In some embodiments, R^{10a} is —CH₃. In some embodiments, R^{10a} is —(CH₂)₁₀OH. In some embodiments, R^{10a} is —(CH₂)₉OH. In some embodiments, R^{10a} is —(CH₂)₈OH. In some embodiments, R^{10a} is —(CH₂)₇OH. In some embodiments, R^{10a} is —(CH₂)₆OH. In some embodiments, R^{10a} is —(CH₂)₅OH. In some embodiments, R^{10a} is —(CH₂)₄OH. In some embodiments, R^{10a} is —(CH₂)₃OH. In some embodiments, R^{10a} is —(CH₂)₂OH. In some embodiments, R^{10a} is —CH₂OH. In some embodiments, R^{10a} is —OH. In some embodiments, R^{10a} is —H.

In some embodiments of a compound described herein, R^{8b} is —(CH₂)₉CH₃. In some embodiments, In some embodiments, R^{8b} is —(CH₂)₈CH₃. In some embodiments, R^{8b} is —(CH₂)₇CH₃. In some embodiments, R^{8b} is —(CH₂)₆CH₃. In some embodiments, R^{8b} is —(CH₂)₅CH₃. In some embodiments, R^{8b} is —(CH₂)₄—CH₃. In some embodiments, R^{8b} is —(CH₂)₃CH₃. In some embodiments, R^{8b} is —(CH₂)₂CH₃. In some embodiments, R^{8b} is —CH₂CH₃. In some embodiments, R^{8b} is —CH₃. In some embodiments, R^{8b} is —(CH₂)₁₀OH. In some embodiments, R^{8b} is —(CH₂)₉OH. In some embodiments, R^{8b} is —(CH₂)₅OH. In some embodiments, R^{8b} is —(CH₂)₇OH. In some embodiments, R^{8b} is —(CH₂)₆OH. In some embodiments, R^{8b} is —(CH₂)₅OH. In some embodiments, R^{8b} is —(CH₂)₄OH. In some embodiments, R^{8b} is —(CH₂)₃OH. In some embodiments, R^{8b} is —(CH₂)₂OH. In some embodiments, R^{8b} is —CH₂OH. In some embodiments, R^{8b} is —OH. In some embodiments, R^{8b} is —H. In some embodiments of a compound described herein, R^{9b} is —(CH₂)₉CH₃. In some embodiments, In some embodiments, R^{9b} is —(CH₂)₅CH₃. In some embodiments, R^{9b} is —(CH₂)₇CH₃. In some embodiments, R^{9b} is —(CH₂)₆CH₃. In some embodiments, R^{9b} is —(CH₂)₅CH₃. In some embodiments, R^{9b} is —(CH₂)₄—CH₃. In some embodiments, R^{9b} is —(CH₂)₃CH₃. In some embodiments, R^{9b} is —(CH₂)₂CH₃. In some embodiments, R^{9b} is —CH₂CH₃. In some embodiments, R^{9b} is —CH₃. In some embodiments, R^{9b} is —(CH₂)₁₀OH. In some embodiments, R^{9b} is —(CH₂)₉OH. In some embodiments, R^{9b} is —(CH₂)₅OH. In some embodiments, R^{9b} is —(CH₂)₇OH. In some embodiments, R^{9b} is —(CH₂)₆OH. In some embodiments, R^{9b} is —(CH₂)₅OH. In some embodiments, R^{9b} is —(CH₂)₄OH. In some embodiments, R^{9b} is —(CH₂)₃OH. In some embodiments, R^{9b} is —(CH₂)₂OH. In some embodiments, R^{9b} is —CH₂OH. In some embodiments, R^{9b} is —OH. In some embodiments, R^{9b} is —H. In some embodiments of a compound described herein, R^{10b} is —(CH₂)₉CH₃. In some embodiments, In some embodiments, R^{10b} is —(CH₂)₅CH₃. In some embodiments, R^{10b} is —(CH₂)₇CH₃. In some embodiments, R^{10b} is —(CH₂)₆CH₃. In some embodiments, R^{10b} is —(CH₂)₅CH₃. In some embodiments, R^{10b} is (CH₂)₄—CH₃. In some embodiments, R^{10b} is —(CH₂)₃CH₃. In some embodiments, R^{10b} is —(CH₂)₂CH₃. In some embodiments, R^{10b} is —CH₂CH₃. In some embodiments, R^{10b} is —CH₃. In some embodiments, R^{10b} is —(CH₂)₁₀OH. In some embodiments, R^{10b} is —(CH₂)₉OH. In some embodiments, R^{10b} is —(CH₂)₅OH. In some embodiments, R^{10b} is —(CH₂)₇OH. In some embodiments, R^{10b} is —(CH₂)₆OH. In some embodiments, R^{10b} is —(CH₂)₅OH. In some embodiments, R^{10b} is —(CH₂)₄OH. In some embodiments, R^{10b} is —(CH₂)₃OH. In some embodiments, R^{10b} is —(CH₂)₂OH. In some embodiments, R^{10b} is —CH₂OH. In some embodiments, R^{10b} is —OH. In some embodiments, R^{10b} is —H.

In some embodiments of a compound described herein, R^{8c} is —(CH₂)₉CH₃. In some embodiments, In some embodiments, R^{8c} is —(CH₂)₅CH₃. In some embodiments, R^{8c} is —(CH₂)₇CH₃. In some embodiments, R^{8c} is —(CH₂)₆CH₃. In some embodiments, R^{8c} is —(CH₂)₅CH₃. In some embodiments, R^{8c} is —(CH₂)₄—CH₃. In some embodiments, R^{8c} is —(CH₂)₃CH₃. In some embodiments, R^{8c} is —(CH₂)₂CH₃. In some embodiments, R^{8c} is —CH₂CH₃. In some embodiments, R^{8c} is —CH₃. In some embodiments, R^{8c} is —(CH₂)₁₀OH. In some embodiments, R^{8c} is —(CH₂)₉OH. In some embodiments, R^{8c} is —(CH₂)₅OH. In some embodiments, R^{8c} is —(CH₂)₇OH. In some embodiments, R^{8c} is —(CH₂)₆OH. In some embodiments, R^{8c} is —(CH₂)₅OH. In some embodiments, R^{8c} is —(CH₂)₄OH. In some embodiments, R^{8c} is —(CH₂)₃OH. In some embodiments, R^{8c} is —(CH₂)₂OH. In some embodiments, R^{8c} is —CH₂OH. In some embodiments, R^{8c} is —OH. In some embodiments, R^{8c} is —H. In some embodiments of a compound described herein, R^{9c} is —(CH₂)₉CH₃. In some embodiments, In some embodiments, R^{9c} is —(CH₂)₅CH₃. In some embodiments, R^{9c} is —(CH₂)₇CH₃. In some embodiments, R^{9c} is —(CH₂)₆CH₃. In some embodiments, R^{9c} is —(CH₂)₅CH₃. In some embodiments, R^{9c} is —(CH₂)₄—CH₃. In some embodiments, R^{9c} is —(CH₂)₃CH₃. In some embodiments, R^{9c} is —(CH₂)₂CH₃. In some embodiments, R^{9c} is —CH₂CH₃. In some embodiments, R^{9c} is —CH₃. In some embodiments, R^{9c} is —(CH₂)₁₀OH. In some embodiments, R^{9c} is —(CH₂)₉OH. In some embodiments, R^{9c} is —(CH₂)₅OH. In some embodiments, R^{9c} is —(CH₂)₇OH. In some embodiments, R^{9c} is —(CH₂)₆OH. In some embodiments, R^{9c} is —(CH₂)₅OH. In some embodiments, R^{9c} is —(CH₂)₄OH. In some embodiments, R^{9c} is —(CH₂)₃OH. In some embodiments, R^{9c} is —(CH₂)₂OH. In some embodiments, R^{9c} is —CH₂OH. In some embodiments, R^{9c} is —OH. In some embodiments, R^{9c} is —H. In some embodiments of a compound described herein, R^{10c} is —(CH₂)₉CH₃. In some embodiments, In some embodiments, R^{10c} is —(CH₂)₅CH₃. In some embodiments, R^{10c} is —(CH₂)₇CH₃. In some embodiments, Roc is —(CH₂)₆CH₃. In some embodiments, R^{10c} is —(CH₂)₅CH₃. In some embodiments, R^{10c} is —(CH₂)₄—CH₃. In some embodiments, R^{10c} is —(CH₂)₃CH₃. In some embodiments, R^{10c} is —(CH₂)₂CH₃. In some embodiments, R^{10c} is —CH₂CH₃. In some embodiments, R^{10c} is —CH₃. In some embodiments, R^{10c} is —(CH₂)₁₀OH. In some embodiments, R^{10c} is —(CH₂)₉OH. In some embodiments, R^{10c} is —(CH₂)₅OH. In some embodiments, R^{10c} is —(CH₂)₇OH. In some embodiments, R^{10c} is —(CH₂)₆OH. In some embodiments, R^{10c} is —(CH₂)₅OH. In some embodiments, R^{10c} is —(CH₂)₄OH. In some embodiments, R^{10c} is —(CH₂)₃OH. In some embodiments, R^{10c} is —(CH₂)₂OH. In some embodiments, R^{10c} is —CH₂OH. In some embodiments, R^{10c} is —OH. In some embodiments, R^{10c} is —H.

In some embodiments of a compound described herein, R^{8d} is —(CH₂)₉CH₃. In some embodiments, In some embodiments, R^{8d} is —(CH₂)₅CH₃. In some embodiments, R^{8d} is —(CH₂)₇CH₃. In some embodiments, R^{8d} is —(CH₂)₆CH₃. In some embodiments, R^{8d} is —(CH₂)₅CH₃. In some embodiments, R^{8d} is —(CH₂)₄—CH₃. In some embodiments, R^{8d} is —(CH₂)₃CH₃. In some embodiments, R^{8d} is —(CH₂)₂CH₃. In some embodiments, R^{8d} is —CH₂CH₃. In some embodiments, R^{8d} is —CH₃. In some embodiments, R^{8d} is —(CH₂)₁₀OH. In some embodiments, R^{8d} is —(CH₂)₉OH. In some embodiments, R^{8d} is —(CH₂)₅OH. In some embodiments, R^{8d} is —(CH₂)₇OH. In some embodiments, R^{8d} is —(CH₂)₆OH. In some embodiments, R^{8d} is —(CH₂)₅OH. In some embodiments, R^{8d} is —(CH₂)₄OH. In some embodiments, R^{8d} is —(CH₂)₃OH. In some embodiments, R^{8d} is —(CH₂)₂OH. In some embodiments, R^{8d} is —CH₂OH. In some embodiments, R^{8d} is —OH. In some embodiments, R^{8d} is —H. In some embodiments of a compound described herein, R^{9d} is —(CH₂)₉CH₃. In some embodiments, In some embodiments, R^{9d} is —(CH₂)₅CH₃. In some embodiments, R^{9d} is —(CH₂)₇CH₃. In some embodiments, R^{9d} is —(CH₂)₆CH₃. In some embodiments, R^{9d} is —(CH₂)₅CH₃. In some embodiments, R^{9d} is —(CH₂)₄—CH₃. In some embodiments, R^{9d} is —(CH₂)₃CH₃. In some embodiments, R^{9d} is —(CH₂)₂CH₃. In some embodiments, R^{9d} is —CH₂CH₃. In some embodiments, R^{9d} is —CH₃. In some embodiments, R^{9d} is —(CH₂)₁₀OH. In some embodiments, R^{9d} is —(CH₂)₉OH. In some embodiments, R^{9d} is —(CH₂)₅OH. In some embodiments, R^{9d} is —(CH₂)₇OH. In some embodiments, R^{9d} is —(CH₂)₆OH. In some embodiments, R^{9d} is —(CH₂)₅OH. In some embodiments, R^{9d} is —(CH₂)₄OH. In some embodiments, R^{9d} is —(CH₂)₃OH. In some embodiments, R^{9d} is —(CH₂)₂OH. In some embodiments, R^{9d} is —CH₂OH. In some embodiments, R^{9d} is —OH. In some embodiments, R^{9d} is —H. In some embodiments of a compound described herein, R^{10d} is —(CH₂)₉CH₃. In some embodiments, In some embodiments, R^{10d} is —(CH₂)₅CH₃. In some embodiments, R^{10d} is —(CH₂)₇CH₃. In some embodiments, R^{10d} is —(CH₂)₆CH₃. In some embodiments, R^{10d} is —(CH₂)₅CH₃. In some embodiments, R^{10d} is —(CH₂)₄—CH₃. In some embodiments, R^{10d} is —(CH₂)₃CH₃. In some embodiments, R^{10d} is —(CH₂)₂CH₃. In some embodiments, R^{10d} is —CH₂CH₃. In some embodiments, R^{10d} is —CH₃. In some embodiments, R^{10d} is —(CH₂)₁₀OH. In some embodiments, R^{10d} is —(CH₂)₉OH. In some embodiments, R^{10c} is —(CH₂)₅OH. In some embodiments, R^{10d} is —(CH₂)₇OH. In some embodiments, R^{10c} is —(CH₂)₆OH. In some embodiments, R^{10d} is —(CH₂)₅OH. In some embodiments, R^{10c} is —(CH₂)₄OH. In some embodiments, R^{10d} is —(CH₂)₃OH. In some embodiments, R^{10c} is —(CH₂)₂OH. In some embodiments, R^{10d} is —CH₂OH. In some embodiments, R^{10d} is —OH. In some embodiments, R^{10d} is —H.

In another aspect, a compound is provided, having a formula selected from:

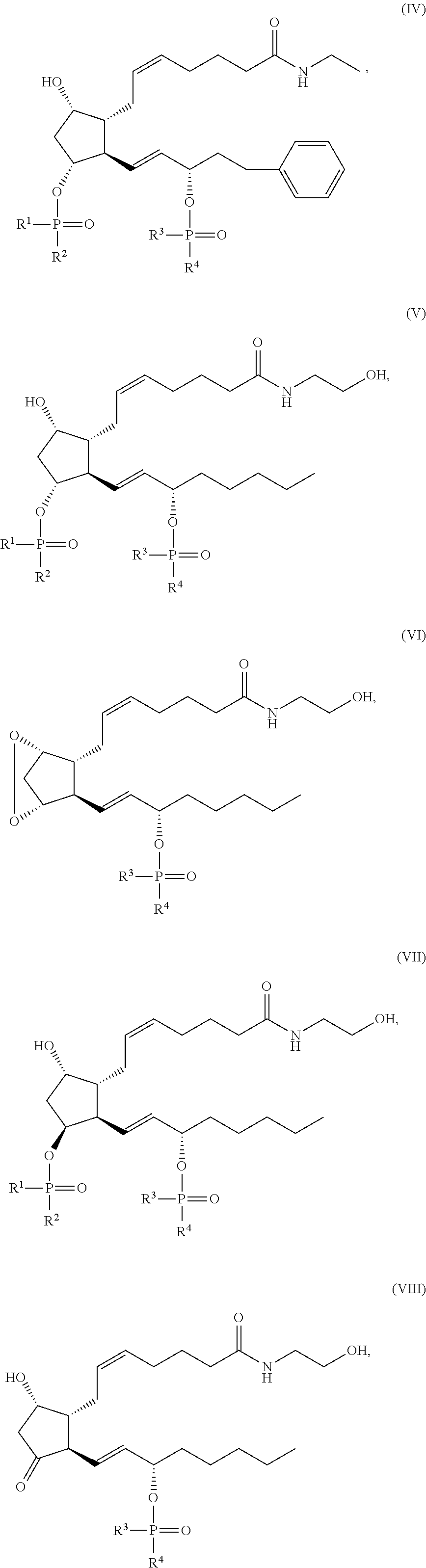

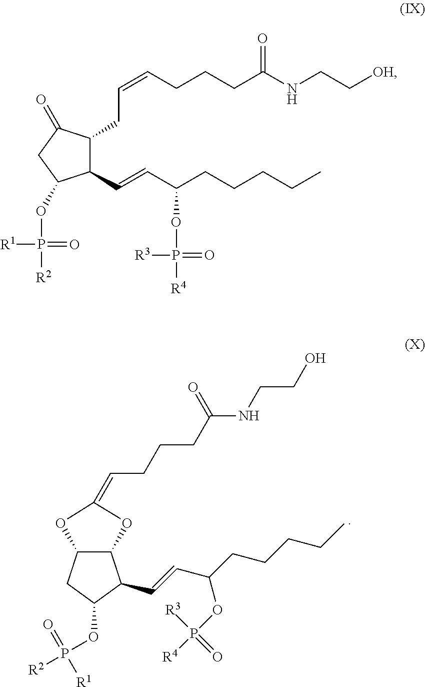

In formulae (IV), (V), (VI), (VII), (VIII), (IX), and (X), the substituents R¹, R², R³, and R⁴ are as described herein (including embodiments).

It is understood that a compound described herein, e.g., a compound with structure of any of Formulae (I), (II), (III), (IV), (V), (VI), (VII), (VIII), (IX), or (X), or derivatives, isomers or enantiomers thereof, can be provided, where applicable, as a pharmaceutically acceptable salt as defined herein, where the compound admits to formation of a pharmaceutically acceptable salt.

### III. Pharmaceutical Compositions

In another aspect, there is provided a pharmaceutical composition including a pharmaceutically acceptable excipient and a compound provided herein (e.g., a compound with structure of Formulae (I), (II), (III), (IV), (V), (VI), (VII), (VIII), (IX), or (X), or derivatives, isomers or enantiomers thereof, and including embodiments thereof).

In one embodiment, the compound has the structure of Formulae (IV). In one embodiment, the compound has the structure of Formula (V).

In one embodiment, the pharmaceutical composition is a solution, emulsion, gel or foam. In one embodiment, the pharmaceutical composition is a solution. In one embodiment, the pharmaceutical composition is an emulsion. In one embodiment, the pharmaceutical composition is a gel. In one embodiment, the pharmaceutical composition is a foam.

In one embodiment, the pharmaceutical composition is a topical pharmaceutical composition. In one embodiment, the pharmaceutical composition is a topical epidermal pharmaceutical composition.

It is understood that the compound within the pharmaceutical composition described herein (e.g., a compound with structure of Formulae (I), (II), (III), (IV), (V), (VI), (VII), (VIII), (IX), or (X), or derivatives, isomers or enantiomers thereof, and including embodiments thereof) can be provided, where applicable, as a pharmaceutically acceptable salt as defined herein, where the compound admits to formation of a pharmaceutically acceptable salt.

A. Formulations

The compounds and pharmaceutical compositions disclosed herein can be prepared and administered in a variety of forms including solution, emulsion, gel or foam. Accordingly, pharmaceutical compositions contemplated herein include a pharmaceutically acceptable carrier or excipient and one or more compounds described herein. “Solution” refers in the customary sense to a liquid pharmaceutical composition in which a compound (e.g., a compound described herein), is at least partially dissolved, preferably fully dissolved, and which can be administered as a liquid. “Emulsion” refers in the customary sense to a mixture of two or more immiscible liquids, one compound (e.g., a compound described herein or solution thereof) being dispersed through the other compound (e.g., a carrier as described herein). “Gel” refers in the customary sense to a highly viscous solution, emulsion, or colloidal suspension of a compound within a continuous fluid phase resulting in a viscous semirigid fluid. “Colloid” refers in the customary sense to a composition which includes a continuous medium throughout which are distributed small particles which do not settle under the influence of gravity. “Foam” refers in the customary sense to a composition which includes a continuous medium (i.e., solution, emulsion, gel and the like) through which gas (e.g., air) is dispersed.

Pharmaceutical compositions contemplated herein may be prepared by combining a therapeutically effective amount of at least one compound as described herein as an active ingredient in combination with one or more conventional pharmaceutically acceptable excipients, and by preparation of unit dosage forms suitable for topical use. The therapeutically efficient amount typically is between about 0.0001 and about 5% (w/v), preferably about 0.001 to about 1.0% (w/v) in liquid formulations which include solutions, emulsions, gels and foams. Pharmaceutical admixtures suitable for use in the present invention include those described, for example, in PHARMACEUTICAL SCIENCES (17th Ed., Mack Pub. Co., Easton, Pa.) and WO 96/05309, the teachings of both of which are hereby incorporated by reference.

The pharmaceutical preparation is preferably in unit dosage form. In such form the preparation is subdivided into unit doses containing appropriate quantities of the active component. The unit dosage form can be a packaged preparation, the package containing discrete quantities of preparation, such as packeted tablets, capsules, and powders in vials or ampoules. Also, the unit dosage form can be a capsule, tablet, cachet, or lozenge itself, or it can be the appropriate number of any of these in packaged form.

Some compounds may have limited solubility in water and therefore may require a surfactant or other appropriate co-solvent in the composition. Such co-solvents include: Polysorbate 20, 60, and 80; Pluronic F-68, F-84, and P-103; cyclodextrin; and polyoxyl 35 castor oil. Such co-solvents are typically employed at a level between about 0.01% and about 2% by weight.

Viscosity greater than that of simple aqueous solutions may be desirable to decrease variability in dispensing the formulations, to decrease physical separation of components of a suspension or emulsion of formulation, and/or otherwise to improve the formulation. Such viscosity building agents include, for example, polyvinyl alcohol, polyvinyl pyrrolidone, methyl cellulose, hydroxy propyl methylcellulose, hydroxyethyl cellulose, carboxymethyl cellulose, hydroxy propyl cellulose, chondroitin sulfate and salts thereof, hyaluronic acid and salts thereof, and combinations of the foregoing. Such agents are typically employed at a level between about 0.01% and about 2% by weight.

The compositions of the present invention may additionally include components to provide sustained release and/or comfort. Such components include high molecular weight, anionic mucomimetic polymers, gelling polysaccharides, and finely-divided drug carrier substrates. These components are discussed in greater detail in U.S. Pat. Nos. 4,911,920; 5,403,841; 5,212,162; and 4,861,760. The entire contents of these patents are incorporated herein by reference in their entirety for all purposes. US Patent application publication No. US 2011-0124736 A1, also corresponding to U.S. patent application Ser. No. 12/940,711, is hereby incorporated by reference in its entirety.

For ophthalmic application, preferably solutions are prepared using a physiological saline solution as a major vehicle. The pH of such ophthalmic solutions should preferably be maintained between 4.5 and 8.0 with an appropriate buffer system, a neutral pH being preferred but not essential. The formulations may also contain conventional, pharmaceutically acceptable preservatives, stabilizers and surfactants.

Various buffers and means for adjusting pH may be used so long as the resulting preparation is ophthalmically acceptable. Accordingly, buffers include acetate buffers, citrate buffers, phosphate buffers and borate buffers. Acids or bases may be used to adjust the pH of these formulations as needed.

Preferred preservatives that may be used in the pharmaceutical compositions of the present invention include, but are not limited to, benzalkonium chloride, chlorobutanol, thimerosal, phenylmercuric acetate and phenylmercuric nitrate. A preferred surfactant is, for example, Tween 80. Likewise, various preferred vehicles may be used in the ophthalmic preparations of the present invention. These vehicles include, but are not limited to, polyvinyl alcohol, povidone, hydroxypropyl methyl cellulose, poloxamers, carboxymethyl cellulose, hydroxyethyl cellulose cyclodextrin and purified water.

Tonicity adjustors may be added as needed or convenient. They include, but are not limited to, salts, particularly sodium chloride, potassium chloride, mannitol and glycerin, or any other suitable ophthalmically acceptable tonicity adjustor.

An ophthalmically acceptable antioxidant for use in the present invention includes, but is not limited to, sodium metabisulfite, sodium thiosulfate, acetylcysteine, butylated hydroxyanisole and butylated hydroxytoluene.

Other excipient components which may be included in the ophthalmic preparations are chelating agents. The preferred chelating agent is edentate disodium, although other chelating agents may also be used in place of or in conjunction with it.

The ophthalmic formulations of the present invention are conveniently packaged in forms suitable for metered application, such as in containers equipped with a brush, to facilitate application to the palpebra. In one embodiment, an application brush is disposed within a unit dose vial. Vials suitable for unit dose application are usually made of suitable inert, non-toxic plastic material, and generally contain between about 0.5 and about 15 ml solution, emulsion, gel or foam. One package may contain one or more unit doses.

Preservative-free solutions are often formulated in non-resealable containers containing up to about ten, preferably up to about five units doses, where a typical unit dose is from one to about 8 drops, preferably one to about 3 drops.

For topical use on the eyelids or eyebrows, the active compounds can be formulated in aqueous solutions, creams, ointments or oils exhibiting physiologically acceptable osmolarity by addition of pharmacologically acceptable buffers and salts. Such formulations may or may not, depending on the dispenser, contain preservatives such as benzalkonium chloride, chlorhexidine, chlorobutanol, parahydroxybenzoic acids and phenylmercuric salts such as nitrate, chloride, acetate, and borate, or antioxidants, as well as additives like EDTA, sorbitol, boric acid etc. as additives. Furthermore, particularly aqueous solutions may contain viscosity increasing agents such as polysaccharides, e.g., methylcellulose, mucopolysaccharides, e.g., hyaluronic acid and chondroitin sulfate, or polyalcohol, e.g., polyvinylalcohol. Various slow releasing gels and matrices may also be employed as well as soluble and insoluble ocular inserts, for instance, based on substances forming in-situ gels.

For topical use on the skin and the scalp, the compound can be advantageously formulated using ointments, creams, liniments or patches as a carrier of the active ingredient. Also, these formulations may or may not contain preservatives, depending on the dispenser and nature of use. Such preservatives include those mentioned above, and methyl-, propyl-, or butyl-parahydroxybenzoic acid, betain, chlorhexidine, benzalkonium chloride, and the like. Various matrices for slow release delivery may also be used.

Typically, the compounds are applied repeatedly for a sustained period of time topically on the part of the body to be treated, for example, the eyelids, eyebrows, body or scalp. The preferred dosage regimen will generally involve regular administration for a period of treatment of at least one month, more preferably at least three months, and most preferably at least six months. The regular administration can be 1, 2, 3, 4 or even more times per day.

Formulations for use in the methods and pharmaceutical compositions disclosed herein include Formulation A, provided in Table 1 following. The term “active component” refers to bimatoprost or a compound as described herein (e.g., a compound with structure of Formula (I), (II), (III), (IV), (V), (VI), (VII), (VIII), (IX), or (X), or derivatives, isomers or enantiomers thereof and including embodiments thereof). As customary in the art, the term “q.s.” (i.e., quantum satis) refers to as much as is enough. For example, “water q.s. to 100%” refers to sufficient water to bring the formulation to 100%.

TABLE 1
Formulation A

| Ingredient | Amount |
|---|---|
| Active component (% w/w) | 0.03 |
| Glycerin (% w/w) | 2.0 |
| Propylene Glycol (% w/w) | 10.0 |
| Diethylene Glycol Monoethyl Ether (% w/w) | 10.0 |
| Ethyl Alcohol (% w/w) | 30.0 |
| Carbomer Ultrez 10 (% w/w) | 0.15 |
| Triethanolamine (% w/w) | 0.16 |
| Purified Water | q.s. to 100% |
| pH | ~7 |

Additional formulations for use in the methods and pharmaceutical compositions disclosed herein include formulations exemplified in Tables 2 and 3 following, wherein the amount of each component (i.e., % w/w) is included within the indicated range.

TABLE 2
Exemplary Formulations

| Ingredient | Range (% w/w) |
|---|---|
| Active component | 0.001-3.00 |
| Glycerin | 1.0-4.0 |
| Propylene Glycol | 5.0-15.0 |
| Diethylene Glycol Monoethyl Ether | 5.0-15.0 |
| Ethyl Alcohol | 25.0-35.0 |
| Carbomer Ultrez 10 | 0.05-0.30 |
| Triethanolamine | 0.05-0.30 |
| Purified Water | q.s. to 100% |

TABLE 3
Exemplary Formulations

| Ingredient | Range (% w/w) |
|---|---|
| Active component | 0.01-0.1 |
| Glycerin | 0.001-4.0 |
| Propylene Glycol | 0.5-20.0 |
| Diethylene Glycol Monoethyl Ether | 0.5-20.0 |
| Ethyl Alcohol | 0.5-45.0 |
| Carbomer Ultrez 10 | 0.1-0.30 |
| Triethanolamine | 0.1-0.32 |
| Purified Water | q.s. to 100% |

B. Effective Dosages

Pharmaceutical compositions provided herein include compositions wherein the active ingredient (e.g., a compound with structure of Formula (I), (II), (III), (IV), (V), (VI), (VII), (VIII), (IX), or (X), or derivatives, isomers or enantiomers thereof and including embodiments thereof) is contained in a therapeutically effective amount. The actual amount effective for a particular application will depend, inter alia, on the disease, disorder or condition being treated.

The dosage and frequency (single or multiple doses) of compound administered can vary depending upon a variety of factors, including route of administration; size, age, sex, health, body weight, body mass index, and diet of the recipient; nature and extent of symptoms of the disease, disorder or condition being treated (e.g., the degree of hair loss); presence of other diseases or other health-related problems; kind of concurrent treatment; and complications from any disease or treatment regimen. Other therapeutic regimens or agents can be used in conjunction with the methods and compounds of the invention.

Therapeutically effective amounts for use in humans may be determined from animal models. For example, a dose for humans can be formulated to achieve a concentration that has been found to be effective in animals. The dosage in humans can be adjusted by monitoring piliation and adjusting the dosage upwards or downwards, as described herein.

Dosages may be varied depending upon the requirements of the subject and the compound being employed. The dose administered to a subject, in the context of the present invention, should be sufficient to effect a beneficial therapeutic response in the patient over time. The size of the dose also will be determined by the existence, nature, and extent of any adverse side effects. Generally, treatment is initiated with smaller dosages, which are less than the optimum dose of the compound. Thereafter, the dosage is increased by small increments until the optimum effect under circumstances is reached.

Dosage amounts and intervals can be adjusted individually to provide levels of the administered compound effective for the particular clinical indication being treated. This will provide a therapeutic regimen that is commensurate with the severity of the individual's disease state.

Utilizing the teachings provided herein, an effective prophylactic or therapeutic treatment regimen can be planned that does not cause substantial toxicity and yet is entirely effective to treat the clinical symptoms demonstrated by the particular patient. This planning should involve the careful choice of active compound by considering factors such as compound potency, relative bioavailability, patient body weight, presence and severity of adverse side effects, preferred mode of administration, and the toxicity profile of the selected agent.

Depending on the actual formulation and compound to be used, various amounts of the drug and different dose regimens may be employed. In one embodiment, the daily amount of compound for treatment of the palpebra is about 0.1 ng to about 100 mg per eyelid.

In some embodiments, for topical use on the skin and the scalp, the dose to be applied is in the range of about 0.1 ng to about 100 mg per day, more preferably about 1 ng to about 10 mg per day, and most preferably about 10 ng to about 1 mg per day depending on the compound and the formulation. To achieve the daily amount of medication depending on the formulation, the compound may be administered once or several times daily with or without antioxidants.

In some embodiments, an amount of the active compound in a pharmaceutical composition, e.g., a compound disclosed herein in a pharmaceutical composition disclosed herein, is about 1×10⁻⁷ to 50% (w/w), about 0.001 to 50% (w/w), about 0.01 to 50% (w/w), about 0.1 to 50% (w/w), or about 1 to 50% (w/w). In some embodiments, the amount of the active compound in a pharmaceutical composition is about 0.001%, 0.005%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 3.0%, 4.0% and 5.0% w/w.

In some embodiments, an effective amount, e.g., a therapeutically effective amount, of the active compound in a pharmaceutical composition is afforded at a concentration of about 1×10⁻⁷ to 50% (w/w), about 0.001 to 50% (w/w), about 0.01 to 50% (w/w), about 0.1 to 50% (w/w), or about 1 to 50% (w/w). In some embodiments, the therapeutically effective amount of the active compound in a pharmaceutical composition is about 0.001%, 0.005%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9% and 1.0%, 1.1%, 1.2%, 1.3%, 1.4%, 1.5%, 1.6%, 1.7%, 1.8%, 1.9%, 2.0%, 3.0%, 4.0% and 5.0% w/w.

C. Toxicity

The ratio between toxicity and therapeutic effect for a particular compound is its therapeutic index and can be expressed as the ratio between LD₅₀ (the amount of compound lethal in 50% of the population) and ED₅₀ (the amount of compound effective in 50% of the population). Compounds that exhibit high therapeutic indices are preferred. Therapeutic index data obtained from cell culture assays and/or animal studies can be used in formulating a range of dosages for use in humans. The dosage of such compounds preferably lies within a range of plasma concentrations that include the ED₅₀ with little or no toxicity. The dosage may vary within this range depending upon the dosage form employed and the route of administration utilized. See, e.g., Fingl et al., In: THE PHARMACOLOGICAL BASIS OF THERAPEUTICS, Ch. 1, p. 1, 1975. The exact formulation, route of administration, and dosage can be chosen by the individual physician in view of the patient's condition and the particular method in which the compound is used.

### IV. Methods of Use

In another aspect, there is provided a method for inducing hair growth (e.g., piliation). The method includes administering to a subject in need thereof a therapeutically effective amount of a compound provided herein (e.g., a compound with structure of Formula (I), (II), (III), (IV), (V), (VI), (VII), (VIII), (IX), or (X), or derivatives, isomers or enantiomers thereof, and including embodiments thereof). The compound may be provided as part of a pharmaceutical composition as described herein.

In one embodiment, the subject suffers from alopecia such that the method of inducing hair growth is a method for treating alopecia. In one embodiment, the subject is in need of hair growth of the cilia, the supercilium, scalp pili or body pili such that the method of inducing hair growth is a method for inducing growth of the cilia, the supercilium, scalp pili or body pili or the subject, respectively. In one embodiment, the subject is in need of hair growth of the cilia. In one embodiment, the subject is in need of hair growth of the supercilium. In one embodiment, the subject is in need of hair growth of scalp pili. In one embodiment, the subject is in need of hair growth of body pili.

In one embodiment, the administering is topical administering. In one embodiment, the administering is topical epidermal administering.

In one embodiment, the administering is topical palpebra administering, topical supercilium administering, topical scalp administering, or topical body administering. In one embodiment, the administering is topical palpebra administering. In one embodiment, the administering is topical supercilium administering. In one embodiment, the administering is topical scalp administering. In one embodiment, the administering is topical body administering.

In one embodiment, the administering is topical scalp administering. In a further embodiment, the composition is a foam.

In one embodiment, the administering is topical palpebra administering. In a further embodiment, the composition is administered from a unit dose vial (e.g., by an application brush disposed within a unit dose vial).

In another aspect, there is provided a method for treating an inflammatory skin disease or disorder. The method includes administering to a subject in need thereof a therapeutically effective amount of a compound provided herein (e.g., a compound with structure of Formula (I), (II), (III), (IV), (V), (VI), (VII), (VIII), (IX), or (X), or derivatives, isomers or enantiomers thereof, and including embodiments thereof). The compound may be provided as part of a pharmaceutical composition as described herein.

In one embodiment, the subject suffers from rosacea or redness from rosacea. Thus, the method of treating an inflammatory skin disease, in some embodiments, is a method of treating rosacea or redness from rosacea.

In another aspect, there is provided a method for reducing local adipose deposits. The method includes administering to a subject in need thereof a therapeutically effective amount of a compound provided herein (e.g., a compound with structure of Formulae (I), (II), (III), (IV), (V), (VI), (VII), (VIII), (IX), or (X), or derivatives, isomers or enantiomers thereof, and including embodiments thereof). The compound may be provided as part of a pharmaceutical composition as described herein. The term “local adipose deposit” refers to an adipose (i.e., fat) deposit in a subject which is localized in its extent. In some embodiments, the extent of the greatest dimension of a local adipose deposit is about 1 cm, 2 cm, 3 cm, 4 cm, 5 cm, 6 cm, 7 cm, 8 cm, 9 cm, 10 cm, 20 cm, or even greater. The term “reducing” in the context of reducing adipose deposits (e.g., local adipose deposits) refers to lowering the fat content within such deposits and reducing the mass of the adipose deposit.

In another aspect, there is provided a method for lowering intraocular pressure. The method includes administering to a subject in need thereof a therapeutically effective amount of a compound provided herein (e.g., a compound with structure of Formula (I), (II), (III), (IV), (V), (VI), (VII), (VIII), (IX), or (X), or derivatives, isomers or enantiomers thereof). The compound may be provided as part of a pharmaceutical composition as described herein. In some embodiments, the subject suffers from elevated intraocular pressure or glaucoma. In some embodiments, the subject suffers from glaucoma.

In another aspect, there is provided a method of treating glaucoma. The method includes administering to a subject in need thereof a therapeutically effective amount of a compound provided herein (e.g., a compound with structure of Formula (I), (II), (III), (IV), (V), (VI), (VII), (VIII), (IX), or (X), or derivatives, isomers or enantiomers thereof, and including embodiments thereof). The compound may be provided as part of a pharmaceutical composition as described herein.

In another aspect, there is provided a method of providing bimatoprost therapy. The method includes administering to a subject in need thereof a therapeutically effective amount of a compound provided herein (e.g., a compound with structure of Formula (I), (II), (III), or (IV) or derivative, isomer or enantiomer thereof and including embodiments thereof). The compound may be provided as part of a pharmaceutical composition as described herein.

In some embodiments, the subject is a mammalian subject. In other embodiments the subject is a domesticated animal such as a domesticated mammal. In other embodiments, the subject is a human subject (e.g., a patient).

In another aspect, a method of treating an inflammatory condition in a human is provided, including administering to a subject in need thereof a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby treating an inflammatory condition.

In another aspect, a method of reducing inflammation in a human is provided, including administering to a subject in need thereof a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby reducing inflammation. In some embodiments, the inflammation is of the skin. In some embodiments, the inflammation is of the eye. In some embodiments, the inflammation is of an epidermal tissue.

In another aspect, a method of treating cachexia in a human is provided, including administering to a subject in need thereof, a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby treating cachexia.

In another aspect, a method of increasing muscle mass in a human is provided, including administering to a subject in need thereof, a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby increasing muscle mass. In some embodiments, the increase in muscle mass is through increased growth of muscle. In some embodiments, the muscle is skeletal muscle.

In another aspect, a method of decreasing fat in a human is provided, including administering to a subject in need thereof, a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby decreasing fat in a human.

In another aspect, a method of decreasing adipose tissue in a human is provided, including administering to a subject in need thereof, a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby decreasing adipose tissue.

In another aspect, a method of decreasing the weight of a human is provided, including administering to a subject in need thereof, a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby decreasing the weight of a human.

In another aspect, a method of reducing hair loss in a human is provided, including administering to a subject in need thereof, a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby reducing hair loss.

In another aspect, a method of treating glaucoma in a human is provided, including administering to a subject in need thereof, a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby treating glaucoma.

In another aspect, a method of preventing glaucoma in a human is provided, including administering to a subject at increased risk of glaucoma, a prophylactically effective amount as described herein (e.g., a compound with structure of Formula (I), (II), (III), (IV), (V), (VI), (VII), (VIII), (IX), or (X), or derivatives, isomers or enantiomers thereof, and including embodiments thereof) and thereby preventing glaucoma.

In another aspect, a method of treating intraocular hypertension in a human is provided, including administering to a subject in need thereof, a therapeutically effective amount of a compound as described herein (e.g., a compound with structure of Formula (I), (II), (III), (IV), (V), (VI), (VII), (VIII), (IX), or (X), or derivatives, isomers or enantiomers thereof, and including embodiments thereof) and thereby treating intraocular hypertension.

In some embodiments of the methods described herein, the administering is topical administering. In some embodiments of the methods described herein, the administering is topical epidermal administering. In some embodiments of the methods described herein, the administering is topical ocular administering.

Compounds useful in the methods provided here include those with structure of Formula (I), (II), (III), (IV), (V), (VI), (VII), (VIII), (IX), or (X), or derivatives, isomers or enantiomers thereof, and including embodiments thereof.

In one embodiment of compounds useful in the methods provided herein, R^{8A}, R^{8B}, R^{8C}, and R^{8D} are independently substituted or unsubstituted C₁-C₆ alkyl. In one embodiment, R^{8A}, R^{8B}, R^{8C}, and R^{8D} are independently substituted or unsubstituted C₁-C₃ alkyl. In one embodiment, R^{8A}, R^{8B}, R^{8C}, and R^{8D} are independently substituted or unsubstituted C₁ alkyl. In one embodiment, R^{8A}, R^{8B}, R^{8C}, and R^{8D} are independently unsubstituted methyl. In one embodiment of compounds useful in the methods provided herein, R^{9A}, R^{9B}, R^{9C}, R^{9D}, R^{10A}, R^{10B}, R^{10C} and R^{10D} are independently substituted or unsubstituted C₁-C₆ alkyl. In one embodiment, R^{9A}, R^{9B}, R^{9C}, R^{9D}, R^{10A}, R^{10B}, R^{10C} and R^{10D} are independently substituted or unsubstituted C₁-C₃ alkyl. In one embodiment, R^{9A}, R^{9B}, R^{9C}, R^{9D}, R^{10A}, R^{10B}, R^{10C} and R^{10D} are independently substituted or unsubstituted C₁ alkyl. In R^{9B}, R^{9C}, R^{9D}, R^{10A}, R^{10B}, R^{10C} and R^{10D} one embodiment, R^{9A}, are independently unsubstituted methyl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted C₁-C₃ alkyl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted C₁ alkyl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently unsubstituted methyl.

In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted C₃-C₈ cycloalkyl.

In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently substituted or unsubstituted aryl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently unsubstituted aryl. In one embodiment, R^{8A}, R^{8B}, R^{8C}, R^{8D}, R^{9A}, R^{9B}, R^{9C}, R^{9D}, R^{10A}, R^{10B}, R^{10C} and R^{10D} are independently unsubstituted phenyl.

In one embodiment, R⁵ is hydrogen. In one embodiment, R⁵ is substituted or unsubstituted C₁-C₁₀ alkyl, or substituted or unsubstituted C₃-C₈ cycloalkyl. In one embodiment, R⁵ is substituted or unsubstituted C₁-C₆ alkyl. In one embodiment, R⁵ is substituted or unsubstituted C₁-C₃ alkyl. In one embodiment, R⁵ is substituted or unsubstituted C₁-C₂ alkyl. In one embodiment, R⁵ is substituted or unsubstituted ethyl. In one embodiment, R⁵ is unsubstituted ethyl. In one embodiment, R⁵ is substituted or unsubstituted C₃-C₈ cycloalkyl.

In one embodiment, R⁶ is hydrogen. In one embodiment, R⁶ is substituted or unsubstituted C₁-C₁₀ alkyl, or substituted or unsubstituted C₃-C₈ cycloalkyl. In one embodiment, R⁶ is substituted or unsubstituted C₁-C₆ alkyl. In one embodiment, R⁶ is substituted or unsubstituted C₁-C₃ alkyl. In one embodiment, R⁶ is substituted or unsubstituted C₁-C₂ alkyl. In one embodiment, R⁶ is substituted or unsubstituted ethyl. In one embodiment, R⁶ is unsubstituted ethyl. In one embodiment, R⁶ is substituted or unsubstituted C₃-C₈ cycloalkyl.

In one embodiment, the compound has the structure of one of Formula (I), (II), (III), (IV), (V), (VI), (VII), (VIII), (IX), or (X). In one embodiment, the compound has the structure of Formula (I). In one embodiment, the compound has the structure of Formula (II). In one embodiment, the compound has the structure of Formula (III). In one embodiment, the compound has the structure of Formula (IV). In one embodiment, the compound has the structure of Formula (V). In one embodiment, the compound has the structure of Formula (VI). In one embodiment, the compound has the structure of Formula (VII). In one embodiment, the compound has the structure of Formula (VII). In one embodiment, the compound has the structure of Formula (IX). In one embodiment, the compound has the structure of Formula (X).

In some embodiments of the methods provided herein, the compound is provided within a pharmaceutical composition such as a solution, emulsion, gel or foam. In one embodiment, the pharmaceutical composition is a solution. In one embodiment, the composition is an emulsion. In one embodiment, the composition is a gel. In one embodiment, the composition is a foam.

It is understood that the compounds useful in the methods provided herein (e.g., a compound with structure of Formulae (I), (II), (III), (IV), (V), (VI), (VII), (VIII), (IX), or (X), or derivatives, isomers or enantiomers thereof, and including embodiments thereof) can be provided, where applicable, as a pharmaceutically acceptable salt as defined herein, where the compound admits to formation of a pharmaceutically acceptable salt.

### V. Examples

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A compound with structure of Formula (I): 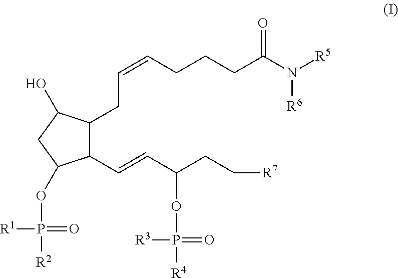
or derivative, isomer, or enantiomer thereof;
wherein
R¹ is —OR^{8A}, —NR^{9A}R^{10A}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl;
R² is —OR^{8B}, —NR^{9B}R^{10B}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl;
R³ is —OR^{8C}, —NR^{9C}R^{10C}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl;
R⁴ is —OR^{8D}, —NR^{9D}R^{10D}, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl;
R⁵ and R⁶ are independently hydrogen, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl;
R⁷ is substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl; and,
R^{8A}, R^{8B}, R^{8C}, R^{8D}, R^{9A}, R^{9B}, R^{9C}, R^{9D}, R^{10A}, R^{10B}, R^{10C} and R^{10D} are independently hydrogen, substituted or unsubstituted C₁-C₁₀ alkyl, substituted or unsubstituted 2 to 10 membered heteroalkyl, substituted or unsubstituted cycloalkyl, substituted or unsubstituted heterocycloalkyl, substituted or unsubstituted aryl or substituted or unsubstituted heteroaryl.

2. The compound of claim 1, wherein
R¹ is —OR^{8A}, —NR^{9A}R^{10A}, substituted or unsubstituted cycloalkyl, substituted or unsubstituted heterocycloalkyl, substituted or unsubstituted aryl or substituted or unsubstituted heteroaryl;
R² is —OR^{8B}, —NR^{9B}R^{10B}, substituted or unsubstituted cycloalkyl, substituted or unsubstituted heterocycloalkyl, substituted or unsubstituted aryl or substituted or unsubstituted heteroaryl;
R³ is —OR^{8C}, —NR^{9C}R^{10C}, substituted or unsubstituted cycloalkyl, substituted or unsubstituted heterocycloalkyl, substituted or unsubstituted aryl or substituted or unsubstituted heteroaryl; and
R⁴ is —OR^{8D}, —NR^{9D}R^{10D}, substituted or unsubstituted cycloalkyl, substituted or unsubstituted heterocycloalkyl, substituted or unsubstituted aryl or substituted or unsubstituted heteroaryl.

3. The compound of claim 1, wherein
R¹ is —OR^{8A}, —NR^{9A}R^{10A}, or a monosaccharide moiety;
R² is —OR^{8B}, —NR^{9B}R^{10B}, or a monosaccharide moiety;
R³ is —OR^{8C}, —NR^{9C}R^{10c}, or a monosaccharide moiety; and
R⁴ is —OR^{8D}, —NR^{9D}R^{10D}, or a monosaccharide moiety.

4. The compound of claim 1, wherein R^{8A}, R^{8B}, R^{8C} and R^{8D} are independently hydrogen, or hydroxyl-substituted or unsubstituted C₁-C₁₀ alkyl.

5. The compound of claim 1, wherein R⁵ and R⁶ are independently hydrogen or hydroxyl-substituted or unsubstituted C₁-C₁₀ alkyl.

6. The compound of claim 1, wherein R⁵ and R⁶ are hydrogen.

7. The compound of claim 1, wherein
R^{9A}, R^{9B}, R^{9C}, R^{9D}, R^{10A}, R^{10B}, R^{10C} and R^{10D} are independently hydrogen or hydroxyl-substituted or unsubstituted C₁-C₁₀ alkyl.

8. The compound of claim 1, wherein
R⁷ is substituted or unsubstituted C₁-C₁₀ alkyl, substituted or unsubstituted cycloalkyl, substituted or unsubstituted heterocycloalkyl, substituted or unsubstituted aryl or substituted or unsubstituted heteroaryl.

9. The compound of claim 1, wherein
R⁷ is substituted or unsubstituted cycloalkyl, substituted or unsubstituted heterocycloalkyl, substituted or unsubstituted aryl or substituted or unsubstituted heteroaryl.

10. The compound of claim 1, wherein R⁷ is substituted or unsubstituted aryl.

11. A pharmaceutical composition comprising a pharmaceutically acceptable excipient and a compound of any one of claim 1.

12. A method of inducing hair growth in a human comprising administering to a subject in need thereof a therapeutically effective amount of a compound of claim 1.

13. The method of claim 12, wherein said subject suffers from alopecia.

14. The method of claim 12, wherein said subject is in need of hair growth of the cilia, the supercilia, scalp pili, or body pili.

15. The method of claim 12, wherein the method comprises administering a therapeutically effective amount of the compound of claim 1 to the eyelashes.

16. The method of claim 12, wherein the method comprises administering a therapeutically effective amount of the compound of claim 1 to the eyebrows.

17. The method of claim 12, wherein the method comprises administering a therapeutically effective amount of the compound of claim 1 to the scalp.

18. The method of claim 12, wherein the method comprises administering a therapeutically effective amount of the compound of claim 1 to a patient undergoing chemotherapy.

19. The method of claim 18, wherein the method comprises administering a therapeutically effective amount of the compound of claim 1 to a patient undergoing chemotherapy wherein the compound is applied from at least one selected from the group consisting of before, during and after chemotherapeutic treatment.

20. The method of claim 13, wherein the patient suffers from alopecia areata.
